(19) United States
(12) Patent Application Publication
(10) Pub. No.: US 2023/0379439 A1
(43) Pub. Date: Nov. 23, 2023

(54) ALL WEATHER CAMERA SYSTEM AND METHODS FOR CONTROL THEREOF

(71) Applicant: EarthCam Inc., Upper Saddle River, NJ (US)

(72) Inventors: Brian CURY, Alpine, NJ (US); James B. NICOLL, Livingston, NJ (US)

(21) Appl. No.: 18/200,842

(22) Filed: May 23, 2023

Related U.S. Application Data
(63) Continuation-in-part of application No. 16/987,228, filed on Aug. 6, 2020, now abandoned.
Application No. 16/987,228 is a continuation of application No. 14/196,599, filed on Mar. 4, 2014, now abandoned.

(51) Int. Cl. H04N 7/18; H04N 17/00; G03B 17/08; G03B 17/56; H04N 23/698

(52) U.S. Cl. CPC H04N 7/183; H04N 17/002; G03B 17/08; G03B 17/561; H04N 23/698

(57) ABSTRACT

An unattended camera system for automatically capturing images at a site, especially including a remote construction site. Accurate focusing of the camera system is especially critical to obtain evidentiary-quality images. Four different focusing processes are executed to ensure these quality images, including: a laboratory setup focus process, an initial field setup process when the camera system is delivered to the remote site, a focus change operation when the system mission is changed, and a refocus operation when a maintenance and repair operation is performed in the camera system.

### CROSS REFERENCE TO RELATED APPLICATIONS

The present application is a continuation-in-part application of application Ser. No. 16/987,228, filed on Aug. 6, 2020, which is a continuation of application Ser. No. 14/196,599, filed on Mar. 4, 2014. Both applications are incorporated herein.

### FIELD OF THE INVENTION

The present invention relates to a continuously operating heteronomous camera system to capture an outlying (i.e., an outlying image is an image of an object which is distant from a camera system) images, processes and instruction sets to remotely operate, maintain, and focus a continuously operating heteronomous outlying image camera system, and processes and instruction sets to install and relocate a continuously operating heteronomous outlying image camera system.

### BACKGROUND OF THE INVENTION

One Vanderbilt is a 93-story supertall skyscraper at the corner of 42nd Street and Vanderbilt Avenue in the Midtown Manhattan neighborhood of New York City. SoFi Stadium is a 70,240-seat sports and entertainment indoor stadium in the Los Angeles suburb of Inglewood, California, United States. The Panama Canal Expansion Program added a third lane to the Panama Canal for the transit of Neopanamax vessels between the Cocoli and Agua Clara Locks. These are characteristic of massive construction and civil engineering projects. Typically, the projects occupy many acres, last several years, cost billions of dollars, employee many thousand workers and have hundreds of contractors. They are also characteristic of massive construction and civil engineering projects in that they experience worker injury and death, cost overruns, completion delays, equipment theft, material theft and construction errors.

Construction sites like these often operate 24 hours a day and 7 days a week. They can have people, workers, heavy equipment, copper wire and building components spread out over hundreds of acres. Monitoring the construction project is a daunting task even with inspectors on site. A major contributor to construction site worker injury and death, cost overruns, completion delays, equipment theft, material theft and construction errors is the inability to monitor and inspect the detail activities. According to the Center for Disease Control and Prevention, one of the highest occurrences of worker death, injury and suicide occurs at construction sites.

Copper and other metals, lumber, small hand tools, power tools, and heavy machinery are continually stolen from constructions projects. Often stolen are loaders, backhoes, excavators, and towable equipment. There is a need to monitor and inspect all the detailed activities of a large construction site or civil engineering project. The cost and liability to construction contractors is enormous. The National Equipment Register (NER) estimates the total value of equipment stolen from construction sites to be between $300 million and $1 billion annually. Never before has there been a camera system for large construction site management to adequately and continuously monitor and inspect the detail activities of an entire construction project site.

A large construction project exists in a complex, outdoor, weather challenging, uncontrolled, air fouled, expansive contextual environment. A camera must operate continuously and reliably in such an environment to be an effective management tool to monitor and inspect the detailed activities of an entire construction project site. To effectively monitor and inspect the detailed activities of an entire sprawling construction project site a camera must be distant from the construction site, while at the same time, capturing high-definition images of the detail activities. Supertall buildings and vast construction sites need a camera that can view the height and width of the construction site. Never before has there been a camera adequately equipped to operate reliably and continuously in such a construction environment while also sufficiently distant from the construction activities. Not until now, is there a camera which can capture continuous high-definition images of the height and width of a construction project.

Construction sites and civil engineering projects experience natural disasters, such as hurricanes, tornados, floods, earthquakes, and lightning storms. They also experience ground tremors from natural causes and from construction demolition. Natural disasters can shake a camera just at the time when a stable camera is needed the most. Not before has there been a camera with can operate reliably without vibration or quivering and produce accurate images in an unstable construction project environment.

The air in proximity to a construction site is generally polluted. Airborne contaminants including contaminated particulate matter and volatile compounds, carried by wind, spread to surrounding areas. Contaminants in the air, generated by polluted dust, can travel large distances in a short time. The main construction contaminants that spread around by wind include, but are not limited to, PM10 (particulate matter with a diameter less than 10 microns), PAH (polycyclic aromatic hydrocarbons), VOCs (volatile organic compounds), asbestos, carbon monoxide, carbon dioxide, and nitrogen oxides. These pollutants can deteriorate and destroy photographic equipment. Not until now, is there a camera which can operate continuously in an air polluted construction project environment.

### BRIEF DESCRIPTION OF THE FIGURES

FIG. 1 illustrates a partial external view of the camera system.

FIGS. 2A-2M illustrate a view of internal and external camera system elements.

FIGS. 3A-3F illustrate a view of a Startup Camera System Test process.

FIGS. 4A-4D illustrate a view of an Internal Camera System Self-test process.

FIG. 5 illustrates a view of a Remote Operator Daily Diagnostic Camera System Check Process.

FIG. 6A-6G illustrates a view of a Scheduled Onsite Maintenance Diagnostic Camera System Check process.

FIG. 7A-7B illustrates a view of a Camera System Installation process.

FIG. 8 illustrates a view of a Camera System Refocus process.

FIG. 9 illustrates a view of a Camera System Relocation process.

FIG. 10 illustrates a view of a Camera System Ground Truth process.

FIG. 11 illustrates a view of a process for Determining an Image Capture Plan for a Camera System.

FIG. 12A-12B illustrates a view of a process to Transmit an Image Capture Plan to a Camera System.

FIG. 13 illustrates a view of a process for a Remote Operate operating a Camera System Operation.

FIG. 14 illustrates a view of a process for a Camera System Autonomous Setup Plan for an Image Mission Capture.

FIG. 15 illustrates a view of a process for a Camera System Image Capture.

FIG. 16 illustrates a view of a process for a Camera System to Transmit an Image to a Docu-Vault.

FIG. 17 illustrates a view of a process for a Camera System Operating Autonomously Operating an Image Mission Plan.

FIG. 18A-18E illustrates a view of a Camera System Log (302)

FIG. 19A-19D illustrates a view of a Client Request Form (601)

FIG. 20A-20D illustrates a view of a Scheduled Maintenance Procedure Guide and System Readiness Checklist (113)

FIG. 21A-21B illustrates a view of a process for an Initial Laboratory Setup for a Camera System Focus.

FIG. 22A-22B illustrates a view of a process for an Initial Field Setup for a Camera System Focus.

FIG. 23A-23B illustrates a view of a process for an Image Capture Mission Change for a Camera System Focus.

FIG. 24 illustrates a view of a process for a Maintenance and Repair Change for a Camera System Focus.

FIG. 25 illustrates the various symbols used in the figures.

### DETAILED DESCRIPTION OF THE INVENTION

The following table of contents identifies the various mechanical elements and processes associated with the present invention, each of which is described in detail below.
1. Camera System Mechanical Elements
   a. Camera Module
   b. Camera Body (200)
   c. Camera lens module (201)
   d. Camera Integument Wrapper (102)
   e. Camera Body Support Transport Module ‘camera body support’ (150)
   f. Camera System Data Module (160)
2. Camera System Processes and Procedures
   a. Process 1: Camera System Initial Installation and Relocation Processes
      i. The first Camera System Initial Installation and Relocation Process: EarthCam Camera Installation process
      ii. The second Camera System Initial Installation and Relocation Process: Camera Relocation
      iii. The third Camera System Initial Installation and Relocation Process: Camera System Operation Ground Truth Process
      iv. The fourth Camera System Initial Installation and Relocation Process: Camera Remote Refocus Process
   b. Process 2: Camera System Mission Operating Software and Processes
      i. The first Camera System Mission Operating Software and Process: Determine Outlying Image Capture Plan
      ii. The second Camera System Mission Operating Software and Process: Transmit Outlying Image Mission Capture Plan to A Camera System
   c. Process 3: Camera System Autonomous Mission Operation Process and Instruction Set
      i. The first Camera System Autonomous Mission Operation Instruction Set: Camera System Autonomous Setup for Outlying Image Mission Capture Plan Process
      ii. The second Camera System Autonomous Mission Operation Instruction Set: Camera System Image Capture Process
      iii. The third Camera System Autonomous Mission Operation Instruction Set: Camera System Transmits Images to Destination Docu-Vault
   d. Process 4: Camera System Diagnostic Process and Instruction Set
      i. The first Camera System Diagnostic Process and Instruction Set: Initial Startup System Test
      ii. The second Camera System Diagnostic Process and Instruction Set: Daily Internal self-system diagnostic check
      iii. The third Camera System Diagnostic Process and Instruction Set: Daily Remote Operator System Diagnostic check
      iv. The fourth Camera System Diagnostic Process and Instruction Set: Scheduled Onsite Maintenance Diagnostic Check
   e. Process 5: Camera System Focus Process
      i. The first Camera System Focus and Instruction Set: Laboratory Initial Setup Focus Process
      ii. The second Camera System Focus and Instruction Set: Initial Field Setup Focus Process
      iii. The third Camera System Focus and Instruction Set: Camera Mission Change Focus Process
      iv. The fourth Camera System Focus and Instruction Set: Camera System Maintenance and Repair Refocus Process

### Use of the Camera System

The Outlying Image Camera System (100) of the present invention is heteronomous. Once programmed, the Camera System operates autonomously 24 hours each day, seven days each week. However, the Camera System can be operated manually by a remote operator or by an onsite operator. It operates continuously and unattended, for as long as four years, but not limited to four years.

An outlying image is an image of an object which is distant from the camera system. An outlying object may be as small as, but not limited to being as small as, a wheelbarrow. An outlying object may be as large as, but not limited to being as large as, a football stadium. An outlying image may be, but not limited to being, two thousand and five hundred feet away from the camera system.

The Camera System operates in, but is not limited to operating in, an outdoor construction site, commercial site, civil engineering site, bridge, tunnel, or canal.

The Camera System operates in a hostile environment like, but not limited to, construction sites, tall building construction and civil engineering projects. These sites experience, but not limited to, experiencing, natural disasters, such as hurricanes, tornados, floods, earthquakes, and lightning storms. They also experience ground tremors from natural causes and from construction demolition and blasting. Natural disasters can shake a camera just at the time when a stable camera is needed the most to capture images of the natural disaster visits on the construction site. The camera system operates with vibration and quiver mitigating mechanical elements to capture consistently stable images.

The air in which the camera operates is in proximity to, but not limited to, construction sites, tall building construction and civil engineering projects is generally polluted. Airborne contaminants in the air may include, but are not limited to including, contaminated particulate matter and volatile compounds, and are carried by wind, and are spread to surrounding areas. Contaminants in the air, generated by polluted dust, can travel large distances in a short time. The main construction contaminants that are spread around by wind include, but are not limited to, PM10 (particulate matter with a diameter less than 10 microns), PAH (polycyclic aromatic hydrocarbons), VOCs (volatile organic compounds), asbestos, carbon monoxide, carbon dioxide, and nitrogen oxides. These pollutants can deteriorate and destroy photographic equipment.

The intended use of the EarthCam (assignee of the present invention) camera system is different than other cameras. The camera system takes images of the events which occur at a construction site toxic environment. It operates continuously and unmanned. The focus function is precise, calibrated, controlled, and is performed over time. The transmission of the images is secure. The images which are created and transmitted are logged, audited and verified.

The camera system takes images which are intended for use in a Docu-Narrative as described in related and co-owned patent application Ser. No. 18/199,949, filed on May 20, 2023 (Attorney Docket Number 16569-002). A Docu-Narrative is a historical, recorded, visual, narrative documentary of events that occur at a client's location during a specific period of time. It is subject to rigorous, secure chain of custody and probative protections and procedures such that it can be relied upon as presenting truthful information.

The camera system stores images on an internal image storage device. When instructed, the camera system transmits images to a remote docu-vault. A docu-vault is a secure datastore for images used, but not limited to being used in a docu-narrative. Items in the docu-vault are protected using advanced data protection techniques and physical security. The data security for the docu-vault is provided by, but is not limited to, data encryption, secured socket certificates, digital authentication, access rights management with multiple authentication layers and backup systems. A docu-vault refers to the datastore, data library, file store etc. It is a physical segment of a hard disk which is attached to a CPU (central processing unit). The CPU is located in a secure, fire retarded server room in the headquarters of EarthCam, Inc., the assignee of the present invention. The physical security for the Docu-Vault server site includes, but is not limited to, alarmed access points, climate control, fire suppression, moisture detection, access limitations to secure personnel, lack of external windows, and a vault-like environment.

The description of the camera system includes, but is not limited to including, five major components. The components include, but are not limited to, mechanical elements of the camera system, and instruction steps, processes, and procedures as related to camera system: installation, mission, diagnosis, and focus function.

The first inventive component is the camera system mechanical elements. The second component is the camera system initial installation and subsequent relocation instruction sets, processes and procedures, which allow the camera system to function for its intended use. The third component is the camera system mission instruction sets, processes and procedures. The fourth component is the camera system diagnostic checks instruction sets, processes and procedures. The fifth component is the camera system focus function instruction sets, processes and procedures.

### Camera System Mechanical Elements

The Camera System mechanical elements include, but is not limited to including, the four major subsystems and modules. The first Camera System mechanical element subsystem is the Camera Module. The Camera Module includes, but is not limited to including, a camera body (200) and an outlying image camera lens module (201). The second Camera System mechanical element subsystem is the camera integument wrapper (102). The third Camera System mechanical element subsystem is the Camera Body Transport Module (150). The fourth Camera System mechanical element subsystem is the Data Module (160). Parenthetical numerals refer to the various figures of the application.

### Camera Module

The first Camera System mechanical element subsystem is the Camera Module. The Camera Module includes, but is not limited to including, a megapixel digital camera body (200) and a Camera lens module (201). The rear of the high-definition outlying image camera lens (262) is connected to and locked to the front of the camera lens body (200). The camera body lens locking connection feature is located on the front of the camera body (200) and is hereafter called the lens mount (260).

### Camera Body (200)

The digital megapixel, but not limited to megapixel, camera body (200) includes, but is not limited to including, six significant elements and features. The first element of the camera body is an image sensor which is internal to the camera body and detects light information and converts the light information into electrical signals which are interpreted by the camera body as an image.

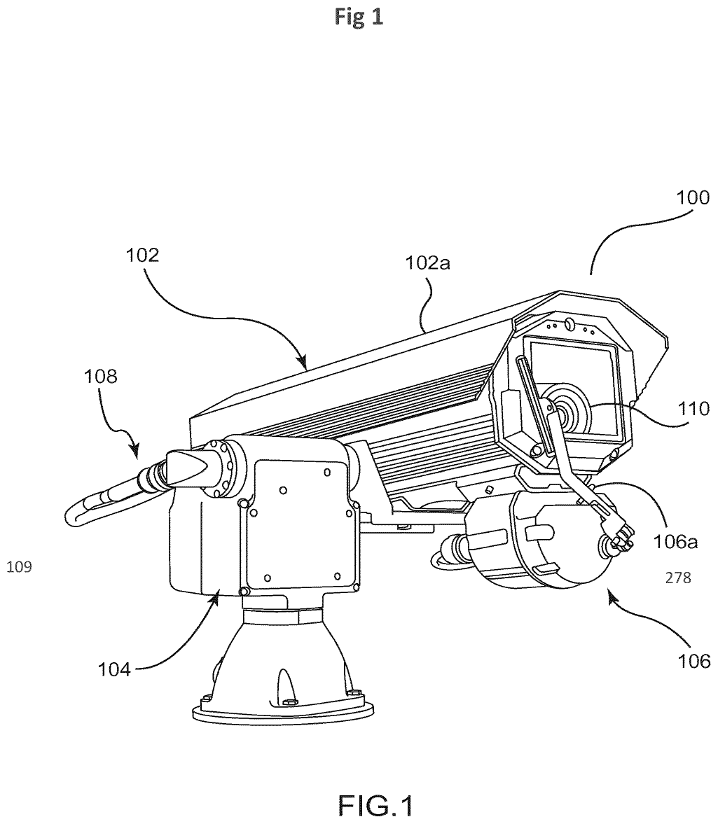

The second element of the camera body is an image file compression feature which is internal to the camera body (and therefore not shown in FIG. 1) and includes, but may not include, a process for storing, but may not store, the image file data. The file compression feature may, but may not include a process to allow a user the ability to view a video file without the video data file being stored.

The image file compression feature includes three, but is not limited to three, file compression processes. The first process is to create and store a compressed, but may not be compressed, image data file, in an audio-video interleave (AVI) format, but not limited to an AVI format, which includes both, but may not include both video and audio data. The second file compression process creates and stores image data, including audio and video data, in an MOV video format (i.e., a QuickTime multimedia file format). The third file compression process creates and stores image data, including audio and video data, in a Moving Pictures Expert Group 4 (MPEG-4) file format.

The third element of the camera body is an ISO control (163) feature which is internal to the camera body. The ISO control (163) includes a setting which allows an Operator to control the amount of brightness in an image.

The fourth element of the camera body is a shutter (165) which is internal to the camera body and controls the amount of light admitted into the camera. The shutter (165) includes a control feature which controls the amount of light and the speed of the shutter opening and closing. The shutter control feature includes f-stop controls including, but not limited to, f/1.8, f/2.0, f/2.8, f/4, f/5.6, f/8. f/11, f/16, f/22.

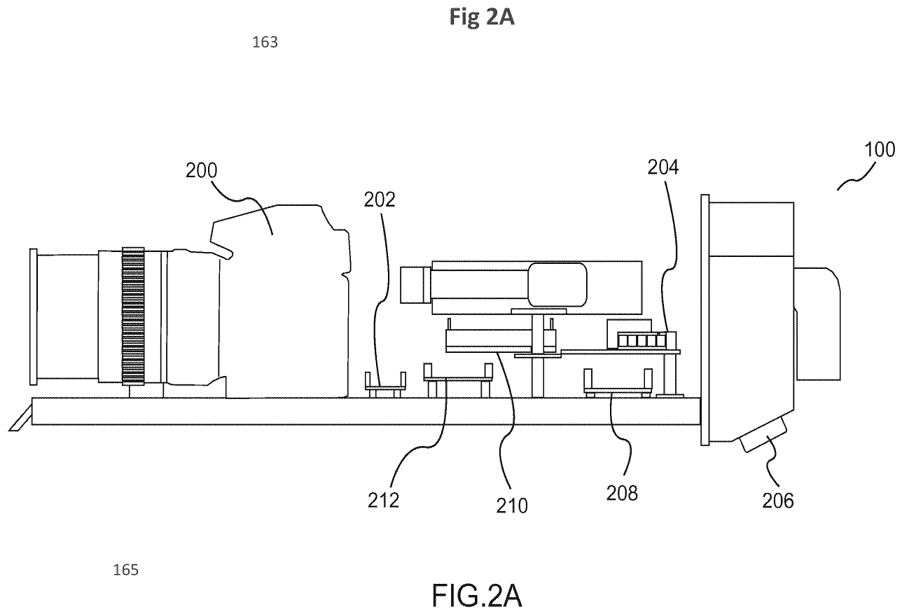

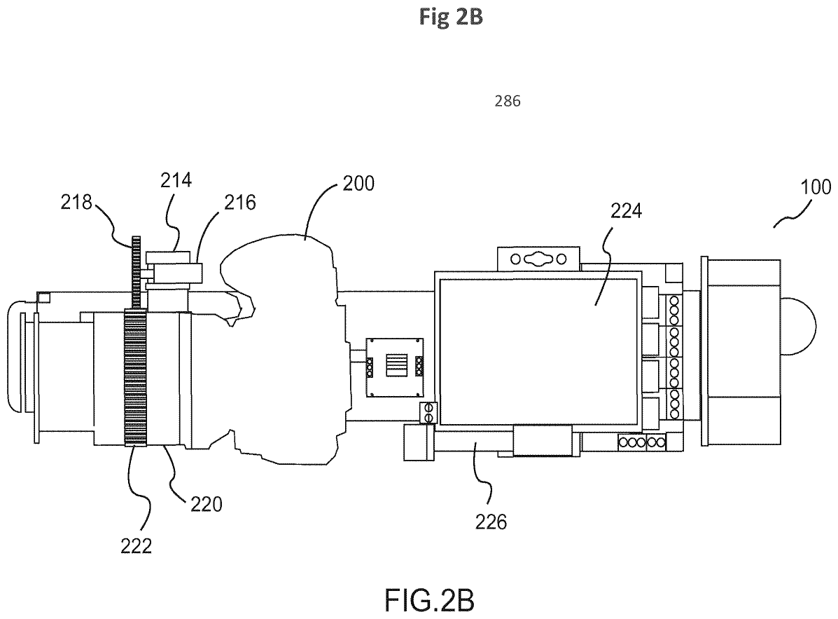

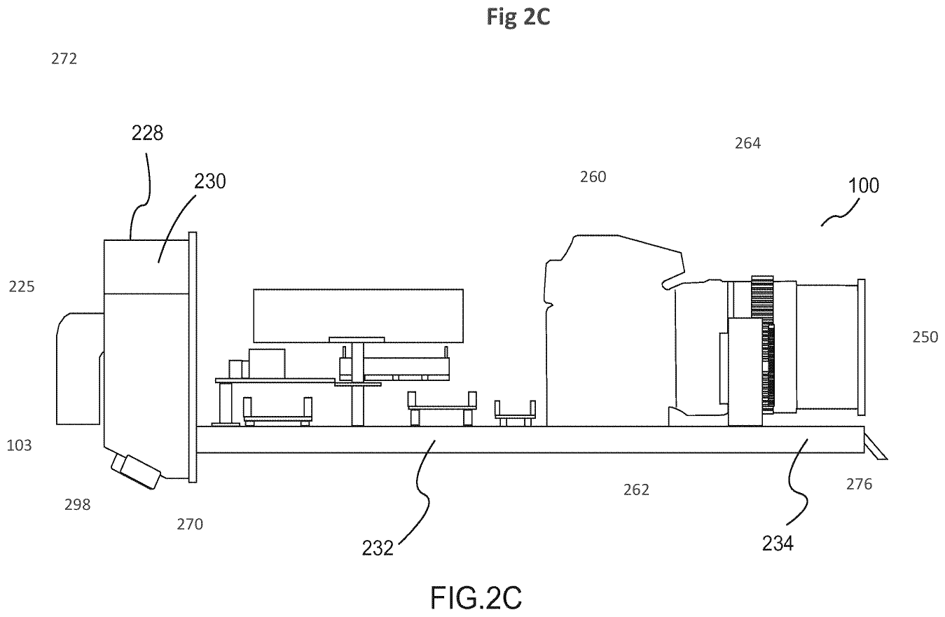

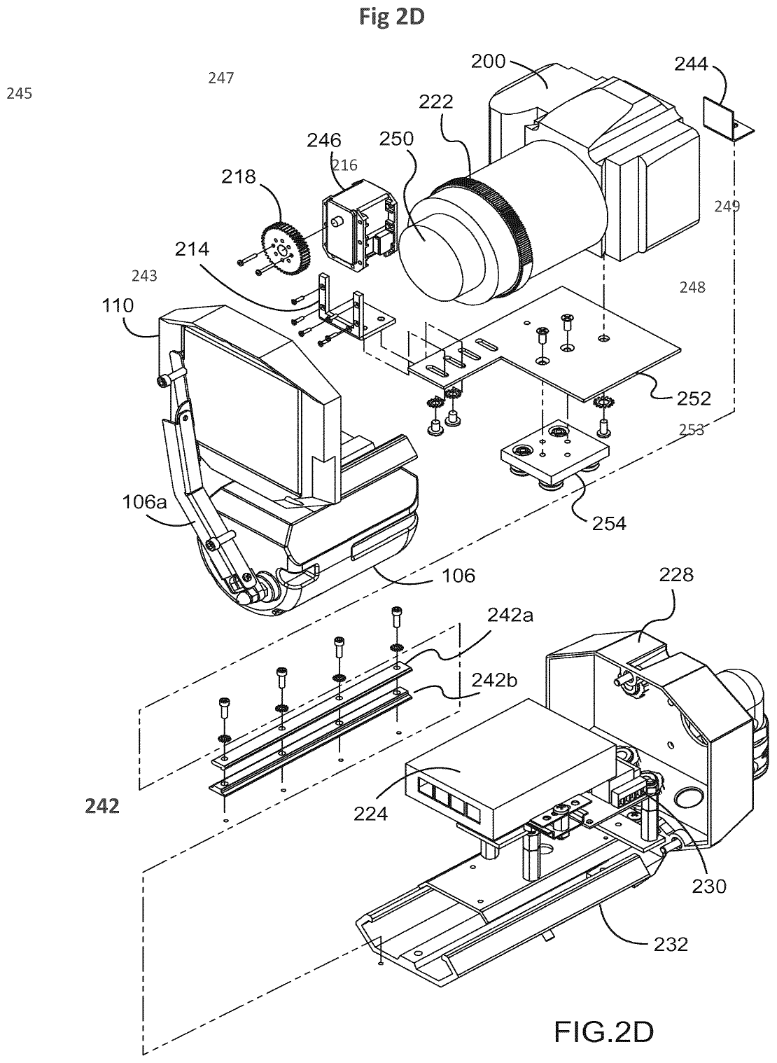

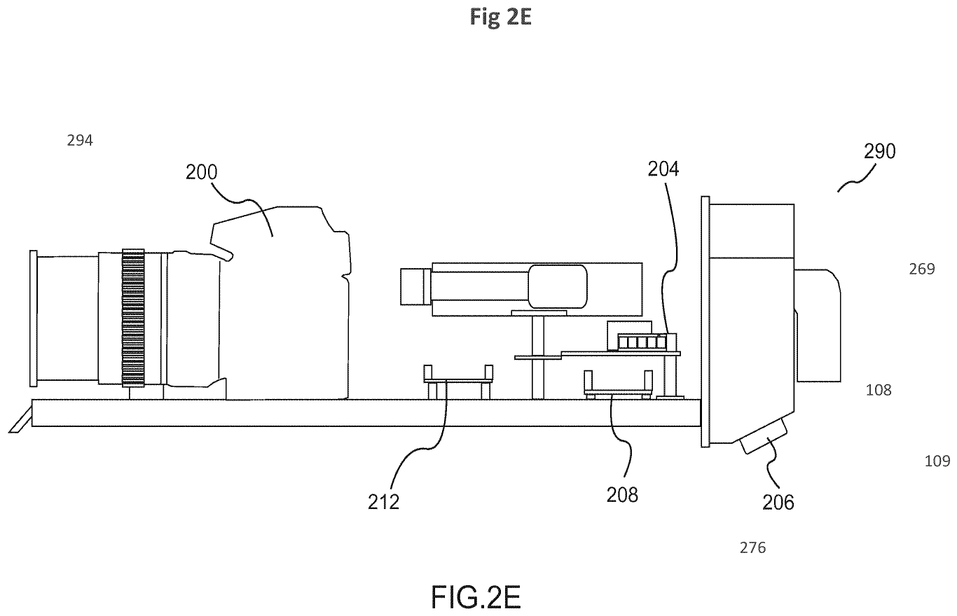

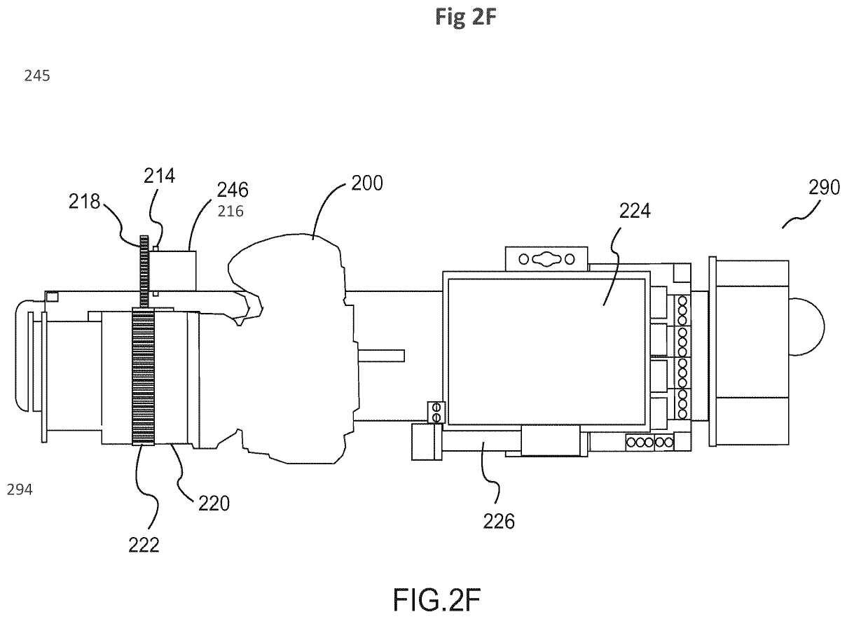

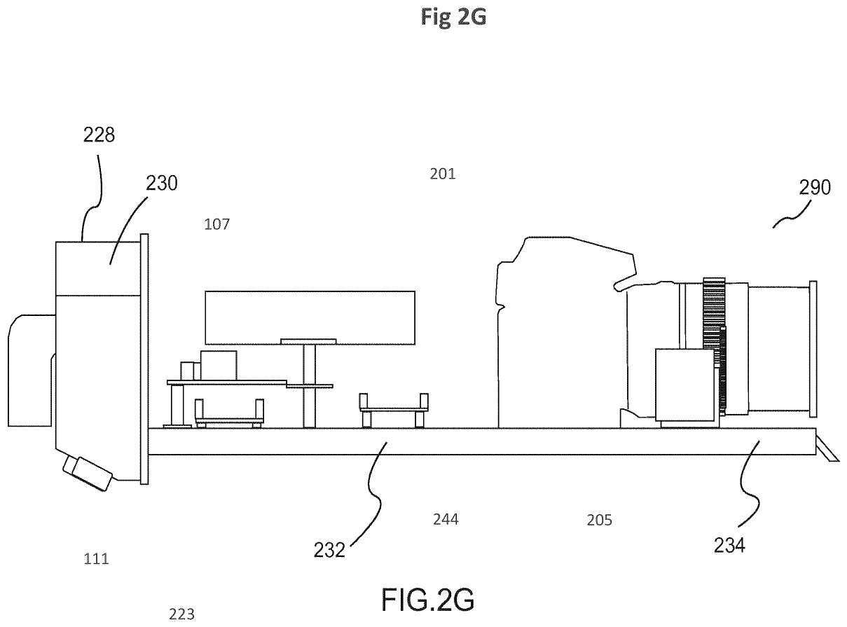

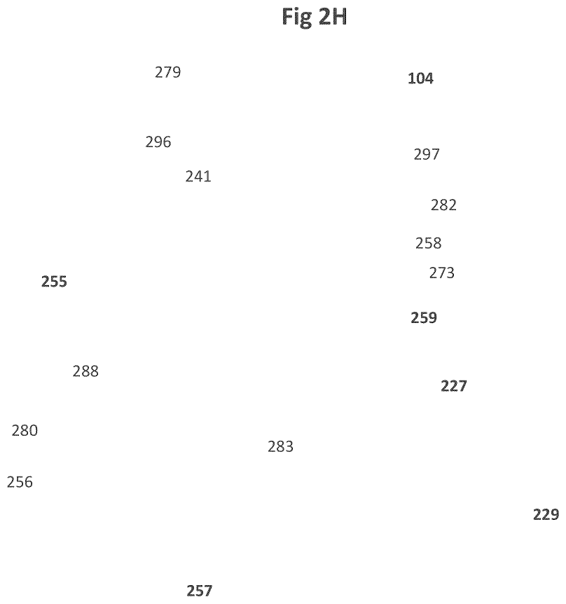

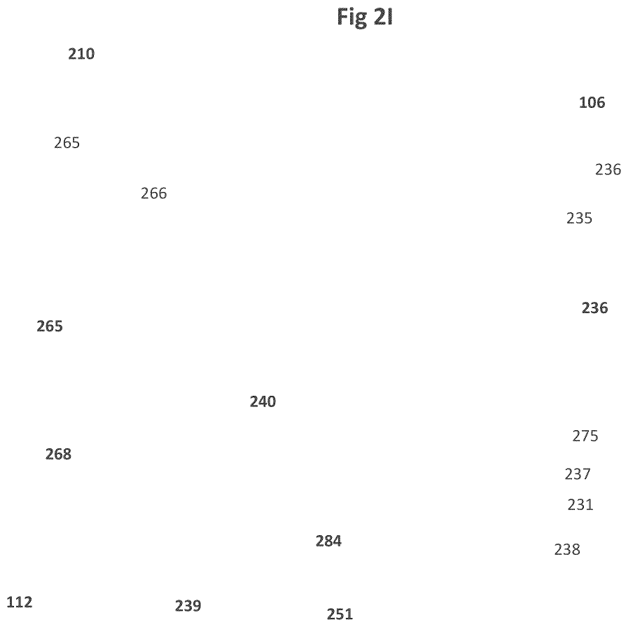

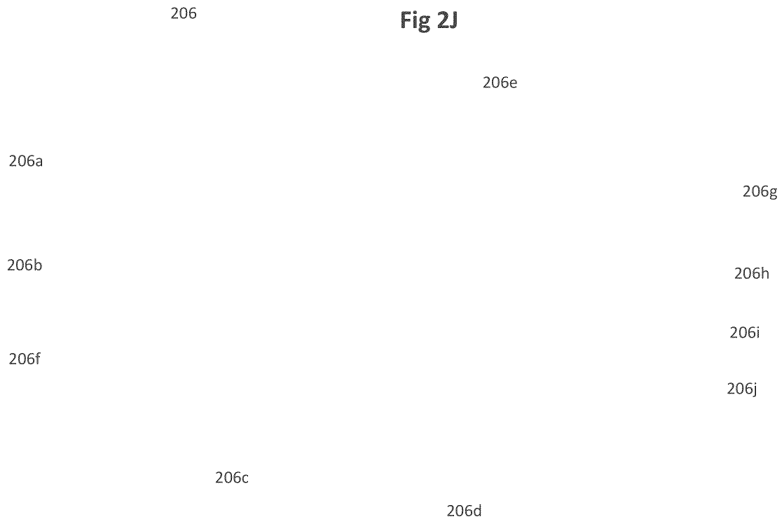

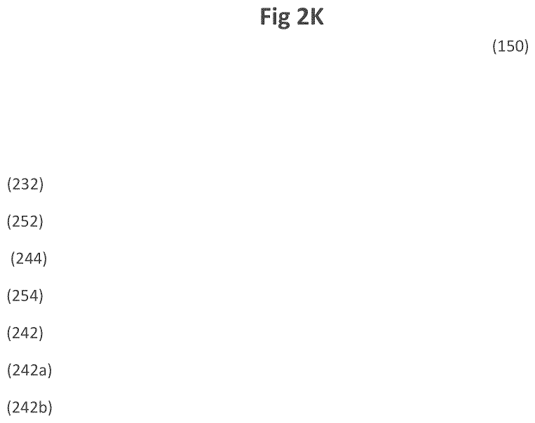

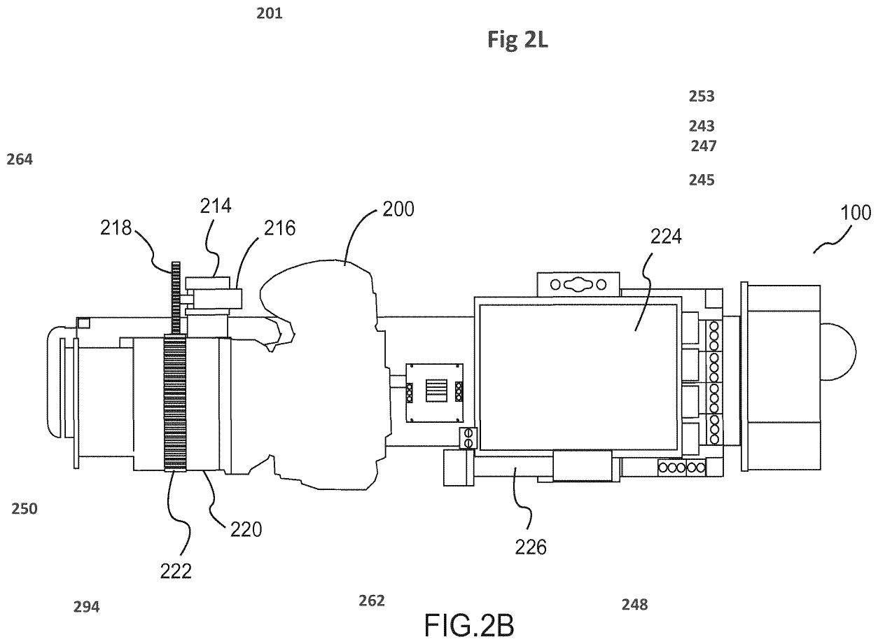

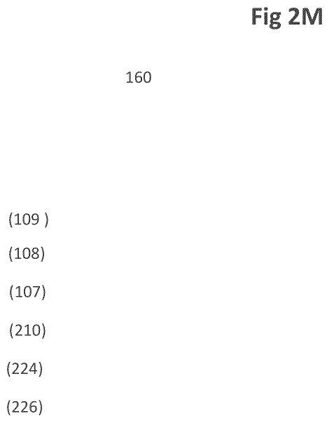

The fifth element of the camera body is a front locking lens mount, hereinafter called ‘lens mount’ (260). See FIG. 2C. A lens mount (260) is located on the front of the camera body. The lens mount is an opening in the front of the camera body. It functions as a mechanical and electronic interface between the Camera Body (200) and the Camera Lens (220). The lens mount (260) includes, but is not limited to including, and may include a spring-loaded pin locking a Camera Lens (220) in place in its proper position, requiring the pin to be retracted when a Camera Lens (220) needs to be detached from the Camera Body (200). The lens mount (260) includes, but may not include, electronic contacts to interface and connect the electronic elements of the Camera Body (200) to the electronic elements of the Camera Lens (220). The lens mount (260) securely locks the front of the Camera Body to the rear of the Camera Lens, that is, the camera lens rear (262). The Camera Body (200) and the Camera Lens (220) are securely attached to each other by the lens mount (260).

The sixth element of the camera body is a Camera Body 360 degree marker (249). See FIG. 2D. A circular 360 degree marker (249) is located on the front of the Camera body.

### Camera Lens Module (201)

The Camera lens module (201) (see FIG. 2L) includes, but is not limited to including, fourteen significant elements and features. Several of these features provide vibration free operation of the camera lens module (201).

The first element of the Camera lens module (201) is a high-definition outlying camera lens, hereinafter called ‘camera lens’ (220). A mechanical assembly of lens elements internal to the camera lens (220) are used to adjust the focal length of the camera lens (220). The focal length of the camera lens (220) can be adjusted from 30 mm, but not limited to 30 mm, to greater than 400 mm, but not limited to 400 mm.

The second element of the Camera lens module (201) is the lens front (250) located in the front of the camera lens (220), hereinafter called ‘camera lens front’ (250). The camera lens front (250) (see FIG. 2C) is a glass front surface of the camera lens (220) which directs light into the camera body (200).

The third element of the Camera lens module (201) is the camera lens rotating lens sleeve, hereinafter called ‘rotating lens sleeve’ (264). See FIG. 2C. The rotating lens sleeve is external to the camera lens (220). It is located on the exterior of the camera lens (220) between the camera lens front (250) and the rear of the camera lens (262). Rotating lens sleeve (264) clockwise and counter-clockwise increases or decreases the focal length of the camera lens (220). A rotating lens sleeve (264) can rotate 360 degrees, but not limited to 360 degrees, clockwise or counterclockwise.

The fourth element of the Camera lens module (201) is the camera lens focus gear, hereinafter called ‘lens focus gear’ (222). A circular nylon, but not limited to nylon, friction free, vibration absorbing, corrosion resistant lens focus gear. A lens focus gear is located at mid-length, but not limited to the mid-length, of the rotating lens sleeve (220). A lens focus gear (222) is located on the outside circumference of the rotating lens sleeve (220). The outside diameter of a rotating lens sleeve (264) relative in size to the inside diameter of the lens focus gear ring (222) is sufficient to allow the lens focus gear ring to be securely compression-fit to the rotating lens sleeve. The face surface of the lens focus gear (222) is installed parallel to the camera lens front (250) to prevent image-distorting vibrations in the camera body (200) and the camera lens (220). A lens focus gear (222) can rotate clockwise and counterclockwise. A rotating lens sleeve (264) can rotate 360 degrees, but not limited to 360 degrees, clockwise or counterclockwise. A fixed degree clockwise and counter-clockwise rotation of a lens focus gear (222) directly causes the same clockwise and counter-clockwise degree rotation of a rotating lens sleeve (264).

The fifth element of the Camera lens module (201) is the lens sleeve benchmark zero-degree marker, hereinafter known as ‘lens zero-degree marker’ (248). See FIG. 2D. The red, but not limited to red, half inch, but not limited to half inch, line lens zero-degree marker is located on the exterior of the rotating lens sleeve (220) proximate the Camera Body 360-degree marker (249) located on the front face of the camera body (200).

The sixth element of the Camera lens module (201) is the expanding and contracting outlying image camera lens rear, hereinafter known as, ‘lens rear’ (262). See FIG. 2C. A lens rear (262) is located at the back of a camera lens (220) and connects with a Camera Body lens mount (260). A lens rear (262) is locked together with a Camera Body by a lens mount (260). As a rotating lens sleeve (264) rotates clockwise or counterclockwise a lens rear (262) expands and contracts moving away from or moving toward a camera lens front (250). As a lens rear (262) expands and contracts a camera body (200), connected to a camera lens (220), moves away from, or moves towards a camera lens front (250).

The seventh element of the Camera lens module (201) is the Servo Motor Gear, hereinafter called ‘servo gear’ (218). See FIG. 2B. A circular nylon, but not limited to nylon, friction free, vibration absorbing, corrosion resistant servo gear. The servo gear (218) is attached to the servo motor (216) of FIG. 2B. The servo gear (218) rotates clockwise or counterclockwise as it is driven clockwise or counterclockwise by the servo motor (218). The teeth of the servo gear (218) mesh with the teeth of the lens focus gear ring (222). The face surface of a servo gear (218) is installed parallel to a face surface of a lens focus gear (222) to prevent image distorting vibrations in the camera body (200) and the camera lens (220). As a servo gear (218) rotates clockwise or counterclockwise it rotates the lens focus gear (222) clockwise or counterclockwise.

The eighth element of the Camera lens module (201) is the servo benchmark zero-degree marker (245), hereinafter known as ‘servo zero-degree marker’ (248). See FIG. 2D. The red, but not limited to red, half inch, but not limited to half inch, line servo zero-degree marker is located on the face of the servo gear (218) approximate to servo motor 360-degree marker (247) located on the servo motor (218).

The ninth element of the Camera lens module (201) is the servo motor (216). See FIG. 2B. The servo motor (216) is an electric 12-volt direct current (VDC), continuous duty, low vibration, self-lubricating electric motor. The servo motor (216) is connected to a servo motor relay on an electrical relay board (204) (see FIG. 2A) for 12 volts direct current (VDC) electric power. An electrical relay board (204) is connected to a camera module and servo motor power supply hereinafter called ‘power supply’ (210) (see FIG. 2A) for electrical 12 VDC power.

A Device Server (224) (see FIG. 2B) is connected to an electrical relay board, hereinafter called ‘relay board’ (204). The device server (224) sends instructions to the relay board (204) to provide power to the servo motor (216) to rotate clockwise or counterclockwise. The device server (224) sends instructions to the relay board (204) to stop providing power to the servo motor (216) to rotate clockwise or counterclockwise. The servo motor (218) rotates the servo motor shaft clockwise or counterclockwise. The device server (224) sends instructions to the relay board (204) for the number of degrees to rotate clockwise or counterclockwise. The device server uses an algorithm to determine the amount of time to close the relays on the relay board (204) to power the servo motor (216) to rotate the servo motor to achieve the desired number of degrees rotation clockwise or counterclockwise.

The servo gear (218) is attached to the shaft of the servo motor. The servo motor (218) rotates the servo motor shaft clockwise or counterclockwise and causes a servo gear (218) to rotate clockwise or counterclockwise.

The tenth element of the Camera lens module (201) is the servo motor 360-degree marker (247). See FIG. 2D. A circular, but not limited to circular, servo motor 360-degree marker (247) is located on the face of the servo motor (218) about the motor shaft. The servo motor 360-degree marker (247) faces the Servo Benchmark zero-degree marker (245) of FIG. 2D. The eleventh element of the Camera lens module (201) is the servo motor mounting bracket, hereinafter referred to as ‘servo bracket’ (214). See FIG. 2D. The servo motor (218) is attached to the face of a servo bracket (214) by six (6), but not limited to six (6), sled mount screws (253). Sled mount stainless steel, but not limited to stainless steel, screws (253) include but are not limited to including a vibration absorbing washer. The bottom of the servo bracket is attached to a vibration absorbing servo motor gasket (243). The bottom of the servo bracket (214) and the servo motor gasket are attached to the camera body sled mount (252) by two (2), but not limited to two (2) sled mount screws (253).

The twelfth element of the Camera lens module (201) is the servo motor gasket (243). See FIG. 2D. The vibration absorbing servo motor gasket is located between the bottom surface of the servo bracket (214) and the top surface of the camera body sled mount (252).

The thirteenth element of the Camera lens module (201) are the sled mount stainless steel, but not limited to stainless steel, screws (253). See FIG. 2D. The sled mount screws (253) include a vibration absorbing washer. Six (6), but not limited to six (6) sled mount screws (253) secure the servo motor (218) to the servo bracket (214). Two (2), but not limited to two (2) sled mount screws (253) secure the servo bracket (214) to the camera body sled mount (252).

The fourteenth element of the Camera lens module (201) is the outlying image camera lens vibration absorbing, adjustable, securing brace with four arms, hereinafter called ‘securing brace’ (294). See FIG. 2E. The circular noose of the securing brace (294) is attached to the circular front of the camera lens (220). The noose of the securing brace (294) is tightly fit to the circular front of the camera lens (220). The four (4) arms, but not limited to four (4) arms, of the securing brace (294) are securely attached to the interior walls of the camera integument wrapper, hereinafter called ‘camera wrapper’ (102). Each leg of the securing brace (294) is securely attached to the camera wrapper by one (1), but not limited to one (1), vibration absorbing sled mount screw (253). The securing brace (294) positions and locks the front of the camera lens (220) close and proximate to the interior face of the DOT AS4 compliant Integument wrapper window, hereinafter called ‘wrapper window’ (110). See FIG. 1. The camera body (200) and the camera lens (220) are locked together by the lens mount (260). The securing bracket (294) supports the combined weight of the camera body (200) and the camera lens (220).

### Camera Integument Wrapper (102)

The second Camera System mechanical element subsystem is the camera integument wrapper, hereinafter called ‘camera wrapper’ (102). See FIG. 1. The camera wrapper (102) encloses a camera module, a vibration absorbing camera body transport module and a camera system data module in a vibration absorbing, impervious, environmentally protective, skin like enclosure. The camera wrapper (102) includes forty-five (45), but not limited to forty-five (45), features and mechanical elements.

The first element of the camera wrapper (102) is the sun shield (102a). See FIG. 1. The sun shield (102a) is located on the top and sides of the camera wrapper (102). The sun shield (102a) provides protection from the heat and UV rays from the sun for the following, but not limited to the following, camera wrapper (102), the camera module, the camera lens module (201) and the data module.

The second element of the camera wrapper (102) is the US Department of Transportation AS-4 windshield standard compliant integument wrapper window, hereinafter called ‘wrapper window’ (110). See FIG. 1. The wrapper window (102) is located in the front of the camera wrapper (102). The wrapper window (110) is attached to the camera wrapper (102) with a weatherproof window frame.

The third element of the camera wrapper (102) is a Federal Motor Vehicle Safety Standard 205 compliant windshield wiper, hereinafter called ‘wiper’ (106a). See FIG. 1. The wiper (106a) is located in the front of the wrapper window (110) and in the camera wrapper (102). The wiper (106a) includes, but is not limited to including, a wiper arm, wiper blade, washer fluid line, washer fluid sprayer, wiper motor, and a wiper movement sensor (278). See FIG. 1. The wiper (106a) moves in front of the wrapper window (110) from left to right, but not limited to moving from left to right. The washer fluid from the wiper (106a) is applied to the wrapper window (110). The wiper blades attached to the wiper (106a) brushes the surface of the wrapper window (110) and clear away the following, but not limited to the following, washer fluid, rain, snow, frost, concrete dust, dirt, mud. A wiper motor is connected to a wiper relay on relay board (204). A wiper relay on a relay board (204) is a two pole but not limited to a two-pole relay.

The fourth element of the camera wrapper (102) is a wiper movement sensor (278). See FIG. 278. The wiper movement sensor (278) is connected to the wiper arm, a part of the wiper (106a). The wiper movement sensor is connected to the vibration free wiper relay on the relay board (204). When the wiper arm (106a) is operating, the wiper relay on the relay board (204) is closed. When the wiper arm (106a) is not operating the wiper relay on the relay board (204) is open. The closed wiper relay on the relay board (204) is connected to the device server (224). When the wiper arm (106a) is operating the wiper relay on the relay board (204) sends a signal to the device server (224) indicating the wiper arm (106a) is moving.

The fifth element of the camera wrapper (102) is a Federal Motor Vehicle Safety Standard 205 compliant window wiper kit, hereinafter called ‘wiper kit’ (106). See FIG. 1. The wiper kit (106) includes, but is not limited to including, wiper fluid (237) including but not limited to FMVSS No. 104 compliant non-freezing wiper fluid, wiper fluid pump (231), wiper fluid container (238), wiper fluid supply line (236), 360-degree wiper fluid supply line connector (235), and wiper fluid level sensor (275).

The wiper fluid (237) is stored in a wiper fluid container (238). See FIG. 2I. A wiper fluid container (238) is positioned on a surface proximate to the camera wrapper (102). A wiper fluid pump is located within a wiper fluid container (238). Electrical power for a wiper fluid pump is supplied by the vibration free wiper fluid pump relay located on an electrical relay board (204). A wiper fluid pump is connected to a wiper fluid supply line (236). A wiper fluid supply line (236) is connected to a 360-degree wiper fluid supply line connector. A wiper fluid line (236) is connected to a wiper arm (106a).

The sixth element of the camera wrapper (102) is a wiper fluid level sensor (275). See FIG. 2I. The wiper fluid level sensor (275) is connected to a wiper fluid container (238). The wiper fluid level sensor (275) is connected to the vibration free wiper fluid level relay on the relay board (204). When the wiper fluid level is full the wiper fluid level relay on the relay board (204) is closed. When the wiper fluid level is not full the wiper fluid level relay on the relay board (204) is open. The closed wiper fluid level relay on the relay board (204) is connected to the device server (224). When the wiper fluid level is full the wiper fluid level relay on the relay board (204) sends a signal to the device server (224) indicating wiper fluid level is full.

The seventh element of the camera wrapper (102) is a Federal Motor Vehicle Safety Standard 10-3 compliant defroster hereinafter called, ‘defroster’ (234). See FIG. 2G. A defroster (234) is connected to a defroster thermostat control board, hereinafter called, ‘defroster thermostat board’ (208). See FIG. 2E. A defroster (234) is connected to the vibration free defroster relay on the relay board (204). A defroster (234) is attached to a camera sled (232). A defroster thermostat control board (208) is attached to a camera sled (232). When the temperature recorded on the thermostat control board is 32 degrees Fahrenheit, but not limited to 32 degrees Fahrenheit, a defroster (234) operates and generates heat. A defroster (234) is connected to a defroster on/off sensor (276).

The eighth element of the camera wrapper (102) is a defroster on/off sensor (276). See FIG. 2E. A defroster on/off sensor (276) is connected to the defroster (234). A defroster on/off sensor (276) is connected to a vibration free defroster relay on the relay board (204). When a defroster (234) is operating a defroster relay on the relay board (204) is closed. When a defroster (234) is not operating a defroster relay on a relay board (204) is open. A closed defroster relay on a relay board (204) is connected to a device server (224). When a defroster (234) is operating a defroster relay on a relay board (204) sends a signal to the device server (224) indicating a defroster (234) is operating.

The ninth element of the camera wrapper (102) is a defroster thermostat controller board, hereinafter called ‘defroster thermostat board’ (208). A defroster thermostat board (208) is attached to a camera sled (232). A defroster thermostat board (208) is connected to a defroster (234). A defroster thermostat board (208) is connected to a vibration free defroster thermostat relay on the relay board (204). A defroster thermostat board (208) is connected to a defroster thermostat sensor (274).

The tenth element of the camera wrapper (102) is a defroster thermostat sensor (276). A defroster thermostat controller board on/off sensor, hereinafter called, ‘defroster thermostat sensor’ (274) is connected to a defroster thermostat (208). A defroster thermostat sensor is connected to a vibration free defroster thermostat sensor relay on the relay board (204). When a defroster thermostat (208) is operating a defroster thermostat sensor relay on the relay board (204) is closed. When a defroster thermostat is not operating a defroster thermostat sensor relay on the relay board (204) is open. A closed defroster thermostat sensor relay on the relay board (204) is connected to a device server (224). When a defroster thermostat controller board (204) is operating a defroster thermostat sensor relay on a relay board (204) sends a signal to a device server (224) indicating a defroster thermostat (204) is operating.

An eleventh element of the camera wrapper (102) is an integument wrapper heavy duty, continuous operation fan, hereinafter called ‘fan’ (230). See FIG. 2G. A fan (230) is located near an integument wrapper rear, hereinafter called ‘wrapper rear’ (228). A fan (230) is attached to wrapper rear (228) by four (4), but not limited to four (4) sled mount screws (253). Sled mount screws (253) include but are not limited to including a vibration absorbing washer. The bottom of the fan (230) is attached to a vibration absorbing fan motor gasket (225). A fan (230) is connected to a fan relay on the relay board (204). A fan (230) is connected to a fan on/off sensor (272).

The twelfth element of the camera wrapper (102) is the fan motor gasket (225). See FIG. 2C. The vibration absorbing servo motor gasket is located between the bottom surface of the fan (230) and the surface of the wrapper rear (228).

The thirteenth element of the camera wrapper (102) is a fan on/off sensor, hereinafter called ‘fan sensor’ (272). See FIG. 2C. A fan sensor (272) is connected to a fan (230). A fan sensor (272) is connected to a vibration free fan relay on the relay board (204). When a fan (230) is operating a fan relay on the relay board (204) is closed. When a fan (230) is not operating a fan relay on the relay board (204) is open. A closed fan relay on the relay board (204) is connected to a device server (224). When a fan (230) is operating a fan relay on a relay board (204) sends a signal to a device server (224) indicating a fan (230) is operating.

The fourteenth element of the camera wrapper (102) is an OSHA compliant air filter, hereinafter called ‘air filter’ (298). See FIG. 2C. An OSHA (29 CFR 1910.134 standard) respirable crystalline silica standard for construction, but not limited to an OSHA standard filter, is located near a wrapper rear (228) and mesh covered vent opening in the rear of the camera wrapper (103).

The fifteenth element of the camera wrapper (102) is an air filter in place and air flow sensor, hereinafter called ‘air filter sensor’ (270). See FIG. 2C. The air filter sensor (270) is located near to an air filter (298). An air filter sensor is connected to a vibration free air filter sensor relay on the relay board (204). When an air filter (298) is present an air filter sensor relay on the relay board (204) is closed. When an air filter (298) is not present an air filter sensor relay on the relay board (204) is open. A closed air filter sensor relay on the relay board (204) is connected to a device server (224). When an air filter (298) is present an air filter sensor relay on a relay board (204) sends a signal to a device server (224) indicating an air filter (298 is present.

The sixteenth element of the camera wrapper (102) is a mesh covered vent opening in the rear of the camera wrapper, hereinafter called ‘rear opening’ (103). See FIG. 2C A rear opening (103) includes, but is not limited to including a superfine, stainless steel, corrosive resistant, bug and pest resistant wire mesh screen.

The seventeenth element of the camera wrapper (102) are Dade County Florida Building Code compliant guy-wires, hereinafter called ‘guy-wires’ (280). See FIG. 2H. The camera wrapper (102) includes, but is not limited to including, four (4) guy-wires (280). A guy-wire (280) is attached to a guy-wire camera system connector (255). See FIG. 2H. A camera system connector (255), including, but limited to including, a vibration absorbing gasket, is attached to a 360 Degree Camera System Pole Support (257). A camera system connector (255) is attached to a 360 Degree Camera System Pole Support (257) by four (4), but not limited to four (4), external bolts (283).

A guy-wire (280) is attached to a guy-wire ground anchor connector (256). See FIG. 2H. A guy-wire ground anchor connector (256) is firmly attached to a surface supporting a 360 Degree Camera System Pole Support (257).

A guy-wire (280) is connected to a guy-wire disconnect sensor (288). See FIG. 2H.

The eighteenth element of the camera wrapper (102) is a guy-wire camera system connector, hereinafter called ‘guy-wire connector’ (255). The stainless steel, but not limited to stainless steel, guy-wire connector (255) includes, but is not limited to including a vibration absorbing gasket. A guy-wire connector (255) is attached to a guy-wire (280) by a stainless-steel fastener, but not limited to a stainless fastener. A guy-wire connector (255) is attached to a 360 Degree Camera System Pole Support (257) by four (4), but not limited to four (4) external bolts (283).

The nineteenth element of the camera wrapper (102) is a guy-wire ground anchor connector, hereinafter called ‘guy-wire anchor’ (256). See FIG. 2H. A guy-wire anchor (256) is attached to a guy-wire (280). A guy-wire anchor (256) is attached to a guy-wire (280) by a by a stainless steel fastener, but not limited to a stainless fastener. A guy-wire anchor (256) is firmly secured to a surface supporting a 360 Degree Camera System Pole Support (257).

The twentieth element of the camera wrapper (102) is a guy-wire disconnect sensor, hereinafter called ‘guy-wire sensor’ (288). A ‘guy-wire sensor’ (288) is connected to a guy-wire (280). A guy-wire sensor (288). is connected to a vibration free guy-wire sensor relay on the relay board (204). When a guy-wire (280) is connected a guy-wire sensor relay on the relay board (204) is closed. When a guy-wire (280) is not connected a guy-wire sensor relay on the relay board (204) is open. A closed guy-wire sensor relay on the relay board (204) is connected to a device server (224). When a guy-wire (280) is connected a guy-wire sensor relay on a relay board (204) sends a signal to a device server (224) indicating a guy-wire (280) is connected.

The twenty first element of the camera wrapper (102) is a stainless steel, but not limited to stainless steel, corrosion resistant, external bolt and nut including, but not limited to including, a vibration absorbing washer hereinafter called ‘external bolt’ (283). See FIG. 2H.

The twenty-second element of the camera wrapper (102) is a Los Angelos County CA Seismic Code compliant camera system supporting strut, hereinafter called ‘strut’ (282). See FIG. 2H. A stainless steel, but not limited stainless steel, non-corrosive, strut (282) is attached to a 360 Degree Camera System Pole Support (257) by two (2), but not limited to two (2), strut to pole connectors (258). A strut to pole connector (258) is fastened to a 360 Degree Camera System Pole Support (257) by two (2), but not limited to two (2) external bolts (283). An external bolt (283) passes through and fastens together a strut to pole connector (258), the strut (282) and the 360 Degree Camera System Pole Support (257). The top of a strut (282) is attached to the bottom of a pedestal mount (241).

+ The twenty-third element of the camera wrapper (102) is stainless steel, but not limited to including stainless steel, non-corrosive strut to pole connector (258), (see FIG. 2H) which includes, but not limited to including a vibration absorbing gasket. A strut to pole connector (258) secures a strut (282) to a 360 Degree Camera System Pole Support (257).

The twenty-fourth element of the camera wrapper (102) is a strut connect sensor (273). See FIG. 2H. A strut connect sensor (273) is connected to a strut (282). A strut connect sensor is connected to a vibration free strut connector relay on the relay board (204). When a strut (282) is attached a strut connector relay on the relay board (204) is closed. When a strut (282) is not attached a strut connector relay on the relay board (204) is open. A closed strut connector relay on the relay board (204) is connected to a device server (224). When a strut (282) is connected a strut connector relay on a relay board (204) sends a signal to a device server (224) indicating a strut (282) is attached.

The twenty-fifth element of the camera wrapper (102) is a Florida Department of Motor Vehicles (FLDMV) 15C-1 Standard compliant safety cable, hereinafter called ‘safety cable’ (227). See FIG. 2H. A safety cable (227) is attached to a strut (282) by a safety cable camera system connector, hereinafter called ‘safety connector’ (259). A safety cable (227) is firmly attached to a surface supporting a 360 Degree Camera System Pole Support (257) by a safety cable anchor (229).

The twenty-sixth element of the camera wrapper (102) is a Florida Department of Motor Vehicles (FLDMV) 15C-1 Standard compliant safety cable anchor (229). See FIG. 2H. A safety cable anchor (229) is fastened to a safety cable (227) by a stainless steel, but not limited to stainless steel, fastener.

The twenty-seventh element of the camera wrapper (102) is a Florida Department of Motor Vehicles (FLDMV) 15C-1 Standard compliant safety cable camera system connector, hereinafter called ‘safety connector’ (259). See FIG. 2H. A safety connector (259) is fastened to a safety cable (227) by a stainless steel, but not limited to stainless steel, fastener.

The twenty-eighth element of the camera wrapper (102) is a 360 Degree Camera System Pole Support hereinafter called ‘pole mount’ (257). See FIG. 2H. A stainless steel non-corrosive, but not limited to stainless steel, cylindrical pole forty (40) feet tall, but not limited to forty (40) feet tall and three (3) inches, but not limited to three (3) inches in diameter. A pole mount (257) is securely anchored to supporting surface including, but not limited to a roof top, tower, or ground. A pole mount (257) is installed in such a manner to allow the camera system a 360-degree pan, but not limited to 360 degrees and a 180 degree tilt but not limited to 180 degrees.

The twenty-ninth element of the camera wrapper (102) is a stainless steel, but not limited to stainless steel, non-corrosive pedestal mount (241). See FIG. 2H. A pedestal mount (241) includes, but is not limited to including, a top vibration absorbing gasket and a bottom vibration absorbing gasket. The bottom of pedestal mount (241) including, but not limited to including, a vibration absorbing gasket is attached to the top of a strut (282). A pedestal mount (242) is secured to a strut (282) by four (4), but not limited to four (4) external bolts (283). The top of a pedestal mount (242) including, but not limited to including, a vibration absorbing gasket is attached to the bottom of a quiver buffer (296). A pedestal mount (242) is secured to a quiver buffer (296) by four (4), but not limited to four (4) external bolts (283).

The thirtieth element of the camera wrapper (102) is a Los Angelos County CA Seismic Code compliant camera integument wrapper quiver buffer, hereinafter called ‘quiver buffer’ (296). See FIG. 2H. A quiver buffer (296) absorbs and dampens the movement of a strut (282) caused by ground tremors and quivers, but not limited to ground tremors and quivers. The bottom of a quiver buffer (296) is attached to the top of a pedestal mount (241) by four (4), but not limited to four (4) external bolts (283). The top of a quiver buffer (296) is attached to the bottom of a pan/tilt base (104) by four (4), but not limited to four (4) external bolts (283). See FIG. 2H. A quiver buffer (296) is connected to a quiver buffer sensor (297).

The thirty-first element of the camera wrapper (102) is a quiver buffer sensor (297). See FIG. 2H. A quiver buffer sensor (297) is connected to a quiver buffer (296). A quiver buffer sensor is connected to a vibration free quiver buffer relay on the relay board (204). When a quiver buffer (297) is operating a quiver buffer relay on the relay board (204) is closed. When a quiver buffer (297) is not operating a quiver buffer relay on the relay board (204) is open. A closed quiver buffer relay on the relay board (204) is connected to a device server (224). When a quiver buffer (297) is operating a quiver buffer relay on a relay board (204) sends a signal to a device server (224) indicating a quiver buffer (297) is operating.

The thirty-second element of the camera wrapper (102) is a pan/tilt mechanism and base, hereinafter called ‘pan/tilt’ (104) of FIG. 1. The bottom of a pan/tilt (104) is attached to the top of a quiver buffer (296) by four (4), but not limited to four (4) external bolts (283). The bottom of a pan/tilt (104) is attached to the top of a quiver buffer (296) including a vibration absorbing gasket, but not limited to including a vibration absorbing gasket. A pan/tilt (104) is attached to the side of a camera wrapper (102) by a stainless steel fastener and watertight and vibration absorbing gasket but not limited to including a stainless steel fastener or gasket. A pan/tilt includes, but is not limited to including a heavy duty, continuous cycle, vibration absorbing electric motor located within the pan/tilt. A pan/tilt (104) weighs twelve (12) pounds but is not limited to weighing twelve (12) pounds. A pan/tilt (104) can pan 360 degrees continuously, but is not limited to panning 360 degrees continuously. A pan/tilt (104) can tilt +90 degrees to −90 degrees from level but is not limited from tilting +90 degrees to −90 degrees from level. A motor included withing a pan/tilt (104) is connected to an electric power cable (265) of FIG. 2H through a pan relay located on a relay board (204). A motor included within a pan/tilt (104) is connected to an electric power cable (265) through a tilt relay located on a relay board (204). A pan/tilt (104) pans when a device server (224) sends a signal to a pan relay located on a relay board (204). A pan/tilt (104) tilts when a device server (224) sends a signal to a tilt relay located on a relay board (204).

A pan/tilt (104) is connected to a pan/tilt movement sensor (279) of FIG. 2H.

The thirty-third element of the camera wrapper (102) is a pan/tilt movement sensor (279). A pan/tilt movement sensor (279) is connected to a pan/tilt (104). A pan/tilt movement sensor is connected to a vibration free pan relay and a tilt relay on a relay board (204). When a pan is operating a pan relay on the relay board (204) is closed. When a pan (104) is not operating a pan relay on the relay board (204) is open. A closed pan relay and a closed tilt relay on the relay board (204) are connected to a device server (224). When a pan/tilt (104) is operating a pan, a, pan relay on a relay board (204) sends a signal to a device server (224) indicating a pan/tilt (104) is panning. When a pan/tilt (104) is operating a tilt, a, tilt relay on a relay board (204) sends a signal to a device server (224) indicating a pan/tilt (104) is tilting.

The thirty-fourth element of the camera wrapper (102) is a wrapper rear (228). See FIG. 2D. A wrapper rear (228) includes but is not limited to including a fan (230), fan motor gasket (225), camera wrapper rear opening (103), air filter (298), air filter in place sensor (270) and wrapper cable conduit connector (269).

The thirty-fifth element of the camera wrapper (102) is a wrapper cable conduit connector, hereinafter called ‘conduit connector’ (269). See FIG. 2E. A stainless steel, but not limited to stainless steel, conduit connector (269) includes, but is not limited to including a watertight gasket between a wrapper rear (228) and a conduit connector (269). A conduit connector (269) includes, but is not limited to including a vibration absorbing gasket between a wrapper rear (228) and a conduit connector (269). An electric cable (265) passes through a conduit connector (269) and into the camera wrapper (102). A network cable (109) passes through a conduit connector (269) and into the camera wrapper (102).

The thirty-sixth element of the camera wrapper (102) is an electrical relay board hereinafter called ‘relay board’ (204). See FIG. 2E. A relay board (204) includes but is not limited to a servo motor relay, vibration free wiper relay, wiper fluid pump relay, defroster relay, free thermostat controller board relay, fan relay, air filter sensor relay, guy-wire sensor relay, strut connector relay, quiver buffer relay, pan relay, tilt relay, pan/tilt relay and backup power relay. A relay board (204) includes but is not limited to 5 VDC or 12 VDC relays. A relay board (204) includes but is not limited vibration free relays. A relay board (204) includes but is not limited to magnetic relays. Such relay includes but are not limited to including two poles. A relay board (204) includes but is not limited to an AC to DC 12V and 5V power converter. An AC to DC 12V and 5V power converter provides power to, but not limited to relays included on the relay board (204), wiper fluid pump (231), wiper (106a), a motor included within a pan/tilt (104).

A relay board (204) is connected to a device server (224). See FIG. 2B. A relay board (204) is connected to an image storage device (226). A relay board (204) is connected to a communications system (107).

A relay board (204) is attached to device server support (223) (see FIG. 2G) by four (4), but not limited to four (4) sled mount screws (253). A sled mount screw (253) includes but may not include a vibration absorbing washer.

The thirty-seventh element of the camera wrapper (102) is an external status indicator, hereinafter called ‘status indicator’ (206). See FIG. 2A. A status indicator (206) located external to the camera wrapper (102) and on the bottom of the wrapper rear (228). A status indicator (206) is attached to the wrapper rear (228) by four (4), but not limited to four (4) sled mount screws (253). A sled mount screw (253) includes but may not include a vibration absorbing washer. A status indicator (206) includes but is not limited to including six (6) LED displays. An LED display is visible from a distance from the camera. A status indicator (206) includes but is not limited to including six (6) LED displays. An LED display shows camera system status information and codes which are visible from a distance from the camera. A status indicator (206) includes but is not limited to including five (5) color status indicators. The color status includes but not limited to including system on, system off, network connection failure, maintenance required, and component failure. A status indicator (206) is connected to a status indicator control board (212). See FIG. 2A. A status indicator (206) is connected to a status indicator control board (212) for electrical power. A status indicator (206) receives error codes from a status indicator control board (212) and displays the error codes on the LED displays for LED 206a-LED 206f but not limited to LED 206a-LED 206f. A status indicator (206) receives system status conditions from a status indicator control board (212) and displays the system status conditions on a colored for status indicator 206g-Indicator 206j but not limited to 206g-Indicator 206j.

The thirty-eighth element of the camera wrapper (102) is a status indicator control board (212). A status indicator control board (212) is attached to a camera sled (232) by four (4) sled mount screws (253). A sled mount screw (253) includes but may not include a vibration absorbing washer. A status indicator control board (212) is connected to a device server (224). A status indicator control board (212) receives camera system status information and codes from a device server (224).

See FIG. 2J for an illustration of the status indicators described below.

A Status LED 206A is connected to a vibration free LED 206A relay on a status indicator control board (212). When a LED 206A is displaying, an LED 206A relay on a status indicator control board is closed.

A Status LED 206B is connected to a vibration free LED 206B relay on a status indicator control board (212). When a LED 206B is displaying, an LED 206B relay on a status indicator control board is closed.

A Status LED 206C is connected to a vibration free LED 206C relay on a status indicator control board (212). When a LED 206C is displaying, an LED 206C relay on a status indicator control board is closed.

A Status LED 206D is connected to a vibration free LED 206D relay on a status indicator control board (212). When a LED 206D is displaying, an LED 206D relay on a status indicator control board is closed.

A Status LED 206E is connected to a vibration free LED 206E relay on a status indicator control board (212). When a LED 206E is displaying, an LED 206E relay on a status indicator control board is closed.

A Status LED 206F is connected to a vibration free LED 206F relay on a status indicator control board (212). When a LED 206F is displaying, an LED 206F relay on a status indicator control board is closed.

A Status Indicator 206g is connected to a vibration free Status Indicator 206g relay on a status indicator control board (212). When a Status Indicator LED 206g is illuminated, a Status Indicator 206g relay on a status indicator control board is closed.

A Status Indicator 206h is connected to a vibration free Status Indicator 206h relay on a status indicator control board (212). When a Status Indicator LED 206h is illuminated, a Status Indicator 206h relay on a status indicator control board is closed.

A Status Indicator 206i is connected to a vibration free Status Indicator 206i relay on a status indicator control board (212). When a Status Indicator LED 206i is illuminated, a Status Indicator 206i relay on a status indicator control board is closed.

A Status Indicator 206j is connected to a vibration free Status Indicator 206j relay on a status indicator control board (212). When a Status Indicator LED 206j is illuminated, a Status Indicator 206j relay on a status indicator control board is closed.

A status indicator control board (212) (see FIG. 2E) is connected to a status indicator (206). A status indicator control board (212) transmits the camera system status information and codes to the status indicator (206) where the camera system status information and codes are displayed. A status indicator control board (212) is connected to a camera module and servo motor power supply hereinafter called ‘power supply’ (210). A status indicator control board (212) receives electrical power from a power supply (210).

The thirty-nineth element of the camera wrapper (102) is an AC external power source hereinafter called ‘AC power source’ (268). See FIG. 2I. An AC power source (268) includes a watertight, non-corrosive, outdoor electrical junction box compliant with National Electrical Manufacturers Association (NEMA) standards. An AC power source (268) interfaces with standard external electric service 120/240 volts AC 40 amps, but not limited to 40 amps. An AC power source (268) includes but is not limited to including an electric surge suppressor. An AC power source (268) includes but is not limited to including an AC electric circuit breaker, hereinafter called ‘AC breaker’ (112). See FIG. 2I. An AC power source (268) is connected to an automatic power transfer switch (240). An AC power source (268) is located proximate to a standard electric service outlet.

The fortieth element of the camera wrapper (102) is a backup power supply (239) (see FIG. 2) is battery powered but not limited to battery power. A backup power supply (239) is connected to an automatic power transfer switch (240). A backup power supply (239) is connected to an automatic power transfer switch (240). A backup power supply (239) is connected to a solar panel battery charger (284), but not limited to connecting to a solar panel charger. A backup power supply (239) is connected to backup power supply sensor (251). A backup power supply (239) is located proximate to an AC power source (268).

The forty-first element of the camera wrapper (102) is a backup power supply sensor (251). See FIG. 2I. A backup power supply sensor (251) is connected to a backup power supply (239). A backup power supply sensor (251) is connected to a vibration free backup power relay on the relay board (204). When a backup power supply (239) is operating and providing power to a camera system (100) a backup power relay on the relay board (204) is closed. When backup power supply (239) is not operating and providing power to a camera system (100) a backup power relay on the relay board (204) is open. A closed backup power relay on the relay board (204) is connected to a device server (224). When a backup power supply (239) is operating and providing power to a camera system (100) a backup power relay on a relay board (204) sends a signal to a device server (224) indicating a backup power supply (239) is operating and providing power to a camera system (100).

The forty-second element of the camera wrapper (102) is a solar panel battery charger, hereinafter called ‘solar panel’ (284). See FIG. 2I. A solar panel (284) is connected to backup power supply (239). A solar panel (284) charges the batteries in a backup power supply (239). A solar panel (284) is located proximate to a backup power supply (239).

The forty-third element of the camera wrapper (102) is an automatic power transfer switch, hereinafter called ‘transfer switch’ (240). See FIG. 2I. A transfer switch (240) is connected to an AC power source (268). A transfer switch (240) is connected to a backup power supply (239). A transfer switch (240) is located proximate to a backup power supply (239). A transfer switch (240) includes control logic which constantly monitors the electrical power source associated with an AC power source (268). Upon failure of a connected power source associated with an AC power source (268), a transfer switch (240) will automatically transfer the electrical load circuit to a backup power supply (239). When a connected power source associated with an AC power source (268) is returned to service, a transfer switch (240) will automatically transfer the electrical load circuit from a backup power supply (239) to an AC power source (268).

The forty-fourth element of the camera wrapper (102) is an electric power cable (265). See FIG. 2I. An electric power cable (265) is connected to a transfer switch (240) with a watertight, but not limited to including a watertight electrical connector. An electric power cable (265) is connected to a power supply (210) with a watertight, but not limited to including a watertight electrical connector. An electric power cable (265) carries electrical power to a power supply (210). An electric power cable (265) includes but is not limited to including a watertight, waterproof, insulating, cut resistant, ultraviolet resistant outer sheath.

The forty-fifth element of the camera wrapper (102) is a 360 Degree Electric Power Cable Connector (266). See FIG. 2I. A 360 Degree Electric Power Cable Connector (266) is located within an electric power cable (265) and toward the top of an electric power cable (265). A 360 Degree Electric Power Cable Connector (266) is connected to an electric power cable (265) with a watertight, but not limited to including a watertight electrical connector. A 360 Degree Electric Power Cable Connector (266) allows the camera wrapper (102) to pan 360 degrees continuously without binding an electric power cable (265).

### Camera Body Support Transport Module ‘Camera Body Support’ (150)

The third Camera System mechanical element subsystem is the vibration absorbing camera body support transport module, hereinafter called “camera body support’ (150). See FIG. 2K. A camera body support (150) is located inside a camera wrapper (102). A camera body support (150) is attached to a camera wrapper (102).

A camera body support (150) provides a vibration free platform for a camera body as a camera body (200) is moved toward and away from a wrapper window (110) and simultaneous moves forward and away from a camera lens front (250). A camera body (200) is attached to a camera lens (220) by a lens mount (260). The weight of a camera body (200) is supported by a securing brace (294). See FIG. 2E. A securing brace (294) attaches a camera lens front (250) securely and in a fixed position to a camera wrapper (102). As a gear ring (222) (see FIG. 2D) rotates a lens sleeve (264) causing the lens rear (262) to expand and contract, a camera body (200) is moved forward and away from a wrapper window (110) and simultaneous moves forward and away from a camera lens front (250).

As a camera body (200) of FIG. 2D is moved forward and away from a wrapper window (100) by a stationary camera lens (220), vibration to the camera body (200), associated with a camera body (200) moving, is absorbed by the vibration absorbing camera body support transport (150) of FIG. 2K.

The camera body support (150) includes seven (7), but not limited to seven (7), features and mechanical elements.

The first element of a camera body support (150) is a camera body sled (232). See FIG. 2D. A camera body sled (232) is attached to a wrapper rear (228). The surface of a camera body sled (232) includes but may not include a friction free, vibration absorbing.

The second element of a camera body support (150) is a Camera Body Sled Mount, hereinafter called ‘sled mount’ (252). See FIG. 2D. A sled mount (150) is positioned above a camera body sled (232). A sled mount (252) includes seven (7) but not limited to seven (7) openings for sled mount screws (253). A sled mount (252) is attached to a servo bracket (214). A sled mount (252) is attached to a servo motor gasket (243). A sled mount (252) is attached to a linear carriage (254).

A gear ring (222) of FIG. 2D rotates lens sleeve (264) of FIG. 2L causing lens rear (262) to expand and contract, causing a camera body (200) to move toward and away from a wrapper window (110) and simultaneous moved forward and away from a camera lens front (250).

A camera body (200) is mounted on a sled mount (252). See FIG. 2D A sled mount (252) provides a stable platform for a camera body (200) while a camera body (200) is moved toward and away from a wrapper window (110) and simultaneous moved forward and away from a camera lens front (250).

A sled mount (252) is attached to a linear carriage (254) of FIG. 2D. A linear carriage (254) allows the sled mount (252) to move toward and away from a wrapper window (110) and simultaneous move forward and away from a camera lens front (250).

The third element of a camera body support (150) is a linear carriage (254) of FIG. 2D. A linear carriage includes four (4) but not limited to four (4) wheels. Said wheels are friction free and vibration absorbing but not limited to friction free and vibration absorbing. A linear carriage (254) is located beneath a sled mount (252) with anti-vibration rollers. A linear carriage (254) engages a track rail guide assembly (242). A track rail guide assembly (242) is located on the top surface of a camera body sled (232). A linear carriage (254) allows a sled mount (252) to move toward and away from a wrapper window (110) and simultaneous move forward and away from a camera lens front (250).

The fourth element of a camera body support (150) is a track rail guide assembly (242). See FIG. 2D. A track rail guide assembly (242) includes but is not limited to including a track rail (242a), track rail support (242b) (see FIG. 2D) and four (4) but not limited to four (4) sled mount screws (253) (also shown in FIG. 2D). A track rail (242a) and track rail support (242b) includes but may not include a friction free and vibration absorbing surface coating.

The fifth element of a camera body support (150) is a camera body sled lock guide hereinafter called ‘sled lock’ (244). See FIG. 2D. A sled lock (244) is attached to a track rail (242a). A sled lock (244) is located proximate to the back of a camera body (200). A sled lock (244) includes, but is not limited to including a cushioned vibration absorbing sled lock gasket (205). A sled lock (244) stops a camera body (200) from moving too far backward.

### Camera System Data Module (160)

The fourth Camera System mechanical element subsystem is the camera system data module, hereinafter called ‘data module’ (160). See FIG. 2M A data module (160) includes six (6) elements but is not limited to including six (6) elements.

The first element of data module (160) is a network cable (109). See FIG. 1. A network cable (109) is wired or wireless but not limited to wired or wireless. A network cable (109) is compliant with Institute of Electrical and Electronics Engineers (IEEE) standards but not limited to IEEE standards. A network cable (109) is CAT5, CAT5e, or CAT6 compliant but not limited to CAT5, CAT5e, or CAT6 compliant. A network cable (109) is connected to a camera wrapper (102) by an outdoor, watertight, corrosion resistant, military grade connector but not limited to an outdoor, watertight, corrosion resistant, military grade connector.

The second element of data module (160) is a network connector (108) of FIG. 1. A network connector (108) is compliant with Institute of Electrical and Electronics Engineers (IEEE) standards but not limited to IEEE standards. A network connector (108) is attached to a camera wrapper (108). A network connector is wired or wireless but not limited to wired or wireless. A network connector (108) is outdoor rated, watertight, corrosion resistant, military grade connector, stainless steel but not limited to is outdoor rated, watertight, corrosion resistant, military grade connector, stainless steel.

The third element of data module (160) is a communication system (107). See FIG. 2G. A communication system (107) includes but is not limited to including a wireless cellular modem system, a wireless point-to-point system, a wired point-to-point system, a wireless system connection to the Internet, or a hard-wired system connection to the Internet. A communication system (107) includes but is not limited to including dynamic or static IP addressing. A communication system (107) is attached to a device server support (223) of FIG. 2G by four (4), but not limited to four (4) sled mount screws (253) of FIG. 2D. A sled mount screw (253) includes but may not include a vibration absorbing washer.

The fourth element of data module (160) is a camera module and servo motor power supply, called ‘power supply’ (210). See FIG. 2A. A power supply (210) inputs electric service 120/240 volts AC 40 amps, but not limited to 120/240 volts AC 40 amps and converts the electric service to 5 VDC, 12 VDC, 24 VDC but not limited to 5 VDC, 12 VDC, 24 VDC. A power supply (210) is attached to a device server support (223) by four (4), but not limited to four (4) sled mount screws (253). A sled mount screw (253) includes but may not include a vibration absorbing washer.

A power supply (210) is connected to but not limited to being connected to a servo motor (216), (see FIG. 2B) a wiper fluid pump (106a), a motor included within a pan/tilt (104), a status indicator control board (212) a relay board (204).

The fifth element of a data module (160) is a device server (224). See FIG. 2B. A device server (224) is attached to a device server support (223) by four (4), but not limited to four (4) sled mount screws (253). A sled mount screw (253) includes but may not include a vibration absorbing washer.

A device server (224) includes but is not limited to including a Linux operating system. A device server (224) includes but is not limited to including an Advanced RISC Machines (ARM) CPU.

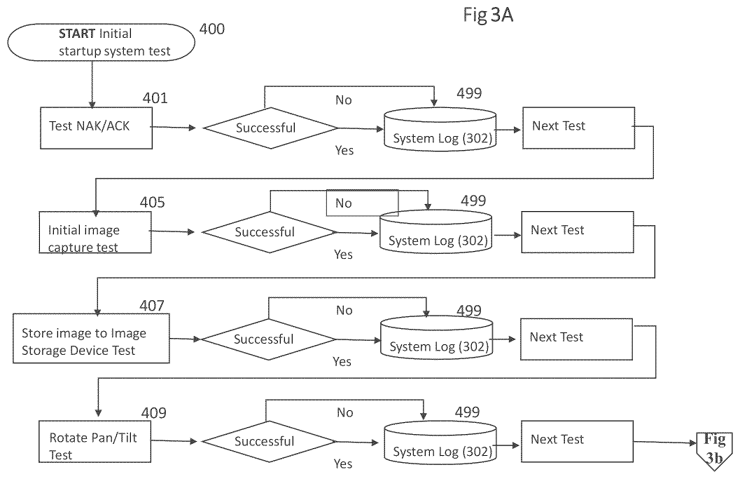

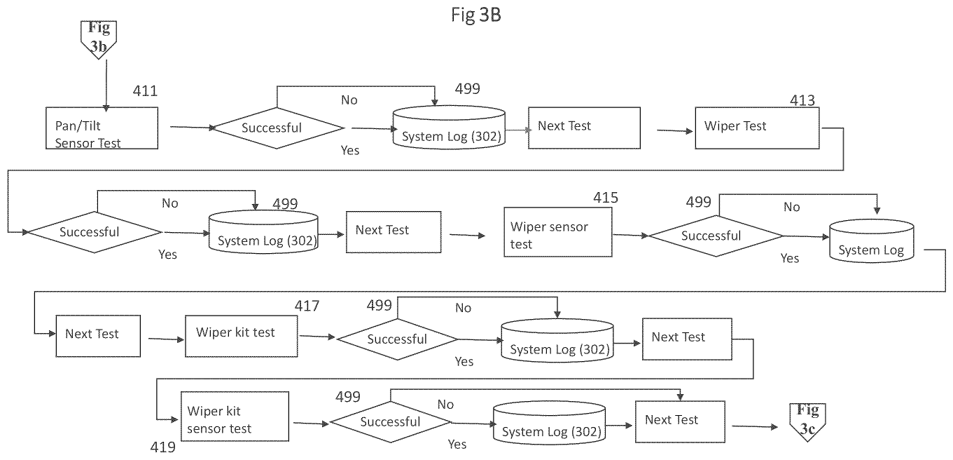

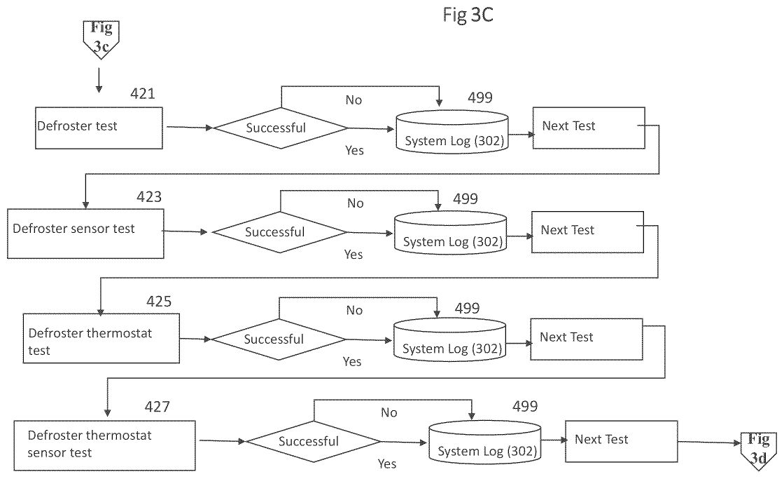

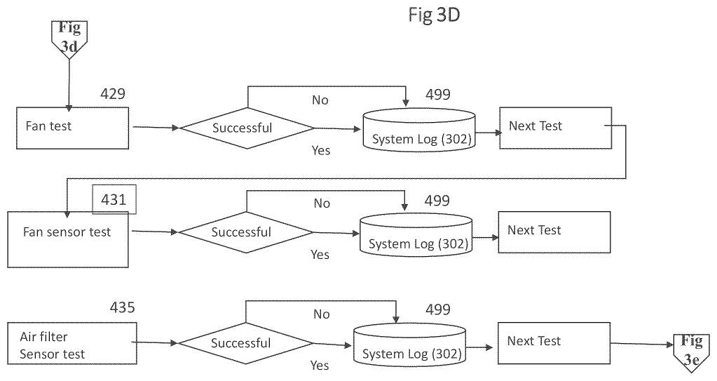

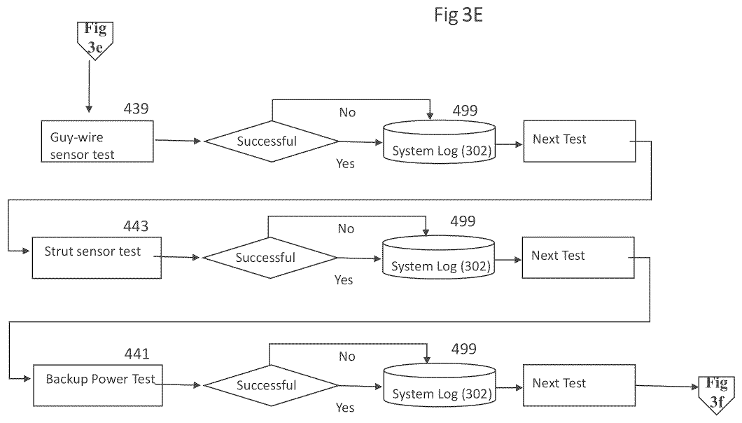

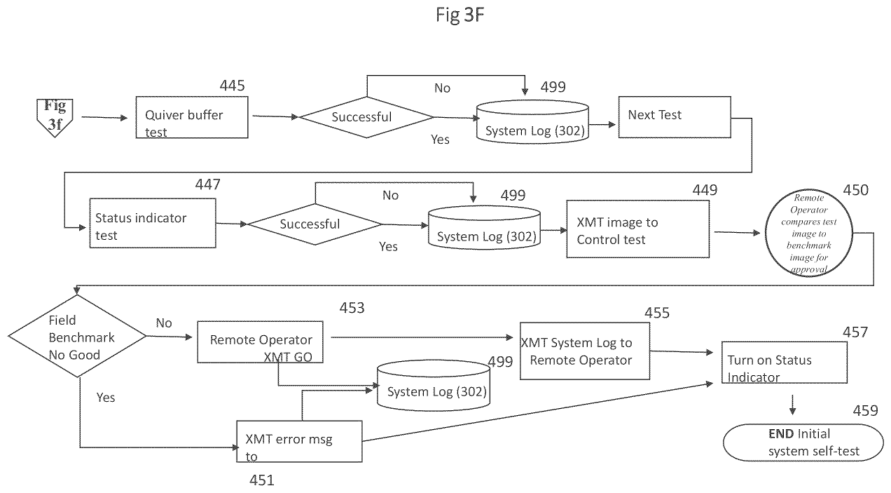

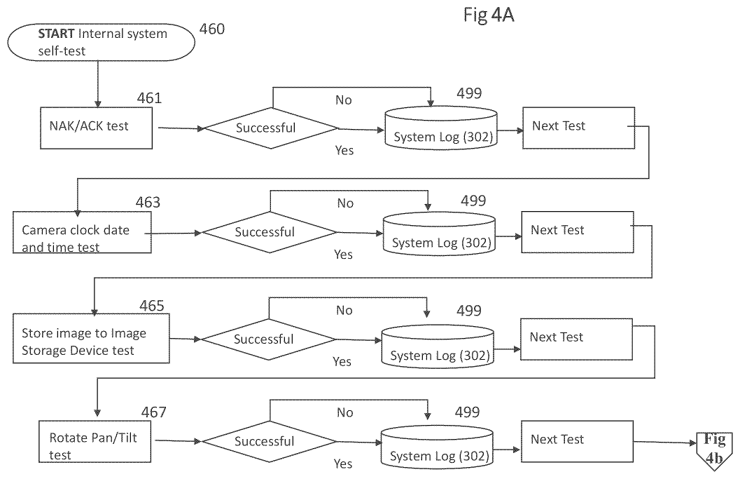

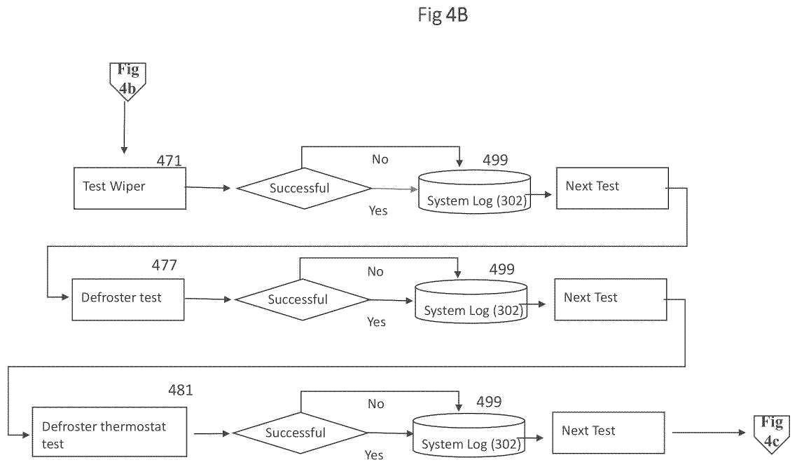

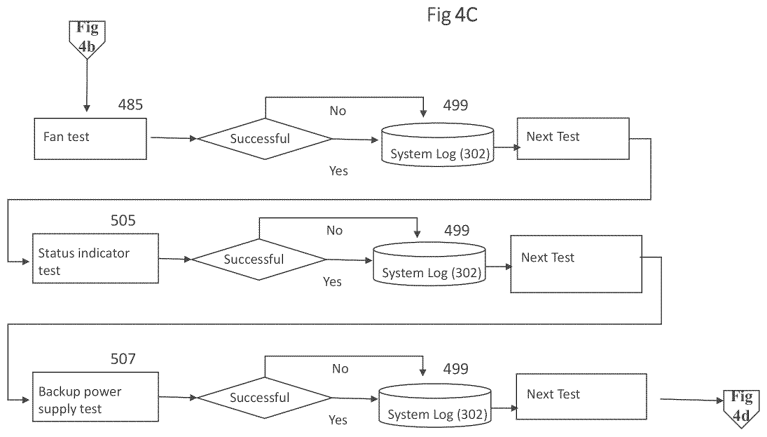

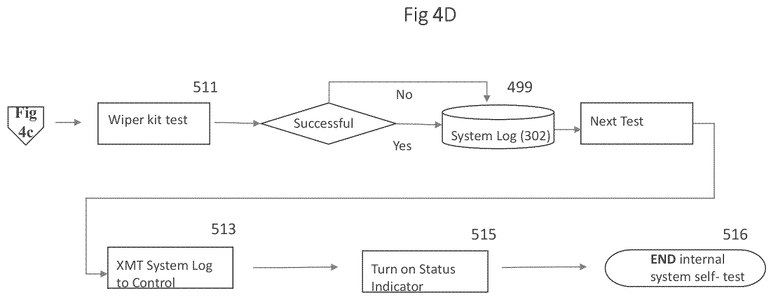

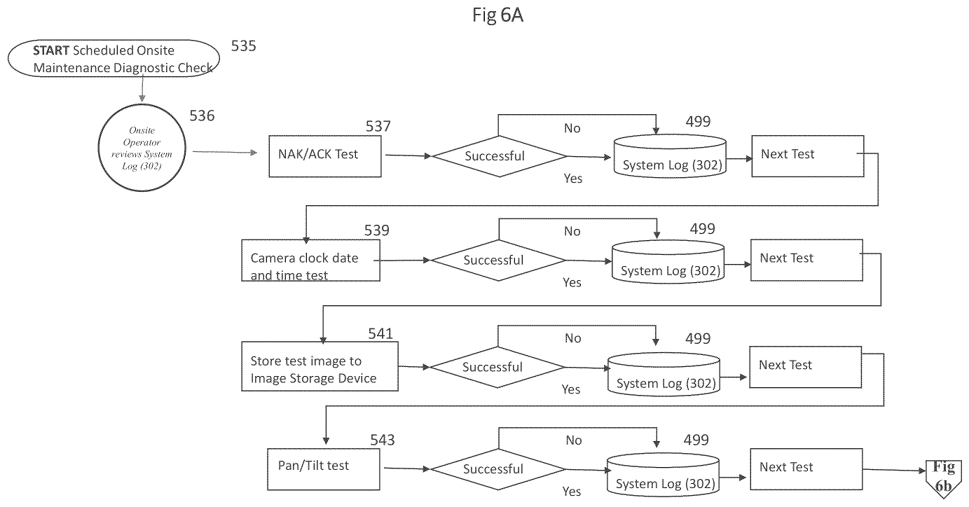

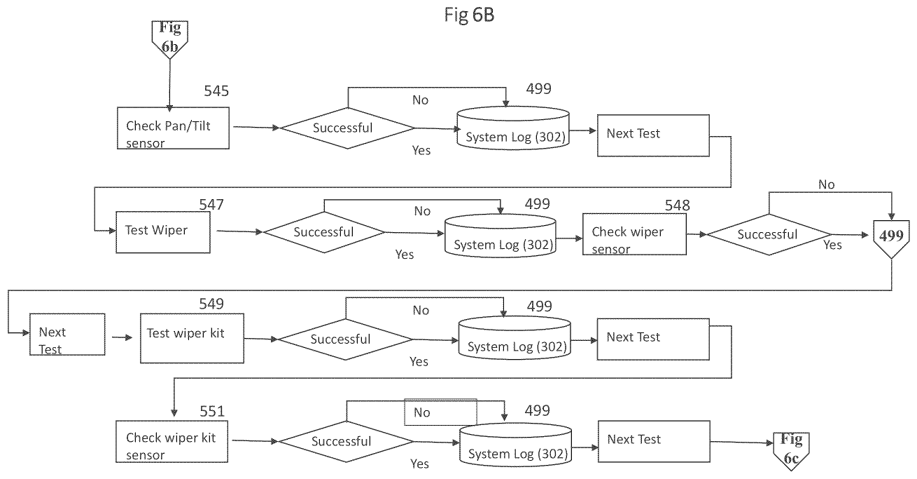

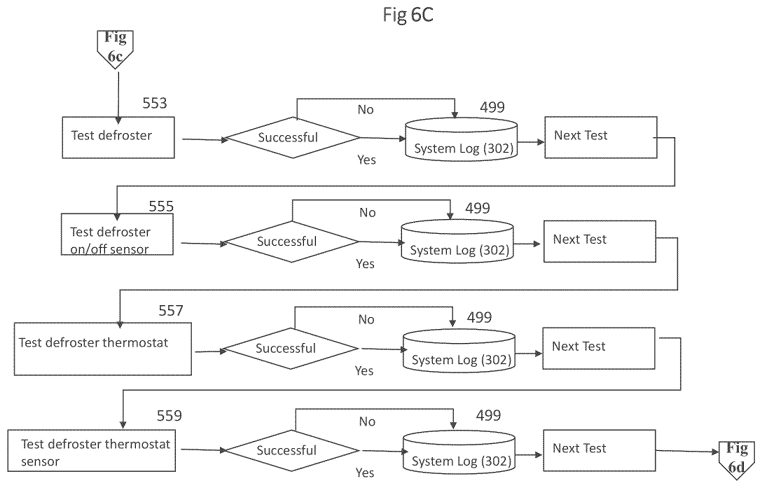

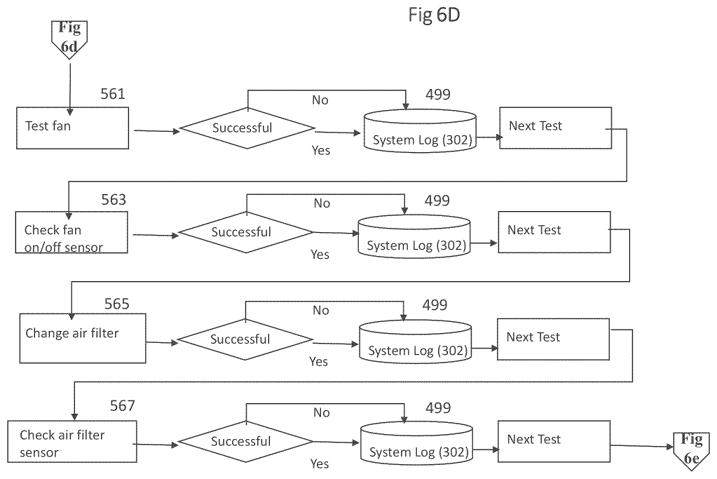

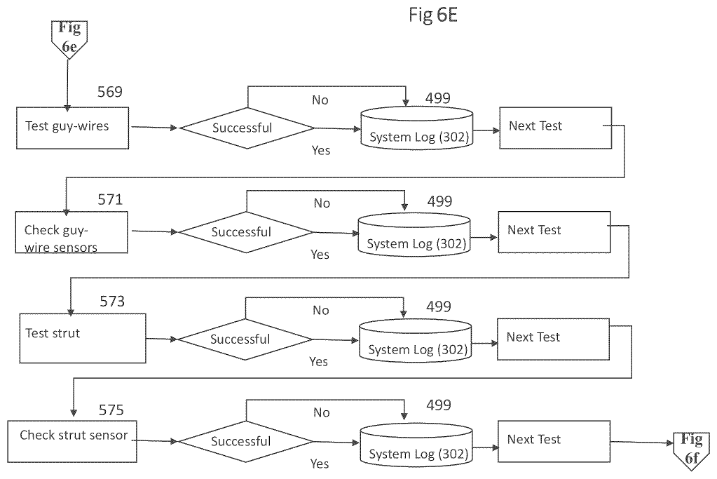

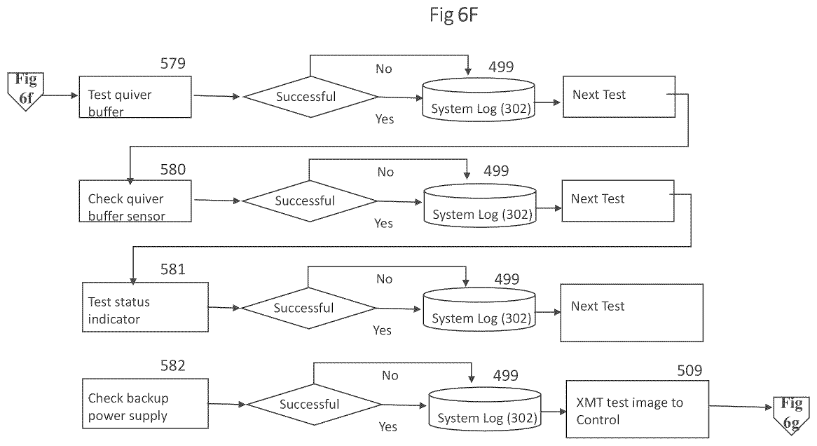

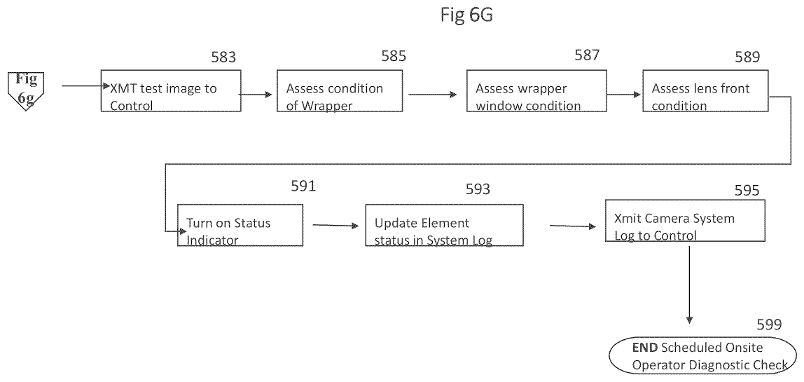

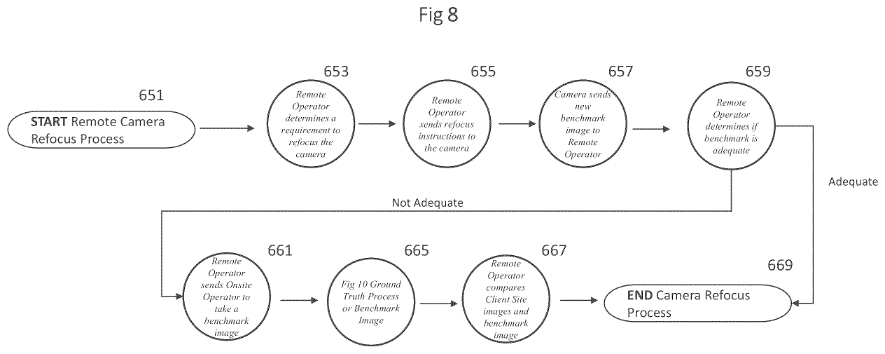

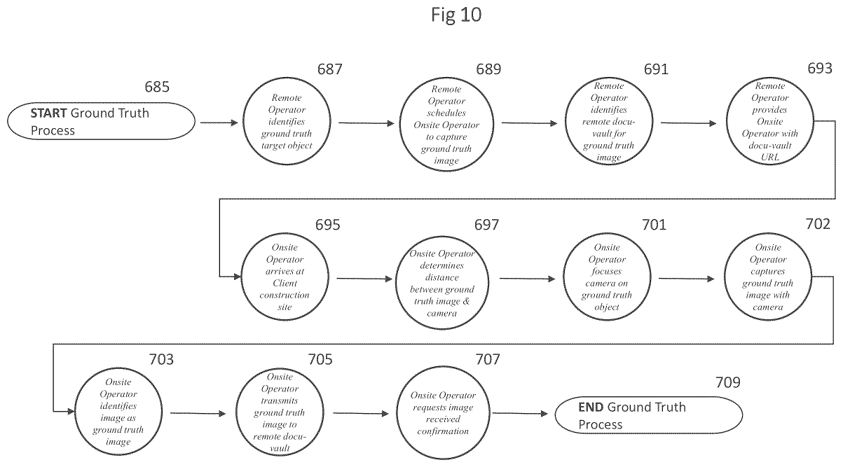

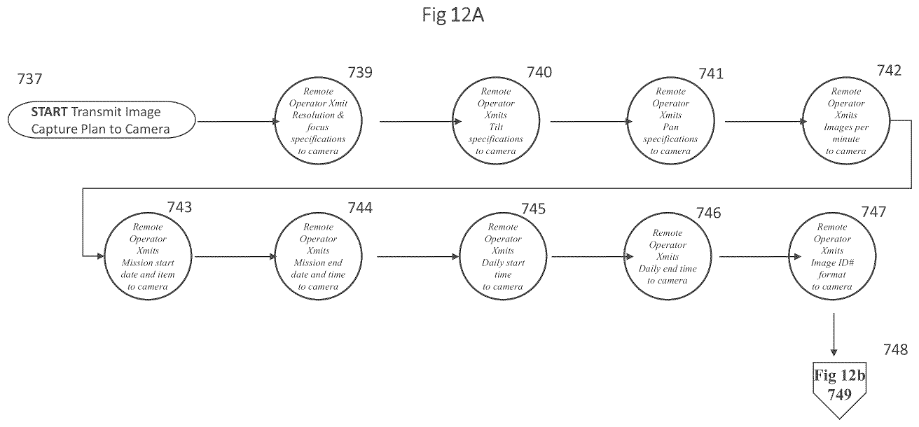

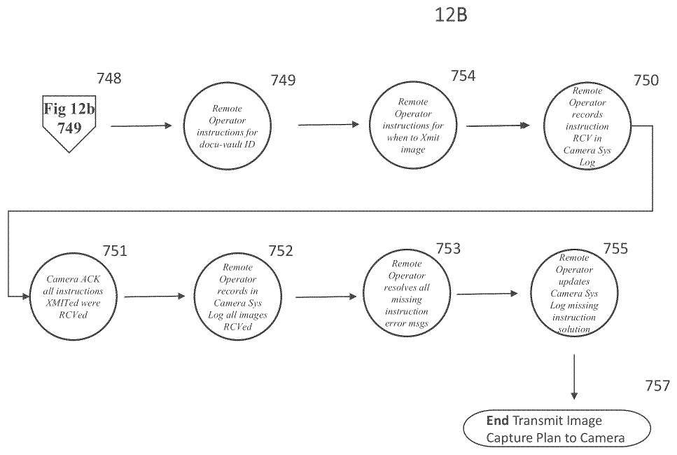

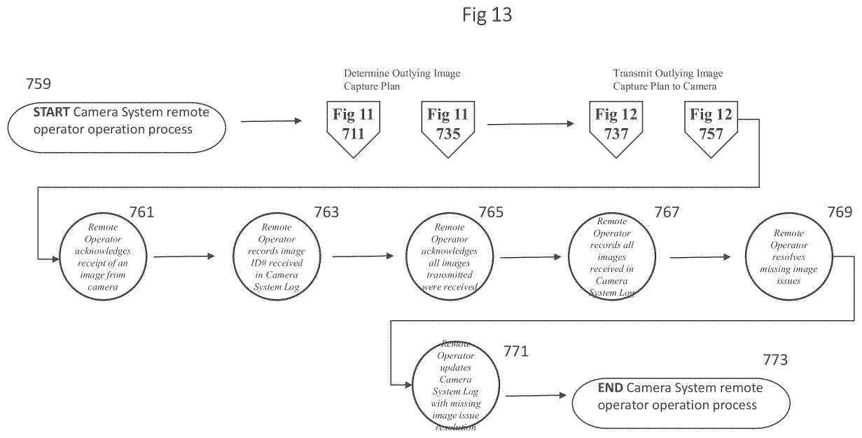

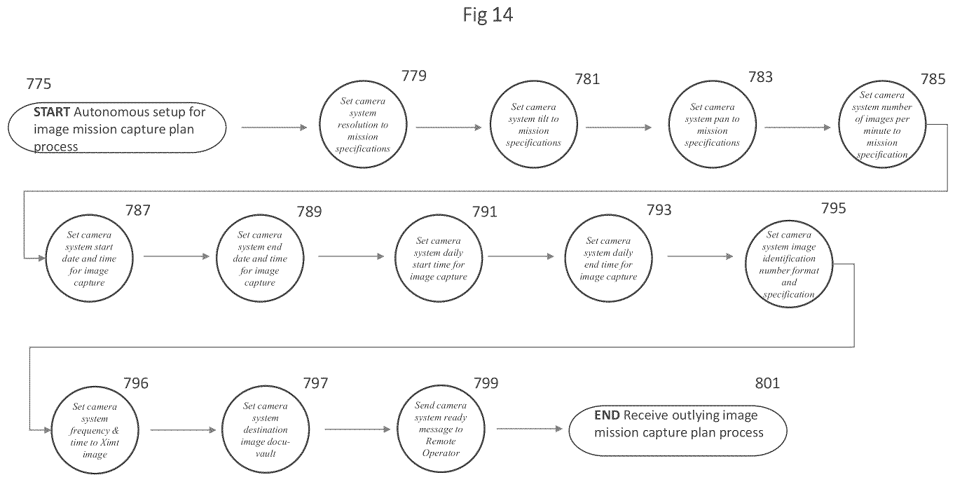

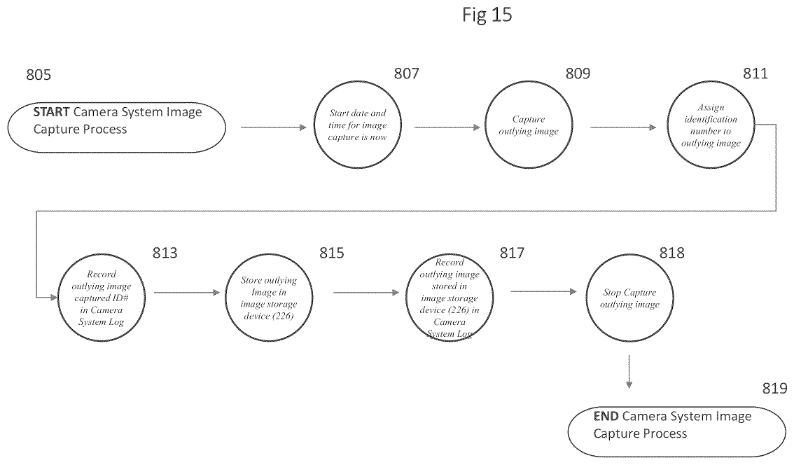

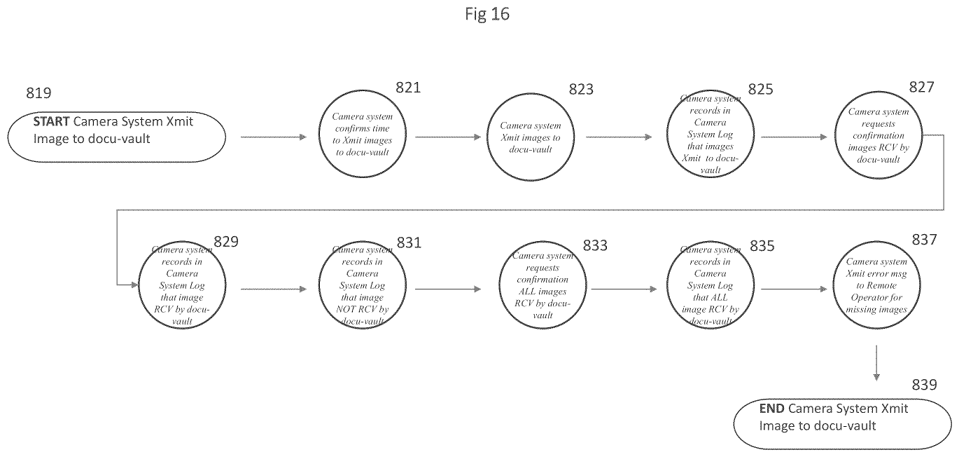

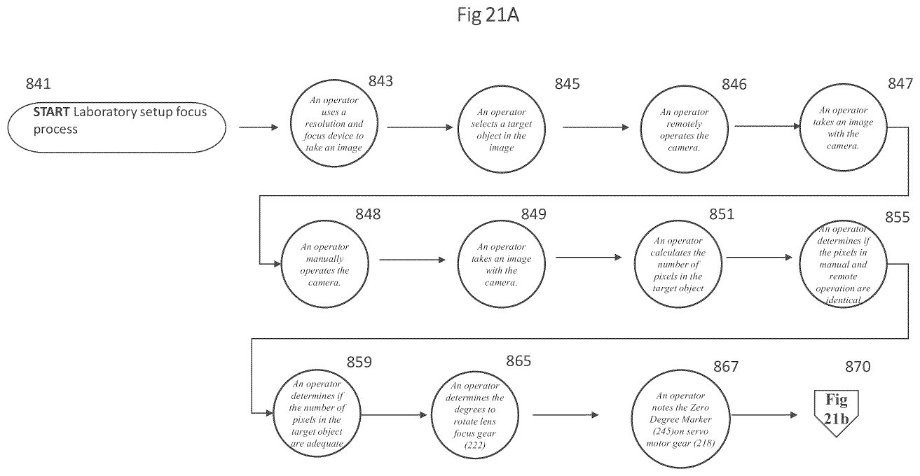

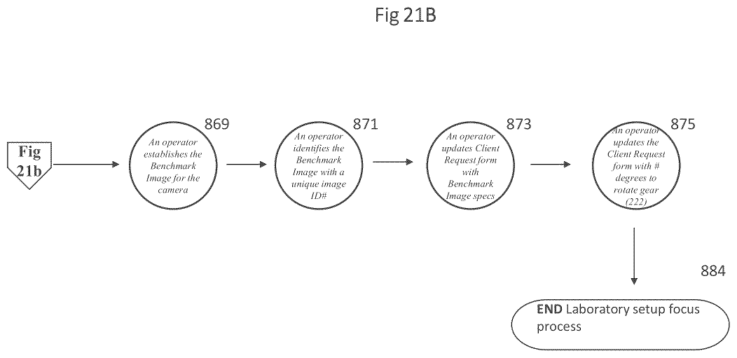

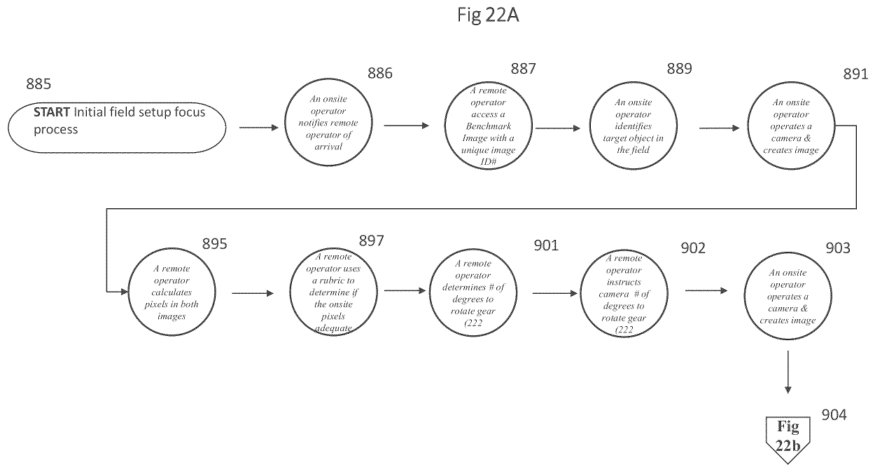

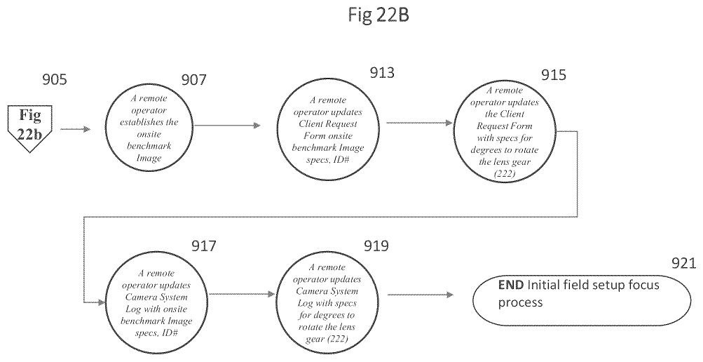

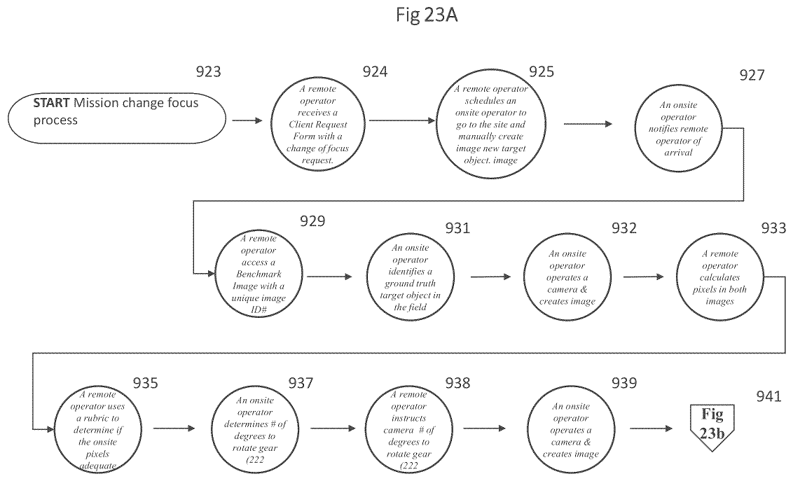

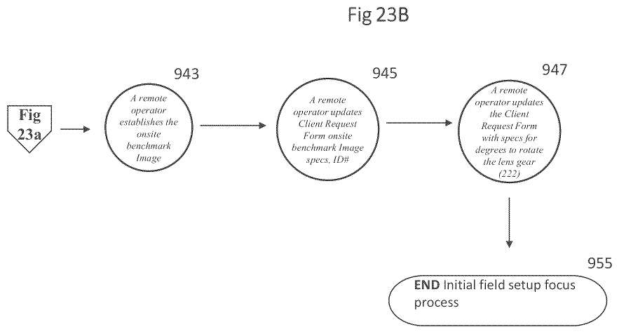

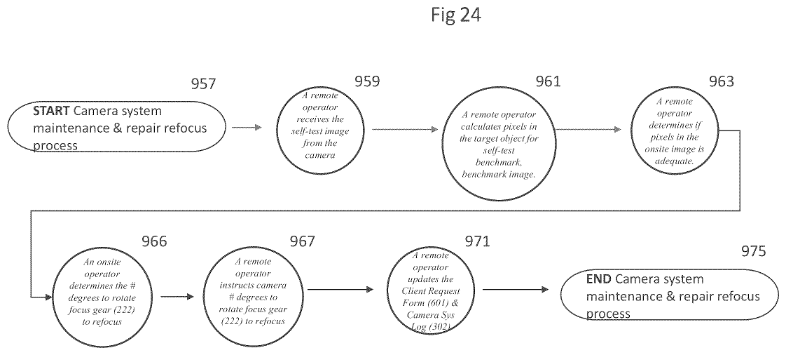

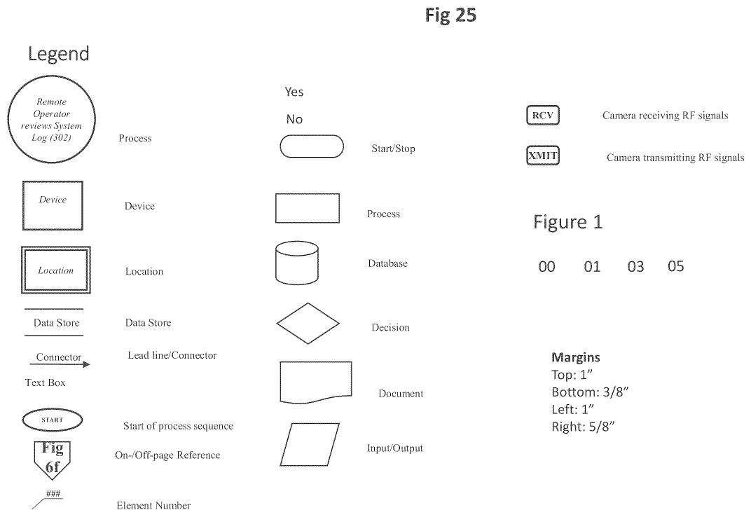

A device server (224) includes an instruction set for processes including but is not limited to including Initial startup EarthCam instruction set (FIG. 3a-3f), Daily Internal self-system check (FIG. 4a-4g), Scheduled Operator Onsite Diagnostic Check (FIG. 6a-6g), Camera Refocus Process (FIG. 8), EarthCam Camera System Operation ground truth process (FIG. 10), Transmit outlying image mission capture plan to camera (FIG. 12a-12b), Camera System receiving outlying image mission capture plan process (FIG. 14), Camera System Image Capture Process (FIG. 15), Camera System transmits images to destination docu-vault (FIG. 16), Laboratory initial setup focus process (FIG. 21a-21b), Initial field setup focus process (FIG. 22a-22b), Camera mission change focus process (FIG. 23a-23b), Maintenance and repair refocus process. (FIG. 24).

A device server (224) is connected to but not limited to being connected to a status indicator control board (212), image storage device (226), camera system clock (286), and relay board (204). A device server is connected to relays on a relay board (204) but not limited to being connected to a servo motor relay, free wiper relay, wiper fluid pump relay, defroster relay, free thermostat controller board relay, fan relay, air filter sensor relay, guy-wire sensor relay, strut connector relay, quiver buffer relay, pan relay, tilt relay, pan/tilt relay, and backup power relay.

A device server (224) is connected to a power source included on a relay board (204). A device server (224) includes but is not limited to including a computer system clock, including but not limited to a including a calendar function, alarm function, calendar notification feature, alarm notification feature, hereinafter called, ‘camera system clock’ (286).

The sixth element of a data module (160) is an image storage device (226). See FIG. 2B. An image storage device (226) is attached to a device server support (223) by four (4), but not limited to four (4) sled mount screws (253). A sled mount screw (253) includes but may not include a vibration absorbing washer.

An image storage device (226) is a non-volatile data storage device including but not limited to a hard disk drive, or flash storage drive.

An image storage device (226) with 32 gigabytes, but not limited to 32 gigabytes of data storage capacity.

An image storage device (226) is connected to a power source included on a relay board (204).

An image storage device (226) is connected to a device server (224).

An image storage device (226) is connected to a camera body (200).

### Camera System Processes and Procedures

Camera System is supported by five (5), but not limited to five (5) major processes. The five (5) processes include but are not limited to including first a Camera System Initial Installation and Relocation Processes, and second a Camera System Mission Operating Software and Processes, and third a Camera System Autonomous Mission Operation Process and Instruction Set, and fourth a Camera System Focus Process and fifth a Camera System Focus Process. Each major process includes sub-processes.

### Process 1: Camera System Initial Installation and Relocation Processes

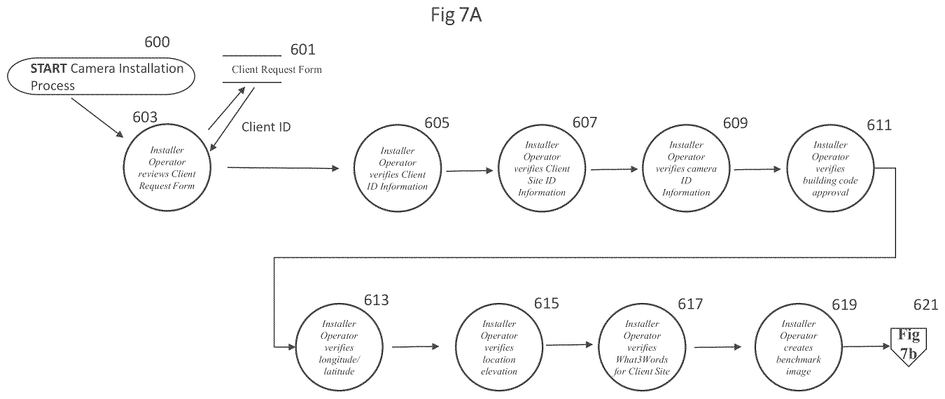

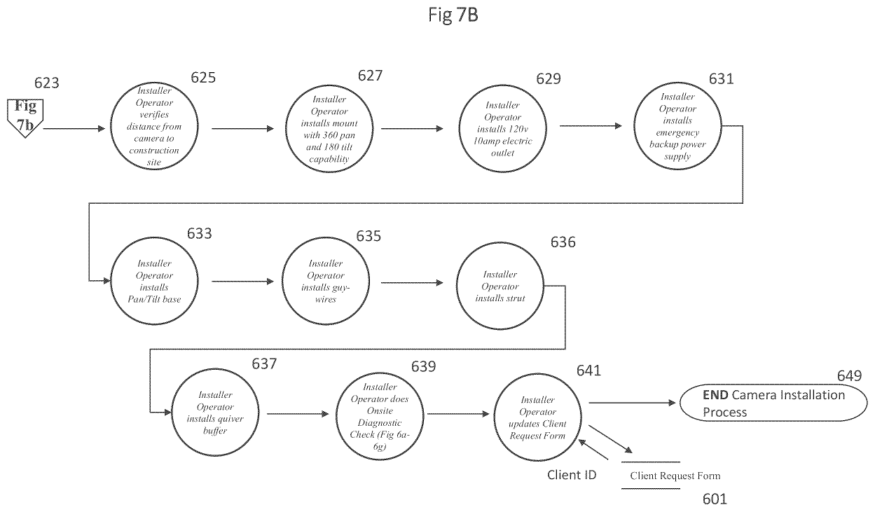

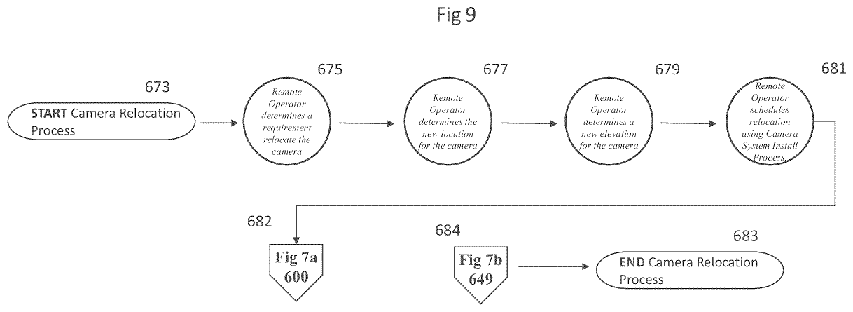

A Camera System Initial Installation and Relocation Process includes, but is not limited to including an EarthCam Camera Installation process (FIG. 7a-7b), a Camera Relocation Process (FIG. 9), EarthCam Camera System Operation ground truth process (FIG. 10), and Camera Remote Refocus Process (FIG. 8).

The first Camera System Initial Installation and Relocation Process: EarthCam Camera Installation process (600) The first Camera System Initial Installation and Relocation Process is an EarthCam Camera Installation process described in (FIGS. 7a-7b) and beginning at Figure number 600.

(603) An installer operator reviews a Client Request Form (601) for a camera system (100).

(607) An installer operator verifies Client identification information associated with a camera system (100) as described in a Client Request Form (601).

(609) An installer operator verifies a camera system (100) identification information as described in a Client Request Form (601).

(611) An installer operator verifies regulatory, site owner compliance and building code approvals for installation of a camera system (100) as described in a Client Request Form (601).

(613) An installer operator verifies latitude and longitude information for a camera system (100) as described in a Client Request Form (601).

(615) An installer operator verifies altitude information for a camera system (100) as described in a Client Request Form (601).

(617) An installer operator verifies What3Words location identification code for a camera system (100) as described in a Client Request Form (601). What3Words is an application which identifies a geographic location with a name which identifies a 3-meter square and a name which identifies a string of 3-meter squares, such as a football stadium or a portion of a mountain.

(619) An installer operator creates an onsite benchmark image of a Client site with a camera system (100), and identifies the image with a benchmark image identification number, and updates an onsite benchmark image identification number in a Client Request Form (601). An image file identification number incorporates a numeric chronological feature, and a multi-level and hierarchical sequence numbering feature.

(625) An installer operator verifies the distance from a client location construction site, but not limited to a client location construction site, to a camera system (100) as described in a Client Request Form (601).

(627) An installer operator installs 360 Degree Camera System Pole Support (257) to provide 360 degree pan capability for a camera system (100).

(629) An installer operator installs, but not limited to installing an AC Power Source (268), 360 Degree Electric Power Cable Connector (266), and Automatic Power Transfer Switch (240), to provide continuous, stable AC power for a camera system (100).

(631) An operator installer installs but not limited to installing a Solar panel for emergency backup power supply (284), Backup Power Supply (239), Backup power supply sensor (251) to provide continuous, stable AC power for a camera system (100).

(633) An operator installer installs but not limited to installing a Pan/Tilt mechanism and base (104) and Pan/Tilt movement sensor (279) to provide 360 degree pan and 180 degree tilt for a camera system (100).

(635) An operator installer installs but not limited to installing guy-wires (280), Guy-wire disconnect sensor (288), Guy-wire Camera System Connector (255), Guy-wire Ground Anchor Connector (256) to provide a stable and motion free installation for a camera system (100).

(636) An operator installer installs but not limited to installing a strut (282) and two (2), but not limited to two (2), strut to pole connectors (258), safety cable (227) and safety cable connector (229) to verify a safe, secure, and motion free installation for a camera system (100).

(637) An operator installer installs but not limited to installing a quiver buffer (296) to provide a tremor and quiver free installation for a camera system (100).

(639) An operator installer performs but not limited to performs an Onsite Diagnostic Check process (FIG. 6a-6g) for a camera system (100).

(641) An operator installer updates the Client Request Form (601) and Camera System Log (302) for a camera system (100).

The second Camera System Initial Installation and Relocation Process: Camera Relocation (673) The second Camera System Initial Installation and Relocation Process is a Camera Relocation Process described in FIG. 9 and beginning at reference number 673.

(675) A remote operator determines a requirement to relocate the camera system (100). A remote operator becomes aware of a request to relocate a camera system (100) from a Client Request Form (601). A remote operator gathers information about the need to relocate a camera system (100). A remote operator establishes a Camera System Relocation Rubric, rules, and algorithm for determining if a camera system must be relocated. An operator updates the Client Request Form (601) with a Camera System Relocation Score. The rubric may be metric, digital, subjective or any combination. The rubric, rules, algorithm provide the operator with a method for grading the outcome of a process to determine the need to relocate a camera system and determining if the camera system relocation score is acceptable. An operator uses a value of 10, but not limited to 10 to indicate a score which is acceptable. An operator uses a value of 1, but not limited to 1 to indicate a score which is not adequate. An operator updates a Client Request Form (601) with a grade for the outcome of a process to determine the need to relocate a camera system.

A remote operator gathers information about alternative locations.

An operator establishes an Alternate Location Rubric, rules, and algorithm for determining the selection of an alternate location.

An operator updates a Client Request Form (601) with an Alternate Location Score.

The rubric may be metric, digital, subjective or any combination. The rubric, rules, algorithm provide the operator with a method for grading the outcome of a process to determine the alternative location and determining if a Alternate Location Score is acceptable.

An operator uses a value of 10, but not limited to 10 to indicate a score which is acceptable. An operator uses a value of 1, but not limited to 1 to indicate a score which is not adequate.

An operator updates a Client Request Form (601) and a with a grade for the outcome of an alternate location for a camera system (100)

(679) A remote operator determines an elevation for a new alternative location for camera system (100).

A remote operator gathers information about an elevation for a new alternative location for camera system (100).

An operator establishes a New Elevation Rubric, rules, and algorithm for determining if an elevation for a new alternative location is acceptable.

An operator updates a Client Request Form (601) with a New Elevation Score. The rubric may be metric, digital, subjective or any combination. The rubric, rules, algorithm provide the operator with a method for grading the outcome of determining an elevation for a new alternative location for a camera system (100) and determining if a New Elevation Score is acceptable. An operator uses a value of 10, but not limited to 10 to indicate a score which is acceptable. An operator uses a value of 1, but not limited to 1 to indicate a score which is not adequate.

An operator updates a Client Request Form (601) with a grade for the outcome of an acceptable elevation for a new alternative location for camera system (100).

(681) A remote operator schedules the installation of a camera system (100) at an alternative location. If a camera system needs a relocation Rubric Score, and a select an alternative relocation site Rubric Score, and a select an elevation for a new alternative location Rubric Score are adequate, a remote operator schedules an installation of a camera system at a new location. To install a camera system (100) at an alternative location, a remote operator uses the processes described in FIG. 7a and in FIG. 7b. An operator updates a Client Request Form (601) with the information detailing an installation of a camera system (100) at an alternative location.

The third Camera System Initial Installation and Relocation Process: Camera System Operation Ground Truth Process:

(685) The third Camera System Initial Installation and Relocation Process is an EarthCam Camera System Operation Ground Truth Process described in FIG. 10 and beginning at Figure number 673.

(687) A remote operator identifies an outlying target object at a Client construction site, but not limited to a Client construction site.

(689) A remote operator schedules an onsite operator to use a camera system (100), at the Client site, to capture an image of an outlying target object.

(691) A remote operator identifies remote docu-vault for storing a ground truth image. A remote operator updates Client Request Form (601) with the docu-vault identification information and the URL.

(693) A remote operator informs the onsite operator of the identification information and the URL to store a ground truth image of a target object.

(695) An onsite operator notifies a remote operator of the date and time arrival at a Camera System (100) located at a Client Site.

(697) An onsite operator determines the distance between ground truth target image and a camera system (100). An onsite operator updates the Client Request Form (601) with the distance between ground truth target image and a camera system (100).

(701) An onsite Operator locates a ground truth object at a Client site. An onsite operator focuses a camera system (100) on a ground truth object using a mobile computer linked to a camera system (100). An onsite operator operates the Pan/Tilt mechanism and base (104) and outlying image camera lens focus gear (222) to locate and focus a ground truth object with camera system (100). An onsite operator records the degrees clockwise or counterclockwise for ground truth object on Camera System Log (302).

(702) An onsite operator uses a mobile computer connected to a communication system (107) and linked to a camera system (100) to capture an image of a ground truth object.

(703) An onsite operator uses a mobile computer connected to a communication system (107) and linked to a camera system (100) to identify the image as a ground truth image with a ground truth image file identification number. An onsite operator uses a mobile computer linked to a camera system (100) to store a ground truth image to Image Storage Device (226). An image file identification number incorporates a numeric chronological feature, and a multi-level and hierarchical sequence numbering feature.

(705) An onsite operator uses a mobile computer connected to a communication system (107) to have camera system (100) transmit a ground truth image to a remote operator and a remote docu-vault. An onsite operator updates the Client Request Form (601) with the image identification number, date, time a ground truth image was created and uploaded to a docu-vault. An image file identification number incorporates a numeric chronological feature, and a multi-level and hierarchical sequence numbering feature.

(707) An onsite operator uses a mobile computer connected to a communication system (107) to transmit a request for a delivery confirmation from a remote operator for receipt of the ground truth image.

The fourth Camera System Initial Installation and Relocation Process: Camera Remote Refocus Process:

(651) The fourth Camera System Initial Installation and Relocation Process is Camera Refocus Process described in FIG. 8 and beginning at Figure number 651.

(653) A remote operator determines a requirement to refocus the camera system (100) remotely from a Control Center.

A remote operator gathers information about an existing benchmark image and current images. A remote operator determines if there is a need to remotely refocus a camera system (100). An operator establishes a Remote Refocus Rubric, rules, and algorithm for determining if a camera system (100) must be remotely refocused.

An operator updates a Client Request Form (601) with a Remote Refocus Rubric Score. The rubric may be metric, digital, subjective or any combination. The rubric, rules, algorithm provide the operator with a method for grading the outcome of a need to remotely refocus a camera system (100) and determining if a Remote Refocus Rubric Score is acceptable.

An operator uses a value of 10, but not limited to 10 to indicate a score which is acceptable. An operator uses a value of 1, but not limited to 1 to indicate a score which is not adequate. An operator updates a Client Request Form (601) with a grade for the outcome of a need to remotely refocus a camera system (100).

(655) A remote operator remote accesses a camera system (100). A remote operator sends refocus instructions to a device server (224) located on a camera system (100). A remote operator sends instructions to a device server (224) located on a camera system (100) for a pan range in degrees or a single pan degree for a Pan/Tilt mechanism and base (104). A remote operator sends instructions to a device server (224) located on a camera system (100) a tilt range in degrees or a single tilt degree for a Pan/Tilt mechanism and base (104). A remote operator sends instructions to a device server (244) to outlying image camera lens focus gear (222) to rotate a number of degrees clockwise or counterclockwise. A device server (244) instructs a pan relay, tilt relay and servo-motor relay, located on relay board (204) to close and provide electric power to a pan/tilt mechanism and base (104) and a servo motor (216). An operator uses an algorithm to determine the amount of time to keep a pan relay closed to move a Pan/Tilt mechanism and base (104) to the required pan degree location. An operator uses an algorithm to determine the amount of time to keep a tilt relay closed to move a Pan/Tilt mechanism and base (104) to the required tilt degree location. An operator uses an algorithm to determine the amount of time to keep a servo motor relay, located on a relay board (204), closed to move the rotating lens sleeve (264) to the required degree location.

(657) A remote operator sends instructions to a device server, (244) located on a camera system (100), to capture a benchmark image using the new focus specifications. (100). A device server (224) instructs a camera body (200) module to capture a benchmark image. A device server (224) instructs a camera body (200) module to store a benchmark image on an image storage device (226). A device server identifies the image as a benchmark image. A device server identifies a benchmark image with a unique identification number. A remote operator instructs a device server (224) how to uniquely identify an image with an image file identification number. A benchmark image file identification number incorporates a numeric chronological feature, and a multi-level and hierarchical sequence numbering feature.

A remote operator identifies remote docu-vault for storing a benchmark image. A remote operator updates Client Request Form (601) with the docu-vault identification information and the URL.

A remote operator instructs the device server (224) with the identification information and the URL to store a benchmark image.

A remote operator instructs a device server (224) to use a communication system (107) to transmit a benchmark image to a docu-vault.

(659) A remote operator reviews the characteristics of a benchmark image and determines if a benchmark image is adequate. If a benchmark image is adequate a remote operator updates a Client Request Form (601) with the benchmark identification information.

A remote operator gathers information about the characteristics of a benchmark image.

An operator establishes a Remote Benchmark Image Rubric, rules, and algorithm for determining if a remote benchmark image is acceptable.

An operator updates a Client Request Form (601) with a Remote Benchmark Image Rubric Score.

The rubric may be metric, digital, subjective or any combination. The rubric, rules, algorithm provide the operator with a method for grading the outcome of a process to determine if a remote benchmark image is acceptable and determining if a Remote Benchmark Image Rubric Score is acceptable.

An operator uses a value of 10, but not limited to 10 to indicate a score which is acceptable. An operator uses a value of 1, but not limited to 1 to indicate a score which is not adequate. An operator updates a Client Request Form (601) with a grade for the outcome of determining if a remote benchmark image is acceptable.

(665) If a benchmark image is not acceptable, a remote operator schedules an onsite operator to travel to a camera system (100) and acquire a new onsite benchmark image. An onsite operator performs the actions in FIG. 10 to capture an onsite benchmark image.

(667) A remote operator compares an onsite benchmark image with Client site images, and previous benchmark images, but not limited to Client site images, and previous benchmark images, and determines if a new onsite benchmark image is acceptable.

A remote operator gathers information about the characteristics of an onsite benchmark image.

An operator establishes an Onsite Benchmark Image Rubric, rules, and algorithm for determining if the characteristics of an onsite benchmark image are acceptable.

An operator updates a Client Request Form (601) with a Onsite Benchmark Image Rubric Score.

The rubric may be metric, digital, subjective or any combination. The rubric, rules, algorithm provide the operator with a method for grading the outcome of a process to determine if the characteristics of an onsite benchmark image are acceptable. and determining if a Onsite Benchmark Image Rubric Score is acceptable.

An operator uses a value of 10, but not limited to 10 to indicate a score which is acceptable. An operator uses a value of 1, but not limited to 1 to indicate a score which is not adequate.

An operator updates a Client Request Form (601) with a grade for the outcome of a process to determine if the characteristics of an onsite benchmark image are acceptable.

### Process 2: Camera System Mission Operating Software and Processes

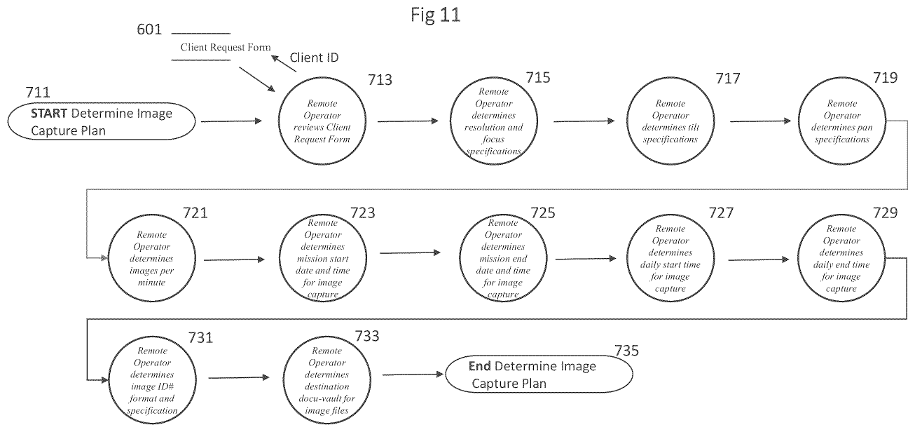

An EarthCam Camera System remote operator mission operation process includes but is not limited to including two processes. The first process is a process to Determine Outlying Image Capture Plan described in FIG. 11. The second process is a process to Transmit outlying image mission capture plan to camera described in FIG. 12a-12b.

An EarthCam Camera System autonomous mission operation instruction set process includes but is not limited to including four processes. The first process is a to Determine Outlying Image Capture Plan for a Camera System described in FIG. 11. The second process is a process for a Camera System receiving outlying image mission capture plan process described in FIG. 14. The third process is a process for a Camera System Image Capture Process described in FIG. 15. The fourth process is a process for Camera System transmitting images to destination docu-vault described in FIG. 16.

### The First Camera System Mission Operating Software and Process: Determine Outlying Image Capture Plan

(711) The first Camera System Mission Operating Software and Process is a process Determine Outlying Image Capture Plan described in FIG. 11 and beginning at figure number 711.

(713) A remote operator reviews a Client Request Form (601), for a camera system (100), for the following but not limited to the following, client identification information, client location information, docu-narrative request date, and docu-narrative length of time.

(715) A remote operator determines Remote Operator determines resolution and focus specification using Resolution and Focus Device for a camera system (100). A remote operator considers but is not limited to considering, the distance of the camera system (100) from the Client site, the significant target objects at the Client site, weather conditions, time of day and the specifications of an initial benchmark image. A remote operator uses an algorithm to determine the amount of time to keep a servo motor relay, located on a relay board (204), closed so a lens focus gear (222) can move a rotating lens sleeve (264) to the required degree location to achieve a focus and resolution.

(717) A remote operator determines pan specifications and uses an algorithm to determine the amount of time to keep a pan relay, located on a relay board (204), closed to move a Pan/Tilt mechanism and base (104) to the required pan degree location and achieve a required pan speed.

(719) A remote operator determines tilt specifications and uses an algorithm to determine the amount of time to keep a tilt relay, located on a relay board (204), closed to move a Pan/Tilt mechanism and base (104) to the required tilt degree location and achieve a required tilt speed.

(721) A remote operator determines the number of images per minute for a camera system (100) to capture. An operator considers but is not limited to considering the pan and tilt speed of a pan/tilt mechanism, the length of time for the docu-narrative defined in the Client Request Form (601), and the capability of a camera body (200).

(723) A remote operator reviews a Client Request Form (601) and determines a mission start date for a camera system (100) to begin to capture images.

(725) A remote operator reviews a Client Request Form (601) and determines a mission end date for a camera system (100) to stop capturing images.

(727) A remote operator reviews a Client Request Form (601) and determines a mission daily start time for a camera system (100) to begin to capture images.

(729) A remote operator reviews a Client Request Form (601) and determines a mission daily end time for a camera system (100) to stop capturing images.

(731) A remote operator determines an image file number format and specification for an image captured by a camera system (100). An image file identification number incorporates a numeric chronological feature, and a multi-level and hierarchical sequence numbering feature.

(733) A remote operator determines a destination remote docu-vault for image files stored on an Image Storage Device (226). A remote operator determines the identification information and URL for a remote docu-vault. A remote operator determines a remote docu-vault based on, but not limited to, image file size, number of images to be stored in the docu-narrative, the size of the number of images to be stored, the storage capacity of a docu-vault, and the data transfer speed of a docu-vault. A remote operator identifies three but not limited to three remote docu-vaults for storing an image taken by a camera system (100).

The second Camera System Mission Operating Software and Process: Transmit Outlying Image Mission Capture Plan to A Camera System

(737) The second Camera System Mission Operating Software and Process is a process to Transmit outlying image mission capture plan to a camera system described in FIGS. 12a and 12b beginning with Figure number 737.

(739) A remote operator transmits resolution and focus specifications and instructions to a camera system (100). A remote operator resolution and focus specification instruction is received by device server (224). A remote operator resolution and focus specification instruction is saved by device server (224) on an image storage device (240). A remote operator instruction includes but is not limited to an amount of time to keep a servo motor relay, located on a relay board (204), closed so a lens focus gear (222) can move a rotating lens sleeve (264) to the required degree location and expand or contract a lens rear (262) and move a camera body (200) forward or away from a stationary lens front (250) and forward or away from a stationary wrapper window (110) to achieve a required focus and resolution.

(740) A remote operator transmits tilt specifications and instructions to a camera system (100). A remote operator tilt specification instruction is received by device server (224). A remote operator tilt specification instruction is saved by device server (224) on an image storage device (240). A remote operator tilt instruction includes but is not limited to an amount of time to keep a tilt relay, located on a relay board (204), closed so a Pan/Tilt mechanism and base (104) can move a camera wrapper (102) including a camera module so a wrapper window (110) and camera lens front (250) are located in the required horizontal degree location.

(741) A remote operator transmits pan specifications and instructions to a camera system (100). A remote operator pan specification instruction is received by device server (224). A remote operator pan specification instruction is saved by device server (224) on an image storage device (240). A remote operator pan instruction includes but is not limited to an amount of time to keep a pan relay, located on a relay board (204), closed so a Pan/Tilt mechanism and base (104) can move a camera wrapper (102) including a camera module so a wrapper window (110) and camera lens front (250) are located in the required vertical degree range location.

(742) A remote operator transmits the number of images per minute for a camera system (100) to capture. A remote operator transmits the number of images per minute a camera body (200) is to capture at a horizontal and vertical coordinate. A remote operator number of images per minute specification instruction is received by device server (224). A remote operator number of images per minute specification instruction is saved by device server (224) on an image storage device (240).

(743) A remote operator transmits a mission start date for a camera system (100) to begin to capture images. A remote operator mission start date specification instruction is received by device server (224). A remote operator mission start date specification instruction is saved by device server (224) on an image storage device (240).

(744) A remote operator transmits a mission end date for a camera system (100) to end capturing images. A remote operator mission end date specification instruction is received by device server (224) on an image storage device (240). A remote operator mission end date specification instruction is saved by device server (224) on an image storage device (240).

(745) A remote operator transmits a daily mission start time for a camera system (100) to begin to capture images. A remote operator daily mission start time specification instruction is received by device server (224). A remote operator daily mission start time specification instruction is saved by device server (224) on an image storage device (240).

A remote operator transmits a daily mission start time for a camera system (100) to begin to self-test diagnostic tests. A remote operator daily self-test diagnostic test start time specification instruction is received by device server (224). A remote operator daily self-test diagnostic test start time specification instruction is saved by device server (224) on an image storage device (240).

(746) A remote operator transmits a daily mission end time for a camera system (100) to end to capturing images. A remote operator daily mission end time specification instruction is received by device server (224). A remote operator daily mission end time specification instruction is saved by device server (224) on an image storage device (240).

(747) A remote operator transmits an image file number format and specification for an image captured by a camera system (100). An image file identification number incorporates a numeric chronological feature, and a multi-level and hierarchical sequence numbering feature. A remote operator image identification number specification instruction is received by device server (224). A remote operator image identification number specification instruction is saved by device server (224) on an image storage device (240).

(749) A remote operator transmits a data-vault identification number and URL to a device server (224).

A remote operator transmits the identification information and URL for a remote docu-vault for images stored on an image storage device (226). A remote operator docu-vault identification and URL specification instruction is saved by device server (224) on an image storage device (240).

(754) A remote operator transmits to a device server (224) a frequency and a time for transmitting images to a docu-vault. A device server saves a frequency and a time for transmitting images to a docu-vault on an image storage device (240).

(750) A remote operator updates a Camera System Log (302) which instruction was received by a device server (224).

(751) A Camera system device server (224) using a communication system (107) transmits an acknowledgement to a Remote Operator that a device server (224) has received all instruction messages and the device server (224) has saved all the instructions.

(752) A remote operator updates a Camera System Log (302) that all instructions were received by a device server (224).

(753) A remote operator resolves a missing instruction message sent to a device server (224).

(755) A remote operator updates a Camera System Log (302) with a resolution for a missing instruction message.

### Process 3: Camera System Autonomous Mission Operation Process and Instruction Set

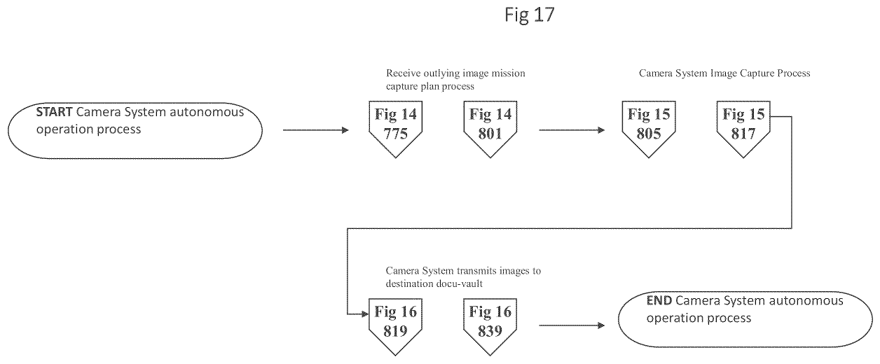

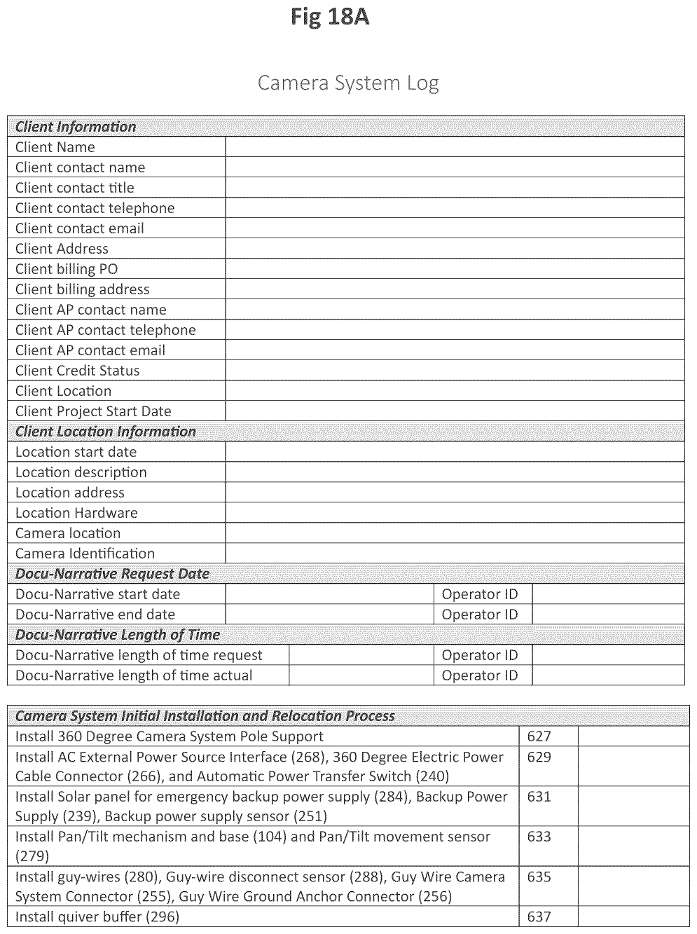

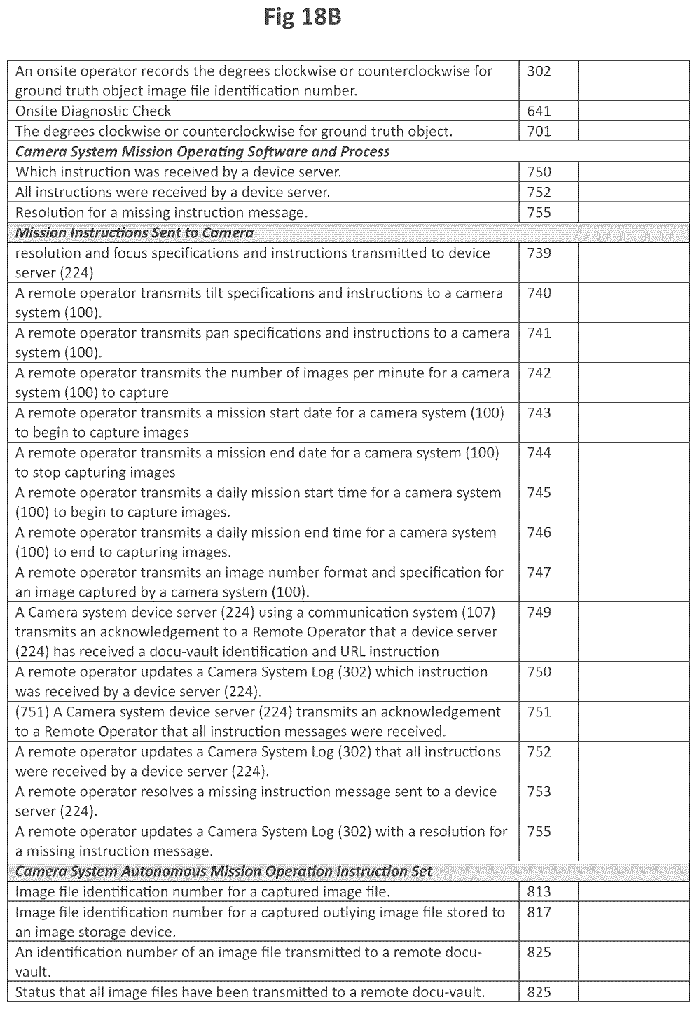

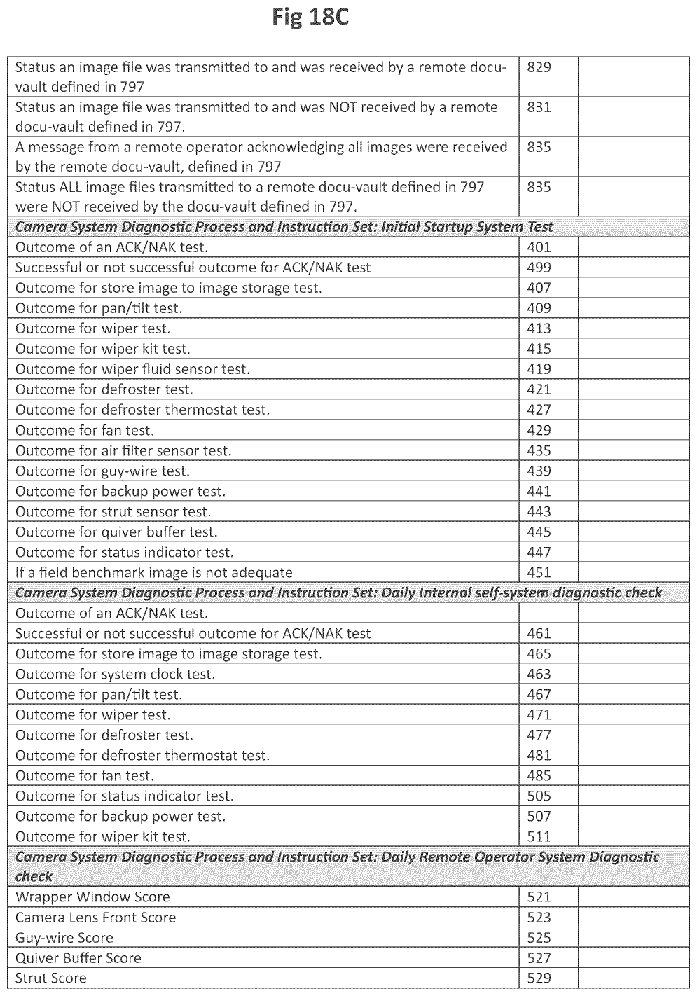

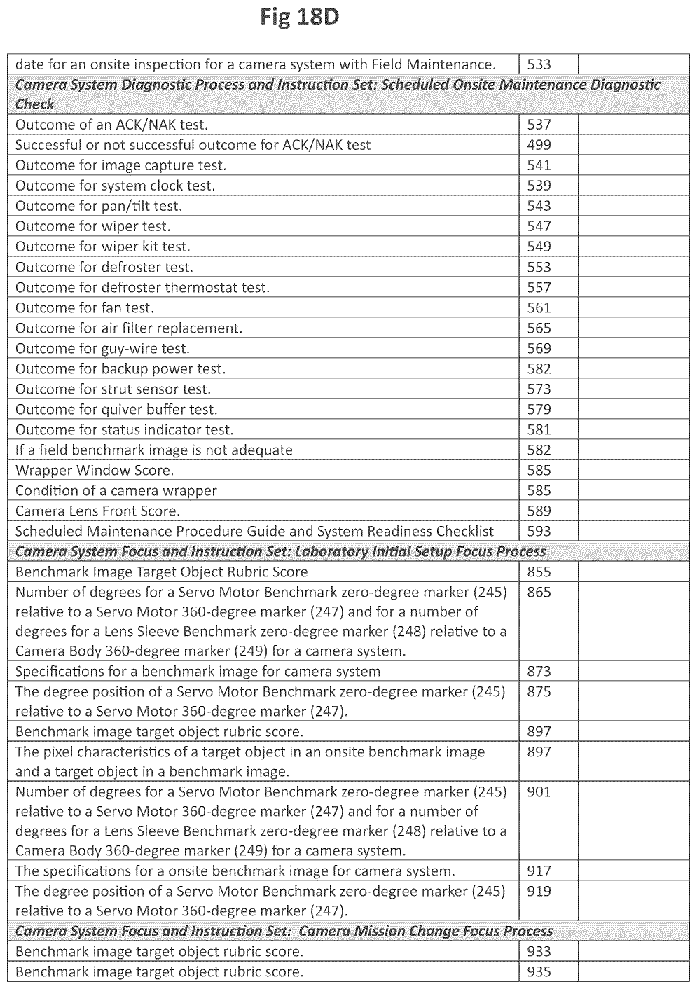

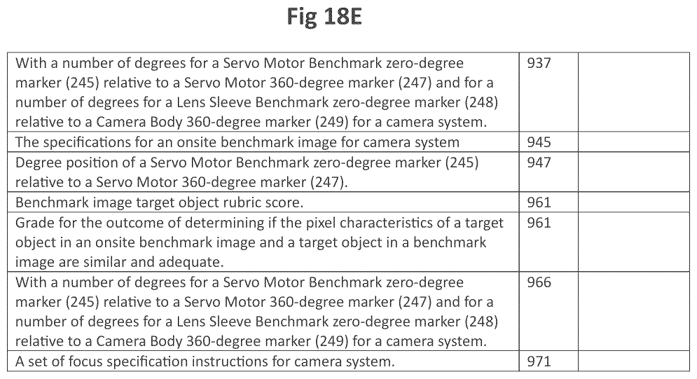

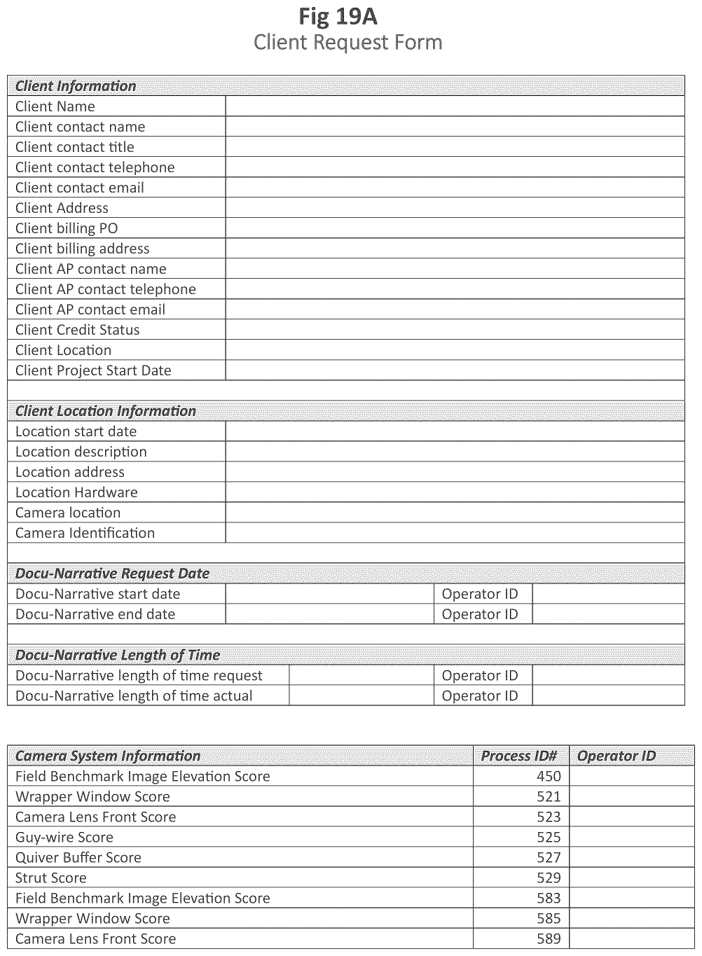

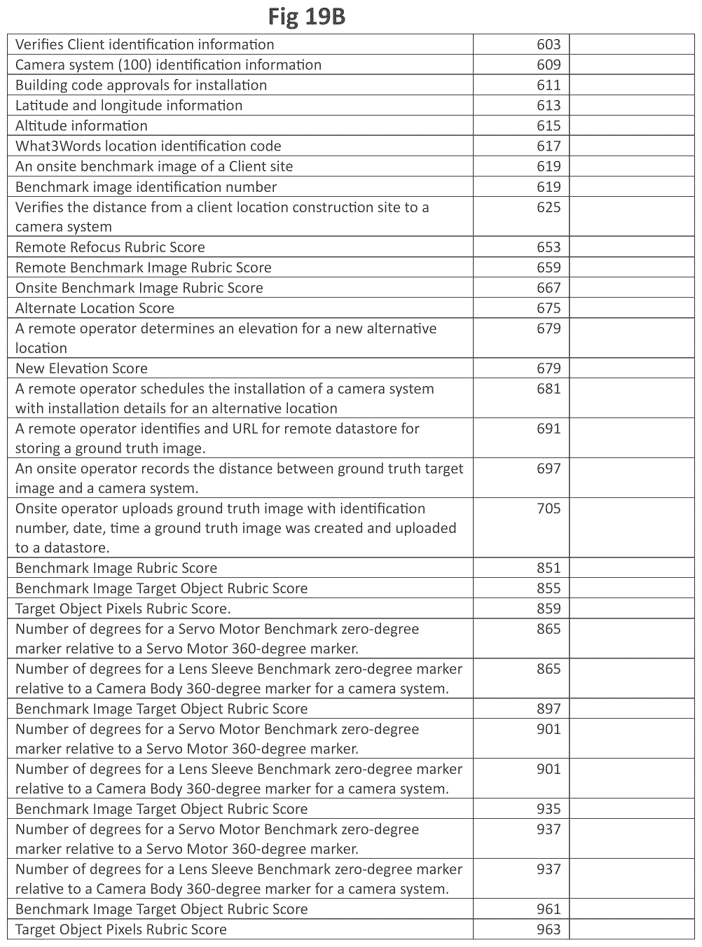

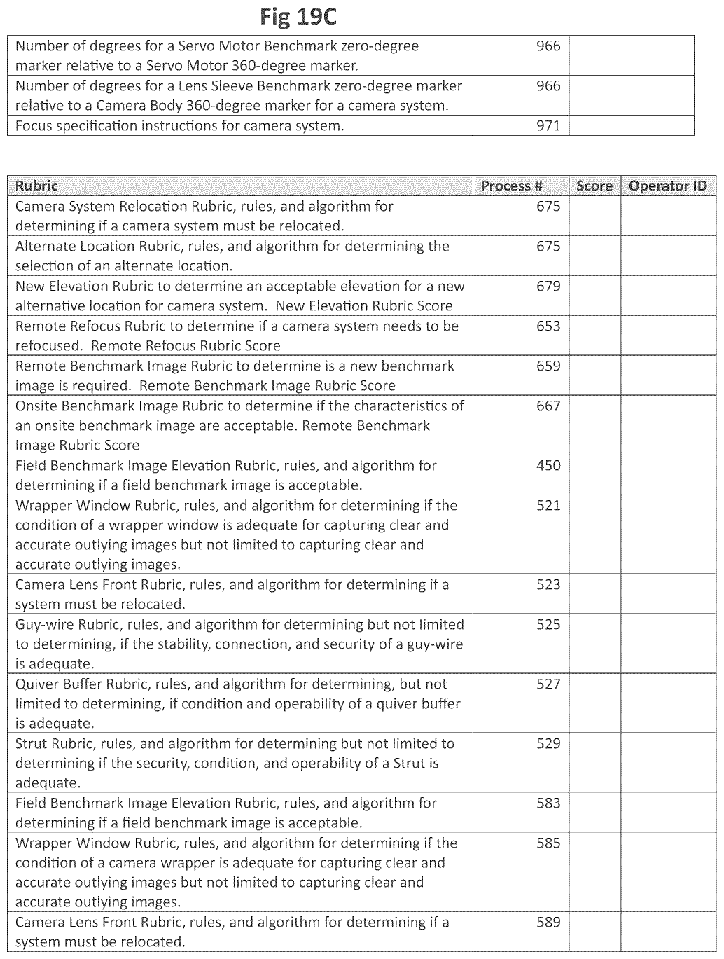

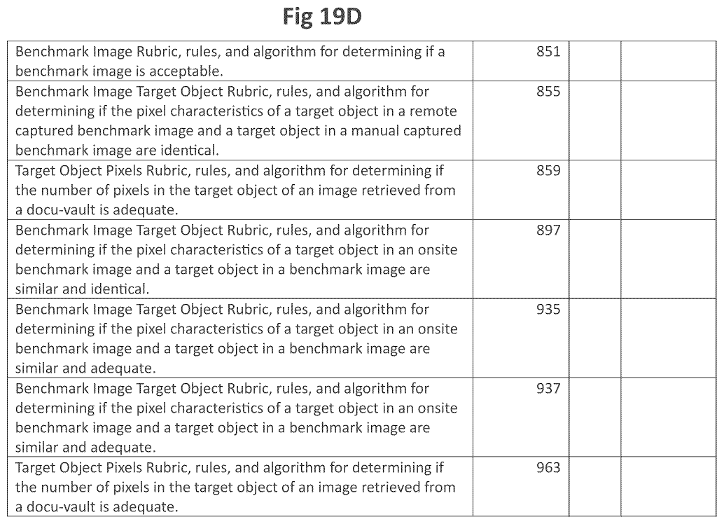

An EarthCam Camera System autonomous mission operation process instruction set, described in FIG. 17, includes but is not limited to including three processes. The first process is a Camera System autonomous setup for outlying image mission capture plan process as described in FIG. 14. The second process is a Camera System Image Capture Process as described in FIG. 15. The third process is a Camera System transmits images to destination docu-vault process as described in FIG. 16.

### The First Camera System Autonomous Mission Operation Instruction Set: Camera System Autonomous Setup for Outlying Image Mission Capture Plan Process

(775) The first process of a EarthCam Camera System autonomous mission operation instruction set is a Camera System Autonomous Setup For Outlying Image Mission Capture Plan process described in FIG. 14 and beginning at figure number 775.

(779) A device server (224) retrieves mission focus and resolution specifications from an image storage device (226). As determined by the focus and resolution specifications, a device server (224) sets the amount of time to keep a servo motor relay, located on a relay board (204), closed so a lens focus gear (222) can move a rotating lens sleeve (264) to the required degree location and expand or contract a lens rear (262) and move a camera body (200) forward or away from a stationary lens front (250) and forward or away from a stationary wrapper window (110) to achieve a required focus and resolution. A device server (224) pauses the instruction set until a camera system clock (286) equals a mission start date and mission start time. A device server (224) pauses the instruction after a camera system clock (286) equals a mission end date and mission start time.

(781) A device server (224) retrieves a tilt specification from an image storage device (226). A device server (224) sets an amount of time to keep a tilt relay, located on a relay board (204), closed so a Pan/Tilt mechanism and base (104) can move a camera wrapper (102) including a camera module so a wrapper window (110) and camera lens front (250) are located in the required horizontal degree location. A device server (224) pauses the instruction set until a camera system clock (286) equals a mission start date and mission start time. A device server (224) pauses the instruction after a camera system clock (286) equals a mission end date and mission start time.

(783) A device server (224) retrieves a pan specification from an image storage device (226). A device server (224) sets amount of time to keep a pan relay, located on a relay board (204), closed so a Pan/Tilt mechanism and base (104) can move a camera wrapper (102) including a camera module so a wrapper window (110) and camera lens front (250) are located in the required vertical degree range location. A device server (224) pauses the instruction set until a camera system clock (286) equals a mission start date and mission start time. A device server (224) pauses the instruction after a camera system clock (286) equals a mission end date and mission start time.

(785) A device server (224) retrieves images per minute specification from an image storage device (226). A device server (224) sets an images per minute rate to the specification received from the remote operator. A device server (224) instructs a camera body (200) the number of images to capture each minute, but not limited to each minute based on the image rate specification. Device server (224) instructs a camera body (200) the number of images per minute a camera body (200) is to capture at a horizontal and vertical coordinate.

A device server (224) pauses the instruction set until a camera system clock (286) equals a mission start date and mission start time. A device server (224) pauses the instruction after a camera system clock (286) equals a mission end date and mission start time.

(787) A device server (224) retrieves mission start date specification from an image storage device (226). A device server (224) sets a mission start date based on a specification instruction saved by device server (224).

(789) A device server (224) retrieves mission end date specification from an image storage device (226). A device server (224) sets a mission end date based on a specification instruction saved by a device server (224).

(791) A device server (224) retrieves a daily mission start time specification from an image storage device (226)

(793) A device server (224) retrieves daily mission end time specification instruction from an image storage device (226).

(795) A device server (224) retrieves an image file number format and specification for an image captured by a camera system (100) from an image storage device (226). A device server (224) sets an image file number format to comply with an image file number format and specification determined by a remote operator instruction.

(796) A device server (224) retrieves a frequency and a time for transmitting images to a docu-vault from an image storage device (226). A device server (224) sets a frequency and a time for transmitting images to a docu-vault based on the instruction saved by a device server (224)

(797) A device server (224) retrieves the identification information and URL for a remote docu-vault for images from an image storage device (226). A device server (224) sets identification information and URL for a remote docu-vault for images to comply with an identification information and URL for a remote docu-vault specification determined by a remote operator instruction.

(799) A Camera system device server (224) using a communication system (107) transmits a message to a Remote Operator that a device server (224) has set a camera system (100) to a mission operation instruction set, as defined in FIG. 14, but not limited to FIG. 14.

### The Second Camera System Autonomous Mission Operation Instruction Set: Camera System Image Capture Process

(805) The second process of an EarthCam Camera System autonomous mission operation instruction set (FIG. 17) is a Camera System Image Capture Process described in FIG. 15 and beginning at figure number 805.

(807) A device server (224) operates autonomously. A device server (224) operates autonomously until instructed to stop operating autonomously by, but not limited to being instructed by, a remote operator or an onsite operator.

A device server (224) continually compares a mission operation start date and time with a camera system clock (224) date and time. A device server (224) compares a mission operation start date and time with a camera system clock (286) and determines a start date and time is now.

(809) A device server (224) initiates a resolution and focus instruction set (779). A device server (224) initiates a tilt instruction set (781). A device server (224) initiates pan instruction set (783). A device server (224) initiates an image per minute instruction set (785).

A device server (224) instructs camera body (200) to acquire an image. Device server (224) instructs a camera body (200) the number of images per minute a camera body (200) is to capture at a horizontal and vertical coordinate (785).

A camera body (200) captures an outlying image.

(811) A device server (224) instructs a camera body (200) to assign an identification number to an image file. A device server (200) uses an image file identification number format defined in an instruction set (795).

(813) A device server (224) updates a Camera System Log (302) with a image file identification number for a captured image file.

(815) A device server (224) stores an outlying image file, with an image file identification number, in an image storage device (226).

(817) A device server (224) updates a Camera System Log (302) with an image file identification number for a captured outlying image file stored to an image storage device (226).

(818) A device server (224) continually compares a mission operation end date and time with a camera system clock (224) date and time. A device server (224) compares a mission operation end date and time with a camera system clock (286) and determines an end date and time is now. A device server (224) instructs a camera body (200) to stop capturing an outlying image.

### The Third Camera System Autonomous Mission Operation Instruction Set: Camera System Transmits Images to Destination Docu-Vault

(819) The third process of an EarthCam Camera System autonomous mission operation instruction set (FIG. 16) is a Camera System Transmits Images to Destination Docu-Vault described in FIG. 16 and beginning at figure number 819.

(821) A device server (224) continually compares a frequency and a time for transmitting images to a docu-vault with a camera system clock (224) date and time. A device server (224) compares a frequency and a time for transmitting images to a docu-vault with a camera system clock (286) and determines a frequency and a time for transmitting images to a docu-vault is now. A device server (224) instructs a camera body (200) to begin a process to transmit an image to a docu-vault.

(823) A Camera system device server (224) using a communication system (107) transmits an image to a remote docu-vault defined in 797.

(825) A device server (224) updates a Camera System Log (302) with an identification number of an image file transmitted to a remote docu-vault. A device server (224) updates a Camera System Log (302) with a date and time an image file transmitted to a remote docu-vault.

(825) A device server (224) updates a Camera System Log (302) with status that all image files have been transmitted to a remote docu-vault. A device server (224) updates a Camera System Log (302) with a date and time when all image files were transmitted to a remote docu-vault.

(827) A device server (224) using a communication system (107) transmits a request to a Remote Operator to acknowledge an image file was received by a remote docu-vault defined in 797. A message from a device server includes but is not limited to including an image file identification number of an image file transmitted to a remote docu-vault, the docu-vault identification number, and the time and date an image file was transmitted to a remote docu-vault.

(829) A device server (224) updates a Camera System Log (302) with status an image file was transmitted to and was received by a remote docu-vault defined in 797.

(831) A device server (224) updates a Camera System Log (302) with status an image file was transmitted to and was NOT received by a remote docu-vault defined in 797.

(833) A device server (224) using a communication system (107) transmits a request to a Remote Operator to acknowledge all image files were received by a remote docu-vault defined in 797. A message from a device server includes but is not limited to including an image file identification number of all the image files transmitted to a remote docu-vault, the docu-vault identification number to which the image files were transmitted, and the time and date each image file was transmitted to a remote docu-vault.

(835) If a device server receives a message from a remote operator acknowledging all images were received by the remote docu-vault, defined in 797, then a device server (224) updates a Camera System Log (302) with a status ALL image files transmitted to a remote docu-vault defined in 797 were received by the docu-vault defined in 797.

If a device server receives a message from a remote operator NOT acknowledging all images were received by the remote docu-vault, defined in 797, then a device server (224) updates a Camera System Log (302) with a status ALL image files transmitted to a remote docu-vault defined in 797 were NOT received by the docu-vault defined in 797.

(837) A device server (224) using a communication system (107) retransmits a missing image file to a remote data-vault defined in 797. A device server (224) using a communication system (107) transmits a message to remote operator the missing image file was retransmitted to a remote data-vault defined in 797. A message from a device server includes but is not limited to including an image file identification number of an image file retransmitted to a remote docu-vault, the docu-vault identification number for the image file retransmitted, and the time and date of image file retransmitted to a remote docu-vault.

### Process 4: Camera System Diagnostic Process and Instruction Set

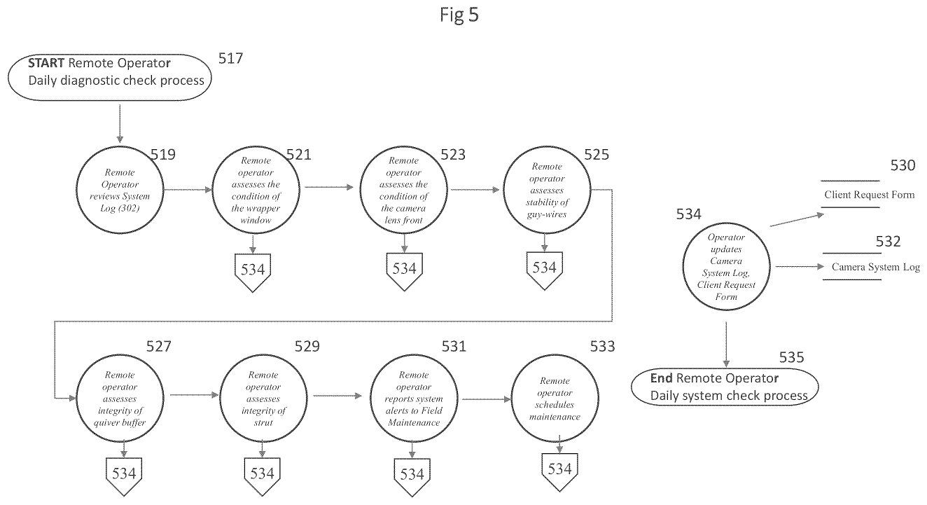

An EarthCam Camera System diagnostic process instruction set, includes but is not limited to including four processes. The first process is an Initial Startup System Test as described in FIG. 3a-3f. The second process is a Daily Internal System Self-Test as described in FIGS. 4a-4d. The third process is a Remote Operator Daily Diagnostic Check process as described in FIG. 5. The fourth process is a Scheduled Onsite Operator Diagnostic Check as described in FIG. 6a-6g.

The first Camera System Diagnostic Process and Instruction Set: Initial Startup System Test

(400) The first process of a Camera System Diagnostic Process and Instruction Set (FIG. 16) is an Initial Startup System Test described in FIG. 3a-3f and beginning at figure number 400. An initial startup system test is performed by an onsite operator once an installation of a camera system (100) has been completed.

(401) An onsite operator instructs a device server (224) to perform an ACK/NAK Test. A device server (224) using a communication system (107) transmits a request to a Remote Operator to reply to a test message.

An onsite operator updates a Camera System Log (302) with the outcome of a ACK/NAK test. A device server (224) using a communication system (107) transmits a ‘test’ message to a Remote Operator requesting a reply. A ‘test’ message from a device server includes but is not limited to including a phrase ‘ACK/NAK Test message’, a camera system identification number, and a date and time when the message was transmitted to a remote operator.

(499) If the test was successful, an onsite operator updates a Camera System Log with a successful outcome for the test. If the Test was not successful within 15 minutes but not limited to 15 minutes, the test was NOT successful. An onsite operator updates a Camera System Log with an unsuccessful outcome for the Test.

(405) An onsite operator instructs a device server (224) to perform an initial image capture test. A device server (224) connected to a Camera Body (200), instructs a Camera Body to capture an outlying image. A camera body captures an outlying image. (499) If the test was successful, an onsite operator updates a Camera System Log (302) with a successful outcome for the test. If the Test was not successful within 15 minutes but not limited to 15 minutes, the test was NOT successful. An onsite operator updates a Camera System Log with an unsuccessful outcome for the Test.

(407) An onsite operator instructs a device server (224) to perform a Store Image to Image Storage Test. A device server (224) instructs a camera body (200), which is connected to an Image Storage Device (226), to store an image, captured in FIG. 405, on an Image Storage Device (226). A Camera Body (200) stores said image on an image storage device (226). (499) If the test was successful, and said image was stored on an image storage device, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(409) An onsite operator instructs a device server (224) to perform a pan/tilt test. An onsite operator observes the pan/tilt (104). An onsite operator instructs a device server a number of degrees for a pan/tilt mechanism and base (104) to pan horizontally and a number of degrees to tilt vertically for a test. An onsite operator instructs a device server a number of degrees for a pan/tilt (104) to pan horizontally and a number of degrees to tilt vertically to return to a pan/tilt position before the test.

A device server (224) instructs a pan relay and tilt relay located on relay board (204) to close and provide electric power to a pan/tilt mechanism and base (104). An operator uses an algorithm to determine the amount of time to keep a pan relay closed to move a Pan/Tilt (104) to the required pan degree location for the test and to return to a pan position before a test. An operator uses an algorithm to determine the amount of time to keep a tilt relay closed to move a Pan/Tilt (104) to the required tilt degree location for a test and to return to a tilt position before a test. (499) If the test was successful, and a pan/tilt (104) moved to the test position and return to the position before the test, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(411) An onsite operator instructs a device server (224) to perform a pan/tilt sensor test during a pan/tilt test (409). An onsite operator instructs a device server (224) to confirm a pan/tilt sensor (278) is operating. An onsite operator sends instructions to a device server (224) to confirm when a pan/tilt (104) was panning, a pan relay on a relay board (204) was closed. An onsite operator sends instructions to a device server (224) to confirm when a pan/tilt (104) was tilting, a relay on a relay board (204) was closed. (499) If the test was successful, and a pan relay on a relay board (204) was closed when a pan/tilt (104) was panning and a tilt relay on a relay board (204) was closed onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(413) An onsite operator instructs a device server (224) to perform a wiper (106a) test. An onsite operator instructs a device server (224) to close a wiper relay on a relay board (204) providing power to a motor included in wiper (106a). An onsite operator observes a wiper (106a). An onsite operator instructs a device server (224) to confirm a wiper motor and wiper (106a) are operating and moving.

(499) If the test was successful, and a wiper (106a) and wiper motor were working, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(415) An onsite operator instructs a device server (224) to perform a wiper sensor test during a wiper (106a) test (413). An onsite operator instructs a device server (224) to confirm a wiper (106a) is operating. An onsite operator sends instructions to a device server (224) to confirm when a wiper (106a) was operating, a wiper sensor relay on a relay board (204) was closed. (499) If the test was successful, and a wiper sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(417) An onsite operator instructs a device server (224) to perform a wiper kit test. An onsite operator instructs a device server (224) to close a wiper fluid pump relay on a relay board (204) providing power to a wiper fluid pump (231). An onsite operator observes a wiper (106a) spraying fluid. An onsite operator instructs a device server (224) to confirm a wiper fluid pump (231) is operating. (499) If the test was successful, and a wiper fluid pump is working, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(419) An onsite operator instructs a device server (224) to perform a wiper fluid level sensor test during a wiper kit test (417). An onsite operator instructs a device server (224) to confirm a wiper (106a) is spraying fluid. An onsite operator sends instructions to a device server (224) to confirm when a wiper (106a) was spraying fluid, a wiper fluid level sensor relay on a relay board (204) was closed. (499) If the test was successful, and a wiper fluid level sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(421) An onsite operator instructs a device server (224) to perform a defroster test. An onsite operator instructs a device server (224) to close a defroster relay on a relay board (204) providing power to a defroster (234). An onsite operator observes heat emitting from a defroster (234). An onsite operator instructs a device server (224) to confirm a defroster is operating and emitting heat. (499) If the test was successful, and a defroster (234) is operating and emitting heat, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(423) An onsite operator instructs a device server (224) to perform a defroster sensor test during a defroster test (421). An onsite operator instructs a device server (224) to confirm a defroster is emitting heat. An onsite operator sends instructions to a device server (224) to confirm when a defroster was emitting heat, a defroster sensor relay on a relay board (204) was closed. (499) If the test was successful, and a defroster sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(425) An onsite operator instructs a device server (224) to perform a defroster thermostat test. An onsite operator instructs a device server (224) to close a defroster thermostat relay on a relay board (204) providing power to a defroster thermostat (208). An onsite operator observes heat emitting from a defroster (234). An onsite operator instructs a device server (224) to confirm a defroster thermostat is operating. (499) If the test was successful, and a defroster thermostat (208) is operating, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(427) An onsite operator instructs a device server (224) to perform a defroster thermostat sensor test during a defroster thermostat test (425). An onsite operator instructs a device server (224) to confirm a defroster thermostat sensor is operating. An onsite operator sends instructions to a device server (224) to confirm when a defroster thermostat was operating, a defroster thermostat sensor relay on a relay board (204) was closed. (499) If the test was successful, and a defroster thermostat sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test (429).

(429) An onsite operator instructs a device server (224) to perform a fan test. An onsite operator instructs a device server (224) to close a fan relay on a relay board (204) providing power to a fan (230). An onsite operator observes a fan (230) operating and blowing air. An onsite operator instructs a device server (224) to confirm a fan (230) is operating. (499) If the test was successful, and a fan is operating and blowing air, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(431) An onsite operator instructs a device server (224) to perform a fan sensor test during a fan test (429). An onsite operator instructs a device server (224) to confirm a fan sensor (272) is operating. An onsite operator sends instructions to a device server (224) to confirm when a fan was operating, a fan sensor relay on a relay board (204) was closed. (499) If the test was successful, and a fan sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(435) An onsite operator instructs a device server (224) to perform an air filter sensor test. An onsite operator observes an air filter (298) installed in a camera system (100). An onsite operator instructs a device server (224) to confirm an air filter (298) is installed in a camera system (100). An onsite operator observes an air filter (298) installed in a camera system (100). An onsite operator sends instructions to a device server (224) to confirm an air filter (298) is installed, and an air filter sensor relay on a relay board (204) was closed. (499) If the test was successful, and an air filter sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(439) An onsite operator instructs a device server (224) to perform a guy-wire sensor test. An onsite operator instructs a device server (224) to confirm a guy-wire sensor (288) is operating on a camera system (100). An onsite operator observes a guy-wire (280) installed in a camera system (100). An onsite operator sends instructions to a device server (224) to confirm a guy-wire (280) is connected to a camera system (100) and an installed guy-wire ground anchor connector (256), and a guy-wire sensor relay on a relay board (204) was closed. (499) If the test was successful, and a guy-wire sensor relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(441) An onsite operator instructs a device server (224) to perform a backup power test. An onsite operator instructs a device server (224) to confirm a backup power supply sensor (251) is operating on a camera system (100). An onsite operator observes a backup power supply (239) installed and operational in a camera system (100). An onsite operator disconnects an AC power source (268) from a camera system. An onsite operator sends instructions to a device server (224) to confirm a backup power supply (239) is connected to a camera system (100) and a backup power relay on a relay board (204) was closed. (499) If the test was successful, and a backup power relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test. An onsite operator disconnects a backup power supply (239) from a camera system (100). An onsite operator reconnects an AC power source (268) to a camera system (100).

(443) An onsite operator instructs a device server (224) to perform a strut sensor test. An onsite operator instructs a device server (224) to confirm a strut connect sensor (273) is operating on a camera system (100). An onsite operator observes a strut (282) installed in a camera system (100). An onsite operator sends instructions to a device server (224) to confirm a strut (282) is connected to a camera system (100) and a strut connect relay on a relay board (204) was closed. (499) If the test was successful, and a strut connect relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(445) An onsite operator instructs a device server (224) to perform a quiver buffer sensor test. An onsite operator instructs a device server (224) to confirm a quiver buffer connect sensor (297) is operating on a camera system (100). An onsite operator observes a quiver buffer (297) installed in a camera system (100). An onsite operator sends instructions to a device server (224) to confirm a quiver buffer (297) is connected to a camera system (100) and a quiver buffer relay on a relay board (204) was closed. (499) If the test was successful, and a quiver buffer relay on relay board (204) was closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(447) An onsite operator instructs a device server (224) to perform a status indicator test. An onsite operator instructs a device server (224) to confirm a Status LED 206A through LED 206F and Indicator 206A through Indicator 206F are operating on a camera system (100). An onsite operator observes a status indicator (206I) installed in a camera system (100). An onsite operator sends instructions to a device server (224) to confirm a Status LED 206A is connected to a status indicator (206I) and a LED 206A relay on a status indicator control board (212) was closed and, an onsite operator sends instructions to a device server (224) to confirm a Status LED 206B is connected to a status indicator (206I) and a LED 206B relay on a status indicator control board (212) was closed and, an onsite operator sends instructions to a device server (224) to confirm a Status LED 206C is connected to a status indicator (206I) and a LED 206C relay on a status indicator control board (212) was closed and, an onsite operator sends instructions to a device server (224) to confirm a Status LED 206D is connected to a status indicator (206I) and a LED 206D relay on a status indicator control board (212) was closed and, an onsite operator sends instructions to a device server (224) to confirm a Status LED 206E is connected to a status indicator (206I) and a LED 206E relay on a status indicator control board (212) was closed and, an onsite operator sends instructions to a device server (224) to confirm a Status LED 206F is connected to a status indicator (206I) and a LED 206F relay on a status indicator control board (212) was closed and, an onsite operator sends instructions to a device server (224) to confirm an Indicator 206G is connected to a status indicator (206I) and an Indicator 206G relay on a status indicator control board (212) was closed and, an onsite operator sends instructions to a device server (224) to confirm an Indicator 206H is connected to a status indicator (206I) and an Indicator 206H relay on a status indicator control board (212) was closed and, an onsite operator sends instructions to a device server (224) to confirm an Indicator 206I is connected to a status indicator (206I) and an Indicator 206I relay on a status indicator control board (212) was closed and, an onsite operator sends instructions to a device server (224) to confirm an Indicator 206J is connected to a status indicator (206I) and an Indicator 206J relay on a status indicator control board (212) was closed.

(499) If the test was successful, and LED 206A, LED 206B, LED 206C, LED 200DA, LED 206E, LED 206F, Indicator 206G, Indicator 206H, Indicator 206I, and Indicator 206J relays on relay board (204) were closed, an onsite operator updates a Camera System Log (302) with a successful outcome for the test. If the Test was not successful within 15 minutes but not limited to 15 minutes, the test was NOT successful. An onsite operator updates a Camera System Log (302) with an unsuccessful outcome for the Test.

(449) An onsite operator instructs a device server (224) to transmit an onsite field benchmark image to a Remote Operator. A device server (224) retrieves a field benchmark image from an image storage device (226). A device server (224) using a communication system (107) transmits a field benchmark image to a remote operator.

(450) A remote operator receives a field benchmark image from a camera system (100). An operator compares a field benchmark image with a benchmark image. An operator determines if a field benchmark image is adequate.

An operator establishes a Field Benchmark Image Elevation Rubric, rules, and algorithm for determining if a field benchmark image is acceptable.

An operator updates a Client Request Form (601) with a Field Benchmark Image Elevation Score. The rubric may be metric, digital, subjective or any combination. The rubric, rules, algorithm provide the operator with a method for grading the outcome of determining if a field benchmark image for a camera system (100) and determining if a Field Benchmark Image Elevation Score is acceptable.

An operator uses a value of 10, but not limited to 10 to indicate a score which is acceptable. An operator uses a value of 1, but not limited to 1 to indicate a score which is not adequate.

An operator updates a Client Request Form (601) with a grade for the outcome of an acceptable if a field benchmark image for a camera system (100).

(451) If a field benchmark image for a camera system (100) is not adequate, a remote operator transmits a message to an onsite operator. A message informs an onsite operator but is not limited to informing, there is a device malfunction. An onsite operator contacts, but is not limited to contacting, a maintenance operator for a repair of a camera system (100).

(499) An operator updates a Camera System Log (302) an outcome of a field benchmark image review for a camera system (100).

(455) An onsite operator instructs a device server (224), using a communication system (107) to transmit a Camera System Log (302) to a remote operator.

(457) An onsite operator instructs a device server to instruct a status indicator control board (212) to close a Indicator 206J relay connected to a status indicator (206I) or close an Indicator 206J relay connected to status indicator (206J) or close an Indicator 206K relay connected to status indicator (206K) or depending on an outcome of a diagnostic test. A device server instructs, but is not limited to instructing, a status indicator to light an Indicator (206J) green for ‘OK’, or an indicator (206I) yellow for ‘system alert or caution’, or an Indicator (206J) red for ‘System not operative. Do not take images’.

(459) An operator ends diagnostic testing.

The Second Camera System Diagnostic Process and Instruction Set: Daily Internal self-system diagnostic check

(460) The second process of a Camera System Diagnostic Process and Instruction Set (FIG. 16) is a Daily Internal self-system diagnostic check described in FIGS. 4a-4d and beginning at figure number 460. A camera system (100) performs a self-test of its elements daily but not limited to daily. A camera system (100) performs a self-test of its elements at specific time each day but not limited to a specific time each day. A device server (224) continually compares a daily self-test diagnostic test start date and time with a camera system clock (224) date and time. A device server (224) compares a daily self-test diagnostic test start date and time with a camera system clock (286) and determines a daily self-test diagnostic test start date and time is now.

(461) A device server (224) to perform a ACK/NAK Test. A device server (224) using a communication system (107) transmits a request to a Remote Operator to reply to a test message.

A device server (224) updates a Camera System Log (302) with the outcome of a ACK/NAK test. A device server (224) using a communication system (107) transmits a ‘test’ message to a Remote Operator requesting a reply. A ‘test’ message from a device server includes but is not limited to including a phrase ‘ACK/NAK Test message’, a camera system identification number, and a date and time when the message was transmitted to a remote operator.

(499) If the test was successful, a device server (224) updates a Camera System Log with a successful outcome for the test. If the Test was not successful within 15 minutes but not limited to 15 minutes, the test was NOT successful. A device server (224) updates a Camera System Log with an unsuccessful outcome for the Test.

(463) A device server (224) performs camera system clock (286) test. A device server (224) determines if the date and time on a camera system clock (286) are the same as the date and time on a GPS receiver (111). A device server (224) accesses the date and time from the GPS receiver (111). A device server (224) accesses the date and time from the camera system clock (286). A device server (224) determines if the date and time from the GPS receiver are the same as the date and time from the Camera System Clock (286). (499) If the test was successful and a date and time on a GPS receiver (111) are the same as a data and time on a camera system clock (286), a device server updates a Camera System Log (302) with a successful outcome for the test. If the Test was not successful within 15 minutes but not limited to 15 minutes, the test was NOT successful. An devices server (224) updates a Camera System Log (302) with an unsuccessful outcome for the Test.

(465) A device server (224) performs an image to image storage device test. A device server (224) instructs a camera body (200) to capture an image. A device server (224) copies and stores an image from a camera body (200) to an image storage device (226). A device server (224) confirms an image was stored on an image storage device (226). (499) If the test was successful, and an image was stored on image storage device (226), a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(467) A device server (224) performs a pan/tilt test. A device server (224) instructs pan/tilt (104) to pan. A device server (224) instructs a pan relay and tilt relay located on relay board (204) to close and provide electric power to a pan/tilt mechanism and base (104). A device server (224) uses an algorithm to determine the amount of time to keep a pan relay closed to move a Pan/Tilt (104) to the required pan degree location for the test and to return to a pan position before a test. A device server (224) uses an algorithm to determine the amount of time to keep a tilt relay closed to move a Pan/Tilt (104) to the required tilt degree location for a test and to return to a tilt position before a test. A device server (224) confirms a pan relay and a tilt relay on a relay board (204) is closed. (499) If the test was successful, and a pan relay and a tilt relay on a relay board (204) are closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(471) A device server (224) performs a wiper test. A device server (224) instructs a wiper (106a) to operate a wiper motor. A device server (224) closes a wiper relay on a relay board (204) providing power to a motor included in wiper (106a). A device server (224) confirms a wiper relay on a relay board (204) is closed. (499) If the test was successful, and a wiper relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(477) A device server (224) performs a defroster test. A device server (224) instructs defroster (234) to operate. A device server (224) closes a defroster relay on a relay board (204) providing power to a defroster (234). A device server (224) confirms a defroster relay on a relay board (204) is closed. (499) If the test was successful, and a defroster relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(481) A device server (224) performs a defroster thermostat test. A device server (224) instructs defroster thermostat (208) to operate A device server (224) closes a defroster thermostat relay on a relay board (204) providing power to a defroster thermostat (208). A device server (224) confirms a defroster thermostat relay on a relay board (204) is closed. (499) If the test was successful, and a defroster thermostat relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(485) A device server (224) performs fan test. A device server (224) instructs a fan (230) to operate. A device server (224) closes a fan relay on a relay board (204) providing power to a fan (230). A device server (224) confirms a fan relay on a relay board (204) is closed. (499) If the test was successful, and a fan relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(485) A device server (224) performs a fan test. A device server (224) instructs a fan (230) to operate. A device server (224) closes a fan relay on a relay board (204) providing power to a fan (230). A device server (224) confirms a fan relay on a relay board (204) is closed. (499) If the test was successful, and a fan relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(505) A device server (224) performs a Status Indicator test. A device server (224) instructs Status LED 206A through LED 206F and Indicator 206A through Indicator 206F are operating on a camera system (100) to operate. A device server (224) closes LED 206A, LED 206B, LED 206C, LED 200DA, LED 206E, LED 206F, Indicator 206G, Indicator 206H, Indicator 206I, and Indicator 206J relays on a status indicator control board (212) providing information to LED 206A, LED 206B, LED 206C, LED 200DA, LED 206E, LED 206F.

A device server (224) closes Indicator 206G, Indicator 206H, Indicator 206I, and Indicator 206J relays on a status indicator control board (212) providing power to Indicator 206G, Indicator 206H, Indicator 206I, and Indicator 206J.

A device server (224) confirms relay LED 206A, LED 206B, LED 206C, LED 200DA, LED 206E, LED 206F on a status indicator control board (212) are closed.

A device server (224) confirms relay Indicator 206G, Indicator 206H, Indicator 206I, and Indicator 206J on a status indicator control board (212) are closed.

(499) If the test was successful, and a LED 206A, LED 206B, LED 206C, LED 200DA, LED 206E, LED 206F, relay Indicator 206G, Indicator 206H, Indicator 206I, and Indicator 206J relay on a status indicator control board (212) are closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(507) A device server (224) performs a backup power supply test. A device server (224) instructs an AC breaker (112) to operate and disconnect an ac power source from a camera system (100) enabling Automatic Power Transfer Switch (240) to engage Backup Power Supply (239) to power camera system (100). A device server (224) closes a backup relay on a relay board (204) providing backup power to camera system (100). A device server (224) confirms a backup relay on a relay board (204) is closed. (499) If the test was successful, and a backup relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(511) A device server (224) performs a wiper kit test. A device server (224) instructs a wiper fluid pump (231) to operate. A device server (224) closes a wiper fluid pump relay on a relay board (204) providing power to a wiper fluid pump (231). A device server (224) confirms a wiper fluid pump relay on a relay board (204) is closed. (499) If the test was successful, and a wiper fluid pump relay on a relay board (204) is closed, a device server (224) updates a Camera System Log (302) with a successful outcome for the test. If the Test was not successful within 15 minutes but not limited to 15 minutes, the test was NOT successful. A device server (224) updates a Camera System Log (302) with an unsuccessful outcome for the Test.

(513) A device server (224), using a communication system (107) to transmit a Camera System Log (302) to a remote operator.

(515) An onsite operator instructs a device server to instruct a status indicator control board (212) to close a Indicator 206J relay connected to a status indicator (206I) or close an Indicator 206J relay connected to status indicator (206J) or close an Indicator 206K relay connected to status indicator (206K) or

depending on an outcome of a diagnostic test. A device server instructs, but is not limited to instructing, a status indicator to light an Indicator 206J green for ‘OK’, or an indicator (206I) yellow for ‘system alert or caution’, or an Indicator 206J red for ‘System not operative. Do not take images’.

(516) An operator ends diagnostic testing.

The Third Camera System Diagnostic Process and Instruction Set: Daily Remote Operator System Diagnostic check

(517) The third process of a Camera System Diagnostic Process and Instruction Set (FIG. 16) is a Daily remote operator system diagnostic check described in FIG. 5 and beginning at figure number 517. A remote operator performs a diagnostic test of an element of a camera system (100). A remote operator performs a diagnostic test of an element of a camera system (100) daily but not limited to daily. A remote operator establishes a time to begin a diagnostic system check for a camera system (100).

(519) A remote operator reviews a Camera System Log (302) for a camera system (100).

(521) A remote operator accesses the condition of a wrapper window (110) for a camera system (100). A remote operator retrieves images from a docu-vault associated with a wrapper window (110) for a camera system (100). A remote operator retrieves images from a docu-vault for three days, but not limited to three days, previous to the day of the diagnostic test. A remote operator reviews the condition of a wrapper window (110) in the images retrieved from a docu-vault. A remote operator uses EarthCam proprietary instructions sets and procedures to examine the condition of an image of a wrapper window (110). A remote operator determines if the condition of the wrapper window (110) is adequate.

A remote operator gathers information about the condition of a wrapper window (110).

An operator establishes a Wrapper Window Rubric, rules, and algorithm for determining if the condition of a wrapper window (110) is adequate for capturing clear and accurate outlying images but not limited to capturing clear and accurate outlying images.

An operator updates a Camera System Log (302) with a Wrapper Window Score.

The rubric may be metric, digital, subjective or any combination. The rubric, rules, algorithm provide the operator with a method for grading the outcome of determining if the condition of a wrapper window (110) is adequate for capturing clear and accurate outlying images but not limited to capturing clear and accurate outlying image and determining if a Wrapper Window Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of the condition of a wrapper window (110).

An operator updates a Camera System Log (302) with a grade for the outcome of the condition of a wrapper window (110).

(523) A remote operator accesses the condition of a camera lens front (250) for a camera system (100). A remote operator retrieves images from a docu-vault associated with a camera lens front (250) for a camera system (100). A remote operator retrieves images from a docu-vault for three days, but not limited to three days, previous to the day of the diagnostic test. A remote operator reviews the condition of a camera lens front (250) in the images retrieved from a docu-vault. A remote operator uses EarthCam proprietary instructions sets and procedures to examine the condition of an image taken by a camera lens front (250). A remote operator determines if the condition of the camera lens front (250) is adequate.

A remote operator gathers information about determining if the condition of the camera lens front is, but not limited to, being stable, and adequate for capturing clear and accurate outlying images. An operator establishes a Camer Lens Front Rubric, rules, and algorithm for determining if a system must be relocated.

An operator updates a Camera System Log (302) with a Camera Lens Front Score. The rubric may be metric, digital, subjective or any combination. The rubric, rules, algorithm provide the operator with a method for grading the outcome of determining if the condition of the camera lens front is, but not limited to, being stable, and adequate for capturing clear and accurate outlying images and determining if a Camera Lens Front Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of a process for determining if the condition of the camera lens front is, but not limited to, being stable, and adequate for capturing clear and accurate outlying images.

An operator updates a Camera System Log (302) with a grade for the outcome of a process for determining if the condition of the camera lens front is, but not limited to, being stable, and adequate for capturing clear and accurate outlying images.

(525) A remote operator accesses the condition of a guy-wire (280) for a camera system (100). A remote operator retrieves images from a docu-vault associated with a guy-wire (280) for a camera system (100). A remote operator retrieves images from a docu-vault for three days, but not limited to three days, previous to the day of the diagnostic test. A remote operator reviews the condition of a guy-wire (280) in the images retrieved from a docu-vault. A remote operator uses EarthCam proprietary instructions sets and procedures to examine the condition of an image of a guy-wire (280). A remote operator determines if the condition of the guy-wire (280) is adequate.

A remote operator gathers information about, but not limited to, the stability, connection, and security of a guy-wire (280).

An operator establishes a Guy-wire Rubric, rules, and algorithm for determining but not limited to determining, if the stability, connection, and security of a guy-wire (280) is adequate.

An operator updates a Camera System Log (302) with a Guy-wire Score.

The rubric may be metric, digital, subjective or any combination. The rubric, rules, algorithm provide the operator with a method for grading the outcome for determining but not limited to determining, if the stability, connection, and security of a guy-wire (280) is adequate and determining if a Guy-wire Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome for determining but not limited to determining, if the stability, connection, and security of a guy-wire (280) is adequate.

An operator updates a Camera System Log (302) with a grade for the outcome for determining but not limited to determining, if the stability, connection, and security of a guy-wire (280) is adequate.

(527) A remote operator accesses the condition of a quiver buffer (296) for a camera system (100). A remote operator retrieves images from a docu-vault associated with a quiver buffer (296) for a camera system (100). A remote operator retrieves images from a docu-vault for three days, but not limited to three days, previous to the day of the diagnostic test. A remote operator reviews the condition of a quiver buffer (296) in the images retrieved from a docu-vault. A remote operator uses EarthCam proprietary instructions sets and procedures to examine the condition of an image of a quiver buffer (296). A remote operator determines if the condition of the quiver buffer (296) is adequate.

A remote operator gathers information about, but not limited to the condition and operability of a quiver buffer (296).

An operator establishes a Quiver Buffer Rubric, rules, and algorithm for determining, but not limited to determining, if condition and operability of a quiver buffer (296) is adequate.

An operator updates a Camera System Log (302) with a Quiver Buffer Score.

The rubric may be metric, digital, subjective or any combination. The rubric, rules, algorithm provide the operator with a method for grading the outcome for determining, but not limited to determining, if the condition and operability of a quiver buffer (296) is adequate and determining if a Quiver Buffer Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of determining, but not limited to determining, if the condition and operability of a quiver buffer (296) is adequate.

An operator updates a Camera System Log (302) with a grade for the outcome of determining, but not limited to determining, if the condition and operability of a quiver buffer (296) is adequate.

(529) A remote operator accesses the condition of a Strut (282) for a camera system (100). A remote operator retrieves images from a docu-vault associated with a Strut (282) for a camera system (100). A remote operator retrieves images from a docu-vault for three days, but not limited to three days, previous to the day of the diagnostic test. A remote operator reviews the condition of a Strut (282) in the images retrieved from a docu-vault. A remote operator uses EarthCam proprietary instructions sets and procedures to examine the condition of an image of a Strut (282). A remote operator determines if the condition of the Strut (282) is adequate.

A remote operator gathers information about, but not limited to the security, condition, and operability of a Strut (282).

An operator establishes a Strut Rubric, rules, and algorithm for determining but not limited to determining if the security, condition, and operability of a Strut (282) is adequate. An operator updates a Camera System Log (302) with a Strut Score.

The rubric may be metric, digital, subjective or any combination. The rubric, rules, algorithm provide the operator with a method for grading the outcome for determining but not limited to determining if the security, condition, and operability of a Strut (282) is adequate and determining if a Strut Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of determining but not limited to determining if the security, condition, and operability of a Strut (282) is adequate.

An operator updates a Camera System Log (302) with a grade for the outcome of determining but not limited to determining if the security, condition, and operability of a Strut (282) is adequate.

(531) A remote operator contacts Field Maintenance for a camera system (100) if there is a less than adequate rubric score for but not limited to a rubric score for a Wrapper Window Rubric (521), Camera Lens Front Rubric (523), Guy-wire Rubric (525), Quiver Buffer Rubric (527), and Strut Rubric (529).

(533) A remote operator schedules an onsite inspection for a camera system (100) with Field Maintenance if there is a less than adequate rubric score for but not limited to a rubric score for a Wrapper Window Rubric (521), Camera Lens Front Rubric (523), Guy-wire Rubric (525), Quiver Buffer Rubric (527), and Strut Rubric (529). An onsite operator updates a Camera System Log (302) with the with the date for an onsite inspection for a camera system (100) with Field Maintenance.

### The Fourth Camera System Diagnostic Process and Instruction Set: Scheduled Onsite Maintenance Diagnostic Check

(535) The third process of a Camera System Diagnostic Process and Instruction Set (FIG. 16) is a Scheduled Operator Onsite Diagnostic Check described in FIG. 6a-6g and beginning at FIG. number 535. An onsite maintenance operator performs an onsite maintenance diagnostic test of an element of a camera system (100). An onsite maintenance operator performs a scheduled onsite maintenance diagnostic test of an element of a camera system (100) monthly but not limited to monthly.

A remote operator establishes a date and time to begin an onsite maintenance diagnostic system check for a camera system (100). An onsite maintenance operator uses a Scheduled Maintenance Procedure Guide and System Readiness Checklist (113) to perform a scheduled maintenance check, but not limited to a scheduled maintenance check.

(536) An onsite maintenance operator reviews a Camera System Log (302) for a camera system (100). An onsite maintenance operator reviews a Camera System Log (302) for, but not limited to, operational issues with camera system (100) mechanical elements.

(537) An onsite maintenance operator instructs a device server (224) to perform a ACK/NAK Test. A device server (224) using a communication system (107) transmits a request to a Remote Operator to reply to a test message.

An onsite maintenance operator updates a Camera System Log (302) with the outcome of a ACK/NAK test. A device server (224) using a communication system (107) transmits a ‘test’ message to a Remote Operator requesting a reply. A ‘test’ message from a device server includes but is not limited to including a phrase ‘ACK/NAK Test message’, a camera system identification number, and a date and time when the message was transmitted to a remote operator.

(499) If the test was successful, an onsite maintenance operator updates a Camera System Log with a successful outcome for the test. If the Test was not successful within 15 minutes but not limited to 15 minutes, the test was NOT successful. An onsite maintenance operator updates a Camera System Log with an unsuccessful outcome for the Test.

(539) An onsite maintenance operator instructs a device server (224) to perform a camera system clock (286) test. A device server (224) determines if the date and time on a camera system clock (286) are the same as the date and time on a GPS receiver (111). A device server (224) accesses the date and time from the GPS receiver (111). A device server (224) accesses the date and time from the camera system clock (286). A device server (224) determines if the date and time from the GPS receiver are the same as the date and time from the Camera System Clock (286). (499) If the test was successful and a date and time on a GPS receiver (111) are the same as a data and time on a camera system clock (286), an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(541) An onsite maintenance operator instructs a device server (224) to perform an initial image capture test. A device server (224) connected to a Camera Body (200), instructs a Camera Body to capture an outlying image. A camera body captures an outlying image. (499) If the test was successful, an onsite maintenance operator updates a Camera System Log (302) with a successful outcome for the test. If the Test was not successful within 15 minutes but not limited to 15 minutes, the test was NOT successful. An onsite maintenance operator updates a Camera System Log with an unsuccessful outcome for the Test.

(543) An onsite maintenance operator instructs a device server (224) to perform a pan/tilt test. An onsite maintenance operator observes the pan/tilt (104). An onsite maintenance operator instructs a device server a number of degrees for a pan/tilt mechanism and base (104) to pan horizontally and a number of degrees to tilt vertically for a test. An onsite maintenance operator instructs a device server a number of degrees for a pan/tilt (104) to pan horizontally and a number of degrees to tilt vertically to return to a pan/tilt position before the test.

A device server (224) instructs a pan relay and tilt relay located on relay board (204) to close and provide electric power to a pan/tilt mechanism and base (104). An operator uses an algorithm to determine the amount of time to keep a pan relay closed to move a Pan/Tilt (104) to the required pan degree location for the test and to return to a pan position before a test. An operator uses an algorithm to determine the amount of time to keep a tilt relay closed to move a Pan/Tilt (104) to the required tilt degree location for a test and to return to a tilt position before a test. (499) If the test was successful, and a pan/tilt (104) moved to the test position and return to the position before the test, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(545) An onsite maintenance operator instructs a device server (224) to perform a pan/tilt sensor test during a pan/tilt test (543). An onsite maintenance operator instructs a device server (224) to confirm a pan/tilt sensor (278) is operating. An onsite maintenance operator sends instructions to a device server (224) to confirm when a pan/tilt (104) was panning, a pan relay on a relay board (204) was closed. An onsite maintenance operator sends instructions to a device server (224) to confirm when a pan/tilt (104) was tilting, a relay on a relay board (204) was closed. (499) If the test was successful, and a pan relay on a relay board (204) was closed when a pan/tilt (104) was panning and a tilt relay on a relay board (204) was closed onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(547) An onsite maintenance operator instructs a device server (224) to perform a wiper (106a) test. An onsite maintenance operator instructs a device server (224) to close a wiper relay on a relay board (204) providing power to a motor included in wiper (106a). An onsite maintenance operator observes a wiper (106a). An onsite maintenance operator instructs a device server (224) to confirm a wiper motor and wiper (106a) are operating and moving. (499) If the test was successful, and a wiper (106a) and wiper motor were working, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(548) An onsite maintenance operator instructs a device server (224) to perform a wiper sensor test during a wiper (106a) test (547). An onsite maintenance operator instructs a device server (224) to confirm a wiper (106a) is operating. An onsite maintenance operator sends instructions to a device server (224) to confirm when a wiper (106a) was operating, a wiper sensor relay on a relay board (204) was closed. (499) If the test was successful, and a wiper sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(549) An onsite maintenance operator instructs a device server (224) to perform a wiper kit test. An onsite maintenance operator instructs a device server (224) to close a wiper fluid pump relay on a relay board (204) providing power to a wiper fluid pump (231). An onsite maintenance operator observes a wiper (106a) spraying fluid. An onsite maintenance operator instructs a device server (224) to confirm a wiper fluid pump (231) is operating. (499) If the test was successful, and a wiper fluid pump is working, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(553) An onsite maintenance operator instructs a device server (224) to perform a defroster test. An onsite maintenance operator instructs a device server (224) to close a defroster relay on a relay board (204) providing power to a defroster (234). An onsite maintenance operator observes heat emitting from a defroster (234). An onsite maintenance operator instructs a device server (224) to confirm a defroster is operating and emitting heat. (499) If the test was successful, and a defroster (234) is operating and emitting heat, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(555) An onsite maintenance operator instructs a device server (224) to perform a defroster sensor test during a defroster test (553). An onsite maintenance operator instructs a device server (224) to confirm a defroster is emitting heat. An onsite maintenance operator sends instructions to a device server (224) to confirm when a defroster was emitting heat, a defroster sensor relay on a relay board (204) was closed. (499) If the test was successful, and a defroster sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(557) An onsite maintenance operator instructs a device server (224) to perform a defroster thermostat test. An onsite maintenance operator instructs a device server (224) to close a defroster thermostat relay on a relay board (204) providing power to a defroster thermostat (208). An onsite maintenance operator observes heat emitting from a defroster (234). An onsite maintenance operator instructs a device server (224) to confirm a defroster thermostat is operating. (499) If the test was successful, and a defroster thermostat (208) is operating, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(559) An onsite maintenance operator instructs a device server (224) to perform a defroster thermostat sensor test during a defroster thermostat test (557). An onsite maintenance operator instructs a device server (224) to confirm a defroster thermostat sensor is operating. An onsite maintenance operator sends instructions to a device server (224) to confirm when a defroster thermostat was operating, a defroster thermostat sensor relay on a relay board (204) was closed. (499) If the test was successful, and a defroster thermostat sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test (429).

(561) An onsite maintenance operator instructs a device server (224) to perform a fan test. An onsite maintenance operator instructs a device server (224) to close a fan relay on a relay board (204) providing power to a fan (230). An onsite maintenance operator observes a fan (230) operating and blowing air. An onsite maintenance operator instructs a device server (224) to confirm a fan (230) is operating. (499) If the test was successful, and a fan is operating and blowing air, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(563) An onsite maintenance operator instructs a device server (224) to perform a fan sensor test during a fan test (561). An onsite maintenance operator instructs a device server (224) to confirm a fan sensor (272) is operating. An onsite maintenance operator sends instructions to a device server (224) to confirm when a fan was operating, a fan sensor relay on a relay board (204) was closed. (499) If the test was successful, and a fan sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(565) An onsite maintenance operator replaces an air filter (298) with a new air filter. An onsite maintenance operator updates a Camera System Log (302) that an air filter (298) was replaced.

(567) An onsite maintenance operator instructs a device server (224) to perform an air filter sensor test. An onsite maintenance operator observes an air filter (298) installed in a camera system (100). An onsite maintenance operator instructs a device server (224) to confirm an air filter (298) is installed in a camera system (100). An onsite maintenance operator observes an air filter (298) installed in a camera system (100). An onsite maintenance operator sends instructions to a device server (224) to confirm an air filter (298) is installed, and an air filter sensor relay on a relay board (204) was closed. (499) If the test was successful, and an air filter sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(569) An onsite maintenance operator checks but not limited to checking a guy-wire (280), Guy-wire disconnect sensor (288), Guy-wire Camera System Connector (255), Guy-wire Ground Anchor Connector (256) to verify a stable and motion free installation for a camera system (100). An onsite maintenance operator updates a Camera System Log (302) to verify the following, but not limited to the following, are secure and provide a motion free installation for camera system (100): a guy-wire (280), Guy-wire disconnect sensor (288), Guy-wire Camera System Connector (255), and Guy-wire Ground Anchor Connector (256). An onsite maintenance operator updates a Camera System Log (302) with the condition of, but not limited to the condition of, a guy-wire (280), Guy-wire disconnect sensor (288), Guy-wire Camera System Connector (255), and Guy-wire Ground Anchor Connector (256).

(571) An onsite maintenance operator instructs a device server (224) to perform a guy-wire sensor test. An onsite maintenance operator instructs a device server (224) to confirm a guy-wire sensor (288) is operating on a camera system (100). An onsite maintenance operator observes a guy-wire (280) installed in a camera system (100). An onsite maintenance operator sends instructions to a device server (224) to confirm a guy-wire (280) is connected to a camera system (100) and an installed guy-wire ground anchor connector (256), and a guy-wire sensor relay on a relay board (204) was closed. (499) If the test was successful, and a guy-wire sensor relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(573) An onsite maintenance operator checks but not limited to checking a strut (282) and two (2), but not limited to two (2), strut to pole connectors (258), safety cable (227) and safety cable connector (229) to verify a safe, secure, and motion free installation for a camera system (100). An onsite maintenance operator updates a Camera System Log (302) with the condition of, but not limited to the condition of a strut (282) and two (2), but not limited to two (2), strut to pole connectors (258), safety cable (227) and safety cable connector (229).

(575) An onsite maintenance operator instructs a device server (224) to perform a strut sensor test. An onsite maintenance operator instructs a device server (224) to confirm a strut connect sensor (273) is operating on a camera system (100). An onsite maintenance operator observes a strut (282) installed in a camera system (100). An onsite maintenance operator sends instructions to a device server (224) to confirm a strut (282) is connected to a camera system (100) and a strut connect relay on a relay board (204) was closed. (499) If the test was successful, and a strut connect relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(579) An onsite maintenance operator checks but not limited to checking a quiver buffer (272) to verify a secure, and quiver free installation for a camera system (100). An onsite maintenance operator updates a Camera System Log (302) with the condition of, but not limited to the condition of a quiver buffer (272).

(580) An onsite maintenance operator instructs a device server (224) to perform a quiver buffer sensor test. An onsite maintenance operator instructs a device server (224) to confirm a quiver buffer connect sensor (297) is operating on a camera system (100). An onsite maintenance operator observes a quiver buffer (297) installed in a camera system (100). An onsite maintenance operator sends instructions to a device server (224) to confirm a quiver buffer (297) is connected to a camera system (100) and a quiver buffer relay on a relay board (204) was closed. (499) If the test was successful, and a quiver buffer relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(581) An onsite maintenance operator instructs a device server (224) to perform a status indicator test. An onsite maintenance operator instructs a device server (224) to confirm a Status LED 206A through LED 206F and Indicator 206A through Indicator 206F are operating on a camera system (100). An onsite maintenance operator observes a status indicator (206I) installed and operating in a camera system (100). An onsite maintenance operator sends instructions to a device server (224) to confirm a Status LED 206A is connected to a status indicator (206I) and a LED 206A relay on a status indicator control board (212) was closed and, an onsite maintenance operator sends instructions to a device server (224) to confirm a Status LED 206B is connected to a status indicator (206I) and a LED 206B relay on a status indicator control board (212) was closed and, an onsite maintenance operator sends instructions to a device server (224) to confirm a Status LED 206C is connected to a status indicator (206I) and a LED 206C relay on a status indicator control board (212) was closed and, an onsite maintenance operator sends instructions to a device server (224) to confirm a Status LED 206D is connected to a status indicator (206I) and a LED 206D relay on a status indicator control board (212) was closed and, an onsite maintenance operator sends instructions to a device server (224) to confirm a Status LED 206E is connected to a status indicator (206I) and a LED 206E relay on a status indicator control board (212) was closed and, an onsite maintenance operator sends instructions to a device server (224) to confirm a Status LED 206F is connected to a status indicator (206I) and a LED 206F relay on a status indicator control board (212) was closed and, an onsite maintenance operator sends instructions to a device server (224) to confirm an Indicator 206G is connected to a status indicator (206I) and an Indicator 206G relay on a status indicator control board (212) was closed and, an onsite maintenance operator sends instructions to a device server (224) to confirm an Indicator 206H is connected to a status indicator (206I) and an Indicator 206H relay on a status indicator control board (212) was closed and, an onsite maintenance operator sends instructions to a device server (224) to confirm an Indicator 206I is connected to a status indicator (206I) and an Indicator 206I relay on a status indicator control board (212) was closed and, an onsite maintenance operator sends instructions to a device server (224) to confirm an Indicator 206J is connected to a status indicator (206I) and an Indicator 206J relay on a status indicator control board (212) was closed.

(499) If the test was successful, and LED 206A, LED 206B, LED 206C, LED 200DA, LED 206E, LED 206F, Indicator 206G, Indicator 206H, Indicator 206I, and Indicator 206J relays on relay board (204) were closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test.

(582) An onsite maintenance operator instructs a device server (224) to perform a backup power test. An onsite maintenance operator instructs a device server (224) to confirm a backup power supply sensor (251) is operating on a camera system (100). An onsite maintenance operator observes a backup power supply (239) installed and operational in a camera system (100). An onsite maintenance operator disconnects an AC power source (268) from a camera system. An onsite maintenance operator sends instructions to a device server (224) to confirm a backup power supply (239) is connected to a camera system (100) and a backup power relay on a relay board (204) was closed. (499) If the test was successful, and a backup power relay on relay board (204) was closed, an onsite maintenance operator updates a Camera System Log (302) with a successful outcome for the test. If the Test was not successful within 15 minutes but not limited to 15 minutes, the test was NOT successful. An onsite maintenance operator updates a Camera System Log (302) with an unsuccessful outcome for the Test. An onsite maintenance operator disconnects a backup power supply (239) from a camera system (100). An onsite maintenance operator reconnects an AC power source (268) to a camera system (100).

(583) An onsite maintenance operator instructs a device server (224) to transmit an onsite field benchmark image to a Remote Operator. A device server (224) retrieves a field benchmark image from an image storage device (226). A device server (224) using a communication system (107) transmits a field benchmark image to a remote operator.

A remote operator receives a filed benchmark image from a camera system (100). A remote operator compares a field benchmark image with a benchmark image. A remote operator determines if a field benchmark image is adequate.

A remote operator establishes a Field Benchmark Image Elevation Rubric, rules, and algorithm for determining if a field benchmark image is acceptable.

A remote operator updates a Client Request Form (601) with a Field Benchmark Image Elevation Score.

The rubric may be metric, digital, subjective or any combination. The rubric, rules, algorithm provide a remote operator with a method for grading the outcome of determining if a field benchmark image for a camera system (100) and determining if a Field Benchmark Image Elevation Score is acceptable.

A remote operator uses a value of 10, but not limited to 10 to indicate a score which is acceptable. A remote operator uses a value of 1, but not limited to 1 to indicate a score which is not adequate.

A remote operator updates a Client Request Form (601) with a grade for the outcome of an acceptable if a field benchmark image for a camera system (100).

If a field benchmark image for a camera system (100) is not adequate, a remote operator transmits a message to an onsite maintenance operator. A message informs an onsite maintenance operator but is not limited to informing, there is a device malfunction. An onsite maintenance operator contacts, but is not limited to contacting, a maintenance operator for a repair of a camera system (100).

An operator updates a Camera System Log (302) an outcome of a field benchmark image review for a camera system (100).

(585) An onsite maintenance operator accesses the condition of a camera wrapper (102) for a camera system (100). An onsite maintenance operator examines a camera wrapper (102) for a camera system (100). An onsite maintenance operator determines if the condition of the camera wrapper (102) is adequate.

An onsite maintenance operator gathers information about the condition of a camera wrapper (102).

An onsite maintenance operator establishes a Wrapper Window Rubric, rules, and algorithm for determining if the condition of a camera wrapper (102) is adequate for capturing clear and accurate outlying images but not limited to capturing clear and accurate outlying images.

An onsite maintenance operator updates a Camera System Log (302) with a Wrapper Window Score.

The rubric may be metric, digital, subjective or any combination. The rubric, rules, algorithm provide the onsite maintenance operator with a method for grading the outcome of determining if the condition of a camera wrapper (102) is adequate for capturing clear and accurate outlying images but not limited to capturing clear and accurate outlying image and determining if a Wrapper Window Score is acceptable.

An onsite maintenance operator uses a value of 10, but not limited to 10 to indicate a score which is adequate. An operator uses a value of 1, but not limited to 1 to indicate a score which is not adequate.

An onsite maintenance operator updates a Client Request Form (601) with a grade for the outcome of the condition of a camera wrapper (102).

An onsite maintenance operator updates a Camera System Log (302) with a grade for the outcome of the condition of a camera wrapper (102).

(587) An onsite maintenance operator accesses the condition of a wrapper window (110) for a camera system (100). An onsite maintenance operator examines a wrapper window (110) for a camera system (100). An onsite maintenance operator determines if the condition of the wrapper window (110) is adequate.

An onsite maintenance operator gathers information about the condition of a wrapper window (110).

An onsite maintenance operator establishes a Wrapper Window Rubric, rules, and algorithm for determining if the condition of a wrapper window (110) is adequate for capturing clear and accurate outlying images but not limited to capturing clear and accurate outlying images.

An onsite maintenance operator updates a Camera System Log (302) with a Wrapper Window Score.

The rubric may be metric, digital, subjective or any combination. The rubric, rules, algorithm provide an onsite maintenance operator with a method for grading the outcome of determining if the condition of a wrapper window (110) is adequate for capturing clear and accurate outlying images but not limited to capturing clear and accurate outlying image and determining if a Wrapper Window Score is acceptable.

An onsite maintenance operator uses a value of 10, but not limited to 10 to indicate a score which is adequate. An operator uses a value of 1, but not limited to 1 to indicate a score which is not adequate.

An onsite maintenance operator updates a Client Request Form (601) with a grade for the outcome of the condition of a wrapper window (110).

An onsite maintenance operator updates a Camera System Log (302) with a grade for the outcome of the condition of a wrapper window (110).

(589) An onsite maintenance operator accesses the condition of a camera lens front (250) for a camera system (100). An onsite maintenance operator examines a camera lens front (250) for a camera system (100). An onsite maintenance operator determines if the condition of the camera lens front (250) is adequate.

An onsite maintenance operator gathers information about determining if the condition of the camera lens front is, but not limited to, being stable, and adequate for capturing clear and accurate outlying images.

An onsite maintenance operator establishes a Camer Lens Front Rubric, rules, and algorithm for determining if a system must be relocated.

An onsite maintenance operator updates a Camera System Log (302) with a Camera Lens Front Score.

The rubric may be metric, digital, subjective or any combination. The rubric, rules, algorithm provide an onsite maintenance operator with a method for grading the outcome of determining if the condition of the camera lens front is, but not limited to, being stable, and adequate for capturing clear and accurate outlying images and determining if a Camera Lens Front Score is acceptable.

An onsite maintenance operator uses a value of 10, but not limited to 10 to indicate a score which is adequate. An operator uses a value of 1, but not limited to 1 to indicate a score which is not adequate.

An onsite maintenance operator updates a Client Request Form (601) with a grade for the outcome of a process for determining if the condition of the camera lens front is, but not limited to, being stable, and adequate for capturing clear and accurate outlying images.

An onsite maintenance operator updates a Camera System Log (302) with a grade for the outcome of a process for determining if the condition of the camera lens front is, but not limited to, being stable, and adequate for capturing clear and accurate outlying images.

(591) An onsite maintenance operator instructs a device server (224) to instruct a status indicator control board (212) to close a Indicator 206J relay connected to a status indicator (206I) or close an Indicator 206J relay connected to status indicator (206J) or close an Indicator 206K relay connected to status indicator (206K) or depending on an outcome of a diagnostic test. A device server instructs, but is not limited to instructing, a status indicator to light an Indicator 206J green for ‘OK’, or an indicator (206I) yellow for ‘system alert or caution’, or an Indicator 206J red for ‘System not operative. Do not take images’.

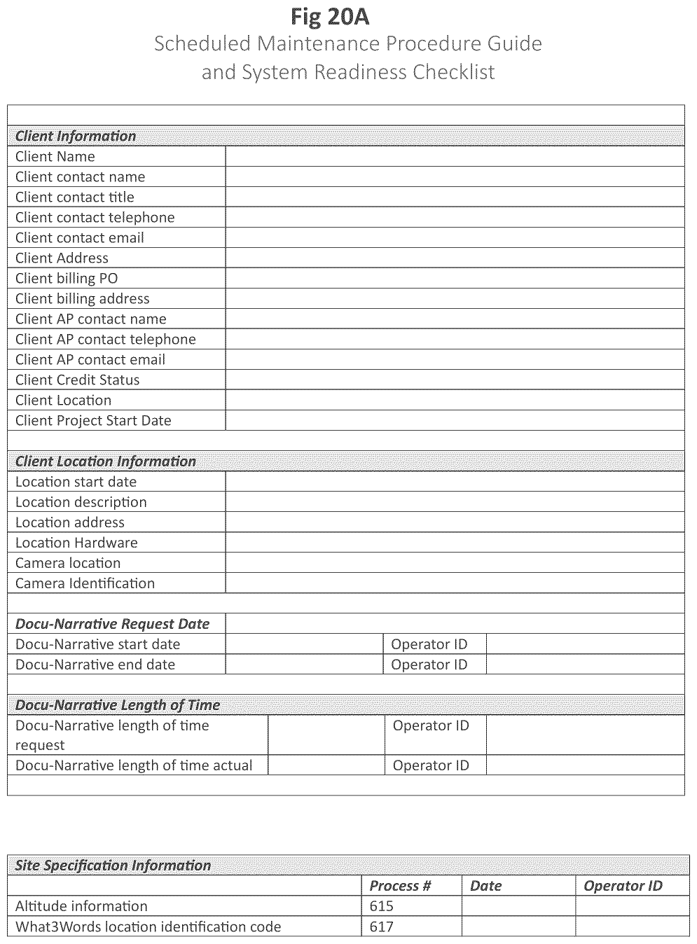

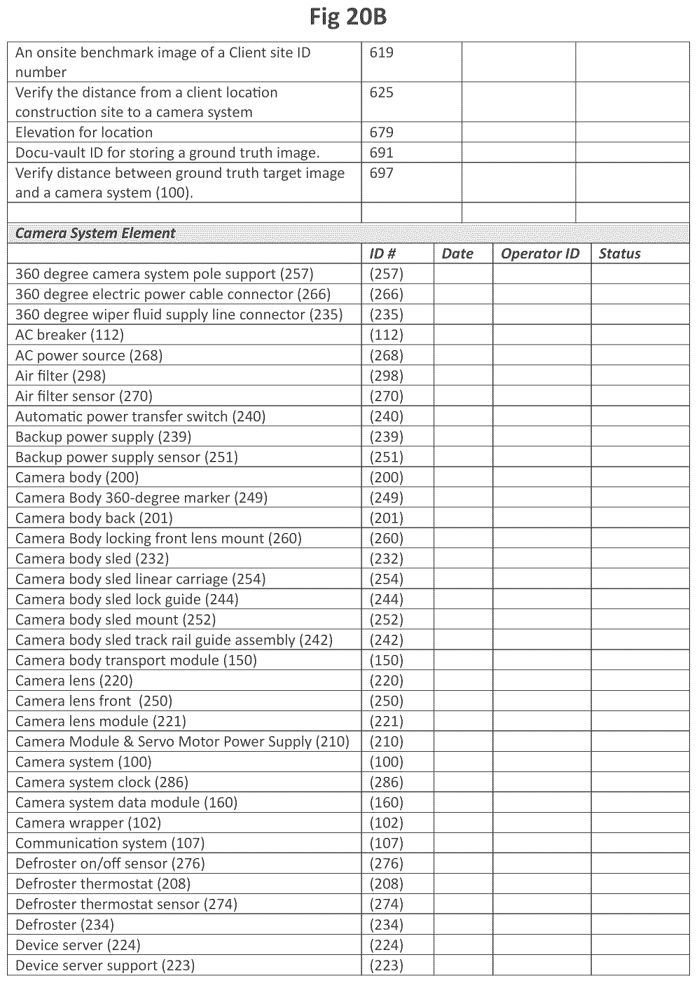

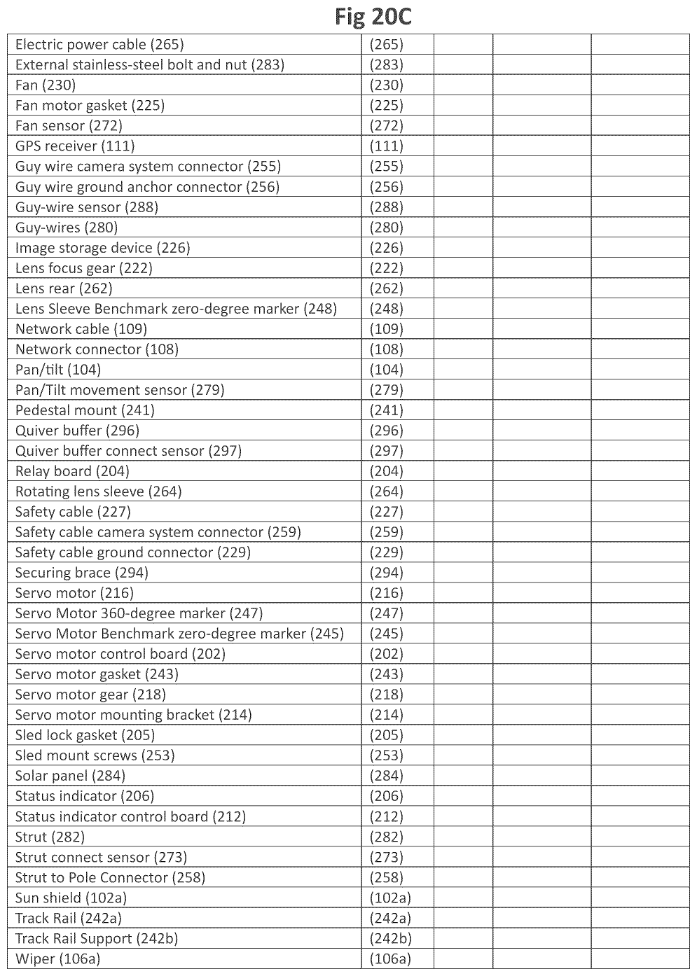

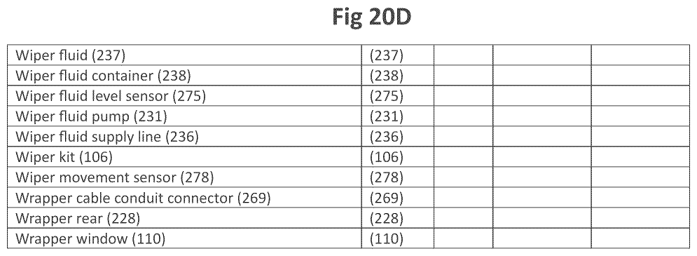

(593) An onsite maintenance operator updates a Camera System Log (302) with an operational status for camera system elements included in but not limited to being included in FIG. 20 Scheduled Maintenance Procedure Guide and System Readiness Checklist (113).

(595) An onsite maintenance operator instructs a device server (224), using a communication system (107) to transmit a Camera System Log (302) to a remote operator.

(599) An onsite maintenance operator ends diagnostic testing.

### Process 5: Camera System Focus Process

As described in this application, the term ‘focus’ is not meant to be only a mechanical operation of the Camera Module. The term ‘focus’ is meant to be a functional description of Camera Module mechanical operations, Camera Module automatic operations, and EarthCam operating procedures. In this application the term ‘focus’ shall include, but not limited to, the depth of field, the pixel size of the target object within the image, the clarity of the image in its entirety and the resolution of the image. The resolution of the image includes, but is not limited to, the sharpness of the target object within the image and the number of pixels in the target object within the image. The ‘focus’ function, as defined in this application, produces an image and target object image clarity and resolution which is verifiably consistent with a previous image and target object image and verifiably consistent with a next image and target object image.

An EarthCam Camera System Focus Process and instruction set, includes but is not limited to including four processes. The first process is a Laboratory initial setup focus process as described in FIG. 21A-21B. The second process is an Initial field setup focus process as described in FIG. 22A-22B. The third process is a Camera mission change focus process as describes in FIG. 23A-23B. The fourth process is a Maintenance and repair refocus process as described in FIG. 24.)

### The First Camera System Focus and Instruction Set: Laboratory Initial Setup Focus Process

(841) The first process of an EarthCam Camera System Focus Process and instruction set is a Laboratory Initial Setup Focus Process as described in FIG. 21A-21B and beginning at figure number 841.

(843) An operator uses an EarthCam Resolution and Focus Device to estimate the size of a ground truth target object and an image in its entirety.

(845) An operator selects an object on an EarthCam Resolution and Focus Device to use as the target object in the image.

(846) An operator remotely operates the camera. An operator instructs a device server (224) to perform a focus operation based on a set of focus specification instructions. Using a communication system (100), An operator sends instructions to a device server (244) for a lens focus gear (222) to rotate a number of degrees clockwise or counterclockwise. An operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneous moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

(847) Using a communication system (100), an operator sends instructions to a device server, (244) located on a camera system (100), to capture a benchmark image using a focus specification instruction set. (100). A device server (224) instructs a camera body (200) module to capture a benchmark image. A device server (224) instructs a camera body (200) module to store a benchmark image on an image storage device (226). A device server identifies the image as a benchmark image. A device server identifies a benchmark image with a unique identification number. An operator instructs a device server (224) how to uniquely identify an image with an image file identification number. A benchmark image file identification number incorporates a numeric chronological feature, and a multi-level and hierarchical sequence numbering feature.

An operator sends instructions to a device server, to instruct a camera body (200) module to store a benchmark image on an image storage device (226). An operator identifies remote docu-vault for storing a benchmark image. An operator updates Client Request Form (601) with the docu-vault identification information and the URL. An operator instructs the device server (224) with the identification information and the URL to store a benchmark image. An operator instructs a device server (224) to use a communication system (107) to transmit a benchmark image to a docu-vault.

(848) An operator manually operates the camera. An operator rotates a lens focus gear (222) a number of degrees clockwise or counterclockwise. As a gear ring (222) rotates, a lens sleeve (264) causes the lens rear (262) to expand and contract, causing a camera body (200) to move forward and away from a wrapper window (110) and simultaneous move forward or away from a camera lens front (250).

As a camera body (200) moves forward or away from a wrapper window (100) and a stationary camera lens front (250), vibration to the camera body (200), associated with a camera body (200) moving, is absorbed by a vibration absorbing camera body support (150).

An image is focused by a camera body (200) being moved forward or away from a wrapper window (110) and simultaneous being moved forward or away from a stationary camera lens front (250).

(849) Using a communication system (100), an operator sends instructions to a device server, (244) located on a camera system (100), to capture a benchmark image using a focus specification instruction set. (100). A device server (224) instructs a camera body (200) module to capture a benchmark image. A device server (224) instructs a camera body (200) module to store a benchmark image on an image storage device (226). A device server identifies the image as a benchmark image. A device server identifies a benchmark image with a unique identification number. An operator instructs a device server (224) how to uniquely identify an image with an image file identification number. A benchmark image file identification number incorporates a numeric chronological feature, and a multi-level and hierarchical sequence numbering feature.

An operator sends instructions to a device server (224), to instruct a camera body (200) module to store a benchmark image on an image storage device (226). An operator identifies remote docu-vault for storing a benchmark image. An operator updates Client Request Form (601) with the docu-vault identification information and the URL. An operator instructs the device server (224) with the identification information and the URL to store a benchmark image. An operator instructs a device server (224) to use a communication system (107) to transmit a benchmark image to a docu-vault.

(851) An operator accesses a Docu-Vault. An operator accesses a benchmark image. An operator uses an EarthCam proprietary instruction set to identify a target object in an image and the bounding box of a target image. An operator uses an EarthCam proprietary iterative image height and iterative image width determination model to determine a number of pixels in a target object in a benchmark image height and width.

An operator reviews the characteristics of a target object in a benchmark image and determines if a target object in a benchmark image is adequate. If a target object in a benchmark image is adequate an operator updates a Client Request Form (601) with the benchmark identification information.

An operator gathers information about the characteristics of a benchmark image. An operator establishes a Benchmark Image Rubric, rules, and algorithm for determining if a benchmark image is acceptable.

An operator updates a Client Request Form (601) with a Benchmark Image Rubric Score. The rubric may be metric, digital, subjective or any combination. The rubric, rules, algorithm provide the operator with a method for grading the outcome of a process to determine if a benchmark image is acceptable and determining if a Benchmark Image Rubric Score is acceptable.

An operator uses a value of 10, but not limited to 10 to indicate a score which is acceptable. An operator uses a value of 1, but not limited to 1 to indicate a score which is not adequate.

An operator updates a Client Request Form (601) with a grade for the outcome of determining if a remote benchmark image is acceptable.

If a benchmark image is not acceptable, an operator acquires a new onsite benchmark image.

(855) An operator determines the number of pixels in a target object of a remote captured benchmark image and a manual captured benchmark image. An operator retrieves a remote captured benchmark image and a manual captured benchmark image from a docu-vault associated with a for a camera system (100). An operator reviews the pixel characteristics of a remote captured benchmark image and a manual captured benchmark image retrieved from a docu-vault. An operator reviews the pixel characteristics of a target object in a remote captured benchmark image and a target object in a manual captured benchmark image. An operator uses EarthCam proprietary instructions sets and procedures to compare the pixel characteristics of a target object in a remote captured benchmark image and a target object in a manual captured benchmark image. An operator determines if the pixel characteristics of a target object in a remote captured benchmark image and a target object in a manual captured benchmark image are adequate.

An operator gathers information about determining if the pixel characteristics of a target object in a remote captured benchmark image and a target object in a manual captured benchmark image are adequate.

To determine if an image is adequate, an operator creates a Filter and Filter Specifications including, but not limited to the following and not using the following, Mean Filter (noise reduction using mean of neighborhood), Median Filter (noise reduction using median of neighborhood), blurred filter, Gaussian Smoothing (noise reduction using convolution with a Gaussian smoothing kernel), Conservative Smoothing (noise reduction using maximum and minimum of neighborhood), Crimmins Speckle Removal (more complex noise reduction by operator), Frequency Filters (including, but limited to high and low pass image filters), Laplacian/Laplacian of Gaussian Filter (edge detection filter), Unsharp Filter (edge enhancement filter), Simple Adaptive Median filter, Decision Based Median filter, Decision Based Untrimmed Median filter.

To determine if an image is adequate, an operator reviews the images in the Accepted EC-F Docu-Vault for issues including, but not limited to, quality, resolution, environmental issues, and appropriateness, image not useful because of camera malfunctions, incorrect camera focal point, insufficient pixels per inch, insufficient dots per inch, and an inappropriate change in resolution. An operator checks for camera manufacturer camera model, camera orientation (rotation), camera firmware, date and time, YCbCr positioning, Compression, X resolution, Y resolution, Resolution unit, Exposure time, F-number, exposure program, Exif version, date and time (original), date and time (digitized), Components configuration, Compressed bits per pixel, Exposure bias, Max. aperture value, Metering mode, Flash, Focal length, Maker Note, FlashPix version, Color space, Pixel X dimension, Pixel Y dimension, File source, Interoperability index, and Interoperability version.

To determine if an image is adequate, an operator reviews the image resizing criteria including, but not limited to, the number of pixels high, pixels wide and the number of color channels.

An operator establishes a Benchmark Image Target Object Rubric, rules, and algorithm for determining if the pixel characteristics of a target object in a remote captured benchmark image and a target object in a manual captured benchmark image are adequate. An operator updates a Camera System Log (302) with a Benchmark Image Target Object Rubric Score.

The rubric may be metric, digital, subjective or any combination. The rubric, rules, algorithm provide the operator with a method for grading the outcome of a process to determine if the pixel characteristics of a target object in a remote captured benchmark image and a target object in a manual captured benchmark image are adequate and determining if a Benchmark Image Target Object Rubric Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of determining if the pixel characteristics of a target object in a remote captured benchmark image and a target object in a manual captured benchmark image are adequate.

An operator updates a Camera System Log (302) with a grade for the outcome of determining if the pixel characteristics of a target object in a remote captured benchmark image and a target object in a manual captured benchmark image are adequate.

(859) An operator determines if the number of pixels are adequate in target object in a benchmark image for a camera system (100). A remote operator retrieves images from a docu-vault associated with a camera system (100). A remote operator reviews the number of pixels in the target object of an image retrieved from a docu-vault. A remote operator uses EarthCam proprietary instructions sets and procedures to examine the number of pixels in the target object of an image retrieved from a docu-vault. A remote operator determines if the number of pixels in the target object of an image retrieved from a docu-vault is adequate.

A remote operator gathers information about the number of pixels in the target object of an image retrieved from a docu-vault.

To determine if an image is adequate, an operator creates a Filter and Filter Specifications including, but not limited to the following and not using the following, Mean Filter (noise reduction using mean of neighborhood), Median Filter (noise reduction using median of neighborhood), blurred filter, Gaussian Smoothing (noise reduction using convolution with a Gaussian smoothing kernel), Conservative Smoothing (noise reduction using maximum and minimum of neighborhood), Crimmins Speckle Removal (more complex noise reduction by operator), Frequency Filters (including, but limited to high and low pass image filters), Laplacian/Laplacian of Gaussian Filter (edge detection filter), Unsharp Filter (edge enhancement filter), Simple Adaptive Median filter, Decision Based Median filter, Decision Based Untrimmed Median filter.

To determine if an image is adequate, an operator reviews the images in the Accepted EC-F Docu-Vault for issues including, but not limited to, quality, resolution, environmental issues, and appropriateness, image not useful because of camera malfunctions, incorrect camera focal point, insufficient pixels per inch, insufficient dots per inch, and an inappropriate change in resolution. An operator checks for camera manufacturer camera model, camera orientation (rotation), camera firmware, date and time, YCbCr positioning, Compression, X resolution, Y resolution, Resolution unit, Exposure time, F-number, exposure program, Exif version, date and time (original), date and time (digitized), Components configuration, Compressed bits per pixel, Exposure bias, Max. aperture value, Metering mode, Flash, Focal length, Maker Note, FlashPix version, Color space, Pixel X dimension, Pixel Y dimension, File source, Interoperability index, and Interoperability version.

To determine if an image is adequate, an operator reviews the image resizing criteria including, but not limited to, the number of pixels high, pixels wide and the number of color channels.

An operator establishes a Target Object Pixels Rubric, rules, and algorithm for determining if the number of pixels in the target object of an image retrieved from a docu-vault is adequate. An operator updates a Client Request Form (601) with a Target Object Pixels Rubric Score.

The rubric may be metric, digital, subjective or any combination. The rubric, rules, algorithm provide the operator with a method for grading the outcome of a process to determine if the number of pixels in the target object of an image retrieved from a docu-vault is adequate and determining if a Target Object Pixels Rubric Score is acceptable.

An operator uses a value of 10, but not limited to 10 to indicate a score which is adequate. An operator uses a value of 1, but not limited to 1 to indicate a score which is not adequate. An operator updates a Client Request Form (601) with a grade for the outcome of a process to determine if the number of pixels in the target object of an image retrieved from a docu-vault is adequate.

(865) An operator determines the position of a Servo Motor Benchmark zero-degree marker (245) relative to a Servo Motor 360-degree marker (247) for a camera system (100). An operator accesses the position of a Lens Sleeve Benchmark zero-degree marker (248) relative to a Camera Body 360-degree marker (249) for a camera system (100).

An operator updates a Client Request Form (601) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An operator updates a Camera System Log (302) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An operator uses an algorithm to determine the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264). As a rotating lens sleeve (264) rotates clockwise or counterclockwise a lens rear (262) expands and contracts moving away from or moving toward a camera lens front (250). As a lens rear (262) expands and contracts a camera body (200), connected to a camera lens (220), moves away from, or moves towards a camera lens front (250) and focuses on a target object. Determining the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264) allows an operator to remotely focus a camera system (100) on an outlying target object in an image.

(869) An operator establishes an image as benchmark image for a camera system (100). A device server (224) instructs a camera body (200) module to capture a benchmark image. A device server (224) instructs a camera body (200) module to store a benchmark image on an image storage device (226). A device server identifies the image as a benchmark image.

(871) An operator establishes an image as benchmark image for a camera system (100). An operator instructs a device server (224) how to uniquely identify an image with an image file identification number. A benchmark image file identification number incorporates a numeric chronological feature, and a multi-level and hierarchical sequence numbering feature.

(873) An operator updates a Client Request Form (601) with the specifications for a benchmark image for camera system (100). An operator updates a Camera System Log (302) with the specifications for a benchmark image for camera system (100).

(875) An operator notes the position of a Servo Motor Benchmark zero-degree marker (245) relative to a Servo Motor 360-degree marker (247). An operator updates a Client Request Form (601) with the degree position of a Servo Motor Benchmark zero-degree marker (245) relative to a Servo Motor 360-degree marker (247). An operator updates a Camera System Log (302) with the degree position of a Servo Motor Benchmark zero-degree marker (245) relative to a Servo Motor 360-degree marker (247).

The Second Camera System Focus and Instruction Set: Initial Field Setup Focus Process

(885) The second process of an EarthCam Camera System Focus Process and instruction set is a Laboratory Initial Setup Focus Process as described in FIG. 22A-22B and beginning at reference numeral 885.

(886) An onsite operator notifies a remote operator of the date and time arrival at a Camera System (100) located at a Client Site.

(887) A remote operator reviews a Client Request Form (601) and identifies a docu-vault for associated with camera system (100). A remote operator retrieves a benchmark image, using a unique benchmark image file identification number, from a docu-vault associated with camera system (100).

(889) An onsite operator identifies a ground truth object at the Client site associated with camera system (100). An onsite operator communicates a description of a ground truth target object to a remote operator.

(891) An onsite operator remotely operates the camera. An onsite operator instructs a device server (224) to perform a focus operation based on a set of focus specification instructions. Using a communication system (100), an onsite operator sends instructions to a device server (244) for a lens focus gear (222) to rotate a number of degrees clockwise or counterclockwise. An onsite operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneously moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

Using a communication system (100), an onsite operator sends instructions to a device server, (244) located on a camera system (100), to capture a benchmark image using a focus specification instruction set. (100). A device server (224) instructs a camera body (200) module to capture a benchmark image include but not limited to including a benchmark ground truth target object. A device server (224) instructs a camera body (200) module to store a benchmark image on an image storage device (226). A device server identifies the image as a benchmark image. A device server identifies a benchmark image with a unique identification number. An onsite operator instructs a device server (224) how to uniquely identify an image with an image file identification number. A benchmark image file identification number incorporates a numeric chronological feature, and a multi-level and hierarchical sequence numbering feature.

An onsite operator sends instructions to a device server, to instruct a camera body (200) to store a benchmark image on an image storage device (226). An onsite operator identifies a remote docu-vault for storing a benchmark image. An onsite operator updates Client Request Form (601) with the docu-vault identification information and the URL. An onsite operator instructs the device server (224) with the identification information and the URL to store a benchmark image. An onsite operator instructs a device server (224) to use a communication system (107) to transmit a benchmark image to a docu-vault.

(895) An operator determines the number of pixels in a target object of an onsite benchmark image and a benchmark image. An operator reviews the pixel characteristics of a target object of an onsite benchmark image and a target object in a benchmark image retrieved from a docu-vault. An operator reviews the pixel characteristics of a target object in an onsite benchmark image and a target object in a benchmark image. An operator uses EarthCam proprietary instructions sets and procedures to compare the pixel characteristics of a target object in an onsite benchmark image and a target object in a benchmark image. An operator determines if the pixel characteristics of a target object in an onsite benchmark image and a target object in a benchmark image are similar and adequate.

(897) An operator gathers information about determining if the pixel characteristics of a target object in an onsite benchmark image and a target object in a benchmark image are similar and adequate.

To determine if an image is adequate, an operator creates a Filter and Filter Specifications including, but not limited to the following and not using the following, Mean Filter (noise reduction using mean of neighborhood), Median Filter (noise reduction using median of neighborhood), blurred filter, Gaussian Smoothing (noise reduction using convolution with a Gaussian smoothing kernel), Conservative Smoothing (noise reduction using maximum and minimum of neighborhood), Crimmins Speckle Removal (more complex noise reduction by operator), Frequency Filters (including, but limited to high and low pass image filters), Laplacian/Laplacian of Gaussian Filter (edge detection filter), Unsharp Filter (edge enhancement filter), Simple Adaptive Median filter, Decision Based Median filter, Decision Based Untrimmed Median filter.

To determine if an image is adequate, an operator reviews the images in the Accepted EC-F Docu-Vault for issues including, but not limited to, quality, resolution, environmental issues, and appropriateness, image not useful because of camera malfunctions, incorrect camera focal point, insufficient pixels per inch, insufficient dots per inch, and an inappropriate change in resolution. An operator checks for camera manufacturer camera model, camera orientation (rotation), camera firmware, date and time, YCbCr positioning, Compression, X resolution, Y resolution, Resolution unit, Exposure time, F-number, exposure program, Exif version, date and time (original), date and time (digitized), Components configuration, Compressed bits per pixel, Exposure bias, Max. aperture value, Metering mode, Flash, Focal length, Maker Note, FlashPix version, Color space, Pixel X dimension, Pixel Y dimension, File source, Interoperability index, and Interoperability version.

To determine if an image is adequate, an operator reviews the image resizing criteria including, but not limited to, the number of pixels high, pixels wide and the number of color channels.

An operator establishes a Benchmark Image Target Object Rubric, rules, and algorithm for determining if the pixel characteristics of a target object in an onsite benchmark image and a target object in a benchmark image are similar and adequate. An operator updates a Camera System Log (302) with a Benchmark Image Target Object Rubric Score.

The rubric may be metric, digital, subjective or any combination. The rubric, rules, algorithm provide the operator with a method for grading the outcome of a process to determine if the pixel characteristics of a target object in an onsite benchmark image and a target object in a benchmark image are similar and adequate, and determining if a Benchmark Image Target Object Rubric Score is acceptable.

An operator uses a value of 10, but not limited to 10 to indicate a score which is adequate. An operator uses a value of 1, but not limited to 1 to indicate a score which is not adequate.

An operator updates a Client Request Form (601) with a grade for the outcome of determining if the pixel characteristics of a target object in an onsite benchmark image and a target object in a benchmark image are similar and adequate.

An operator updates a Camera System Log (302) with a grade for the outcome of determining if the pixel characteristics of a target object in an onsite benchmark image and a target object in a benchmark image are similar and adequate.

(901) An onsite operator determines the position of a Servo Motor Benchmark zero-degree marker (245) relative to a Servo Motor 360-degree marker (247) for a camera system (100). An onsite operator accesses the position of a Lens Sleeve Benchmark zero-degree marker (248) relative to a Camera Body 360-degree marker (249) for a camera system (100).

An onsite operator updates a Client Request Form (601) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator updates a Camera System Log (302) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator uses an algorithm to determine the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264). As a rotating lens sleeve (264) rotates clockwise or counterclockwise a lens rear (262) expands and contracts moving away from or moving toward a camera lens front (250). As a lens rear (262) expands and contracts a camera body (200), connected to a camera lens (220), moves away from, or moves towards a camera lens front (250) and focuses on a target object. Determining the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264) allows an operator to remotely focus a camera system (100) on an outlying target object in an image.

(902) A remote operator instructs a device server (224), of camera system (100), to perform a focus operation based on a set of focus specification instructions. Using a communication system (100), a remote operator sends instructions to a device server (244) for a lens focus gear (222) to rotate a number of degrees clockwise or counterclockwise. A remote operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneous moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

(903) A remote operator sends instructions to a device server, (244) located on a camera system (100), to capture an onsite benchmark image using a focus specification. (100). A device server (224) instructs a camera body (200) module to capture an onsite benchmark image. A device server (224) instructs a camera body (200) module to store an onsite benchmark image on an image storage device (226). A device server identifies the image as an onsite benchmark image. A device server identifies an onsite benchmark image with a unique identification number. A remote operator instructs a device server (224) how to uniquely identify an image with an image file identification number. An onsite benchmark image file identification number incorporates a numeric chronological feature, and a multi-level and hierarchical sequence numbering feature.

A remote operator identifies remote docu-vault for storing an onsite benchmark image. A remote operator updates Client Request Form (601) with the docu-vault identification information and the URL.

A remote operator instructs the device server (224) with the identification information and the URL to store an onsite benchmark image.

A remote operator instructs a device server (224) to use a communication system (107) to transmit an onsite benchmark image to a docu-vault.

(907) A remote operator establishes an image as an onsite benchmark image for a camera system (100). An operator instructs a device server (224) how to uniquely identify an image with an image file identification number. An onsite benchmark image file identification number incorporates a numeric chronological feature, and a multi-level and hierarchical sequence numbering feature.

(917) A remote operator updates a Client Request Form (601) with the specifications for a onsite benchmark image for camera system (100). An operator updates a Camera System Log (302) with the specifications for an onsite benchmark image for camera system (100).

(919) A remote operator notes the position of a Servo Motor Benchmark zero-degree marker (245) relative to a Servo Motor 360-degree marker (247). A remote operator updates a Client Request Form (601) with the degree position of a Servo Motor Benchmark zero-degree marker (245) relative to a Servo Motor 360-degree marker (247). A remote operator updates a Camera System Log (302) with the degree position of a Servo Motor Benchmark zero-degree marker (245) relative to a Servo Motor 360-degree marker (247).

### The Third Camera System Focus and Instruction Set: Camera Mission Change Focus Process

(923) The third process of an EarthCam Camera System Focus Process and instruction set is a Camera Mission Change Focus Process as described in FIG. 23A-23B and beginning at process number 923.

(924) A remote operator receives a Client Request Form (601) for camera system (100). The Client Request Form includes a requirement to change the focus for camera system (100). For example, the work at a client location, like a section of the Panama Canal, progresses. Hypothetically, the focus for the camera system (100) was at one part of the client location and after several months, the activity moves to another part of the client location which is 2,500 feet away.

(925) A remote operator schedules an onsite operator to use a camera system (100), at the Client site, to capture an image of an outlying target object.

(927) An onsite operator notifies a remote operator of the date and time arrival at a Camera System (100) located at a Client Site.

(929) A remote operator reviews a Client Request Form (601) and identifies a docu-vault for associated with camera system (100). A remote operator retrieves a benchmark image, using a unique benchmark image file identification number, from a docu-vault associated with camera system (100).

(931) An onsite operator identifies a ground truth object at the Client site associated with camera system (100). An onsite operator communicates a description of a ground truth target object to a remote operator.

(932) An onsite operator remotely operates the camera. An onsite operator instructs a device server (224) to perform a focus operation based on a set of focus specification instructions. Using a communication system (100), An onsite operator sends instructions to a device server (244) for a lens focus gear (222) to rotate a number of degrees clockwise or counterclockwise. An onsite operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneous moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

Using a communication system (100), an onsite operator sends instructions to a device server, (244) located on a camera system (100), to capture a benchmark image using a focus specification instruction set. (100). A device server (224) instructs a camera body (200) module to capture a benchmark image include but not limited to including a benchmark ground truth target object. A device server (224) instructs a camera body (200) module to store a benchmark image on an image storage device (226). A device server identifies the image as a benchmark image. A device server identifies a benchmark image with a unique identification number. An onsite operator instructs a device server (224) how to uniquely identify an image with an image file identification number. A benchmark image file identification number incorporates a numeric chronological feature, and a multi-level and hierarchical sequence numbering feature.

An onsite operator sends instructions to a device server, to instruct a camera body (200) to store a benchmark image on an image storage device (226). An onsite operator identifies a remote docu-vault for storing a benchmark image. An onsite operator updates Client Request Form (601) with the docu-vault identification information and the URL. An onsite operator instructs the device server (224) with the identification information and the URL to store a benchmark image. An onsite operator instructs a device server (224) to use a communication system (107) to transmit a benchmark image to a docu-vault.

(933) A remote operator determines the number of pixels in a target object of an onsite benchmark image and a benchmark image. A remote operator reviews the pixel characteristics of a target object of an onsite benchmark image and a target object in a benchmark image retrieved from a docu-vault. A remote operator reviews the pixel characteristics of a target object in an onsite benchmark image and a target object in a benchmark image. A remote operator uses EarthCam proprietary instructions sets and procedures to compare the pixel characteristics of a target object in an onsite benchmark image and a target object in a benchmark image. A remote operator determines if the pixel characteristics of a target object in an onsite benchmark image and a target object in a benchmark image are similar and adequate.

(935) A remote operator gathers information about determining if the pixel characteristics of a target object in an onsite benchmark image and a target object in a benchmark image are similar and adequate.

To determine if an image is adequate, an operator creates a Filter and Filter Specifications including, but not limited to the following and not using the following, Mean Filter (noise reduction using mean of neighborhood), Median Filter (noise reduction using median of neighborhood), blurred filter, Gaussian Smoothing (noise reduction using convolution with a Gaussian smoothing kernel), Conservative Smoothing (noise reduction using maximum and minimum of neighborhood), Crimmins Speckle Removal (more complex noise reduction by operator), Frequency Filters (including, but limited to high and low pass image filters), Laplacian/Laplacian of Gaussian Filter (edge detection filter), Unsharp Filter (edge enhancement filter), Simple Adaptive Median filter, Decision Based Median filter, Decision Based Untrimmed Median filter.

To determine if an image is adequate, an operator reviews the images in the Accepted EC-F Docu-Vault for issues including, but not limited to, quality, resolution, environmental issues, and appropriateness, image not useful because of camera malfunctions, incorrect camera focal point, insufficient pixels per inch, insufficient dots per inch, and an inappropriate change in resolution. An operator checks for camera manufacturer camera model, camera orientation (rotation), camera firmware, date and time, YCbCr positioning, Compression, X resolution, Y resolution, Resolution unit, Exposure time, F-number, exposure program, Exif version, date and time (original), date and time (digitized), Components configuration, Compressed bits per pixel, Exposure bias, Max. aperture value, Metering mode, Flash, Focal length, Maker Note, FlashPix version, Color space, Pixel X dimension, Pixel Y dimension, File source, Interoperability index, and Interoperability version.

To determine if an image is adequate, an operator reviews the image resizing criteria including, but not limited to, the number of pixels high, pixels wide and the number of color channels.

A remote operator establishes a Benchmark Image Target Object Rubric, rules, and algorithm for determining if the pixel characteristics of a target object in an onsite benchmark image and a target object in a benchmark image are similar and adequate. A remote operator updates a Camera System Log (302) with a Benchmark Image Target Object Rubric Score.

The rubric may be metric, digital, subjective or any combination. The rubric, rules, algorithm provide the operator with a method for grading the outcome of a process to determine if the pixel characteristics of a target object in an onsite benchmark image and a target object in a benchmark image are similar and adequate, and determining if a Benchmark Image Target Object Rubric Score is acceptable.

A remote operator uses a value of 10, but not limited to 10 to indicate a score which is adequate. A remote operator uses a value of 1, but not limited to 1 to indicate a score which is not adequate.

A remote operator updates a Client Request Form (601) with a grade for the outcome of determining if the pixel characteristics of a target object in an onsite benchmark image and a target object in a benchmark image are similar and adequate.

A remote operator updates a Camera System Log (302) with a grade for the outcome of determining if the pixel characteristics of a target object in an onsite benchmark image and a target object in a benchmark image are similar and adequate.

(937) An onsite operator determines the position of a Servo Motor Benchmark zero-degree marker (245) relative to a Servo Motor 360-degree marker (247) for a camera system (100). An onsite operator accesses the position of a Lens Sleeve Benchmark zero-degree marker (248) relative to a Camera Body 360-degree marker (249) for a camera system (100).

An onsite operator updates a Client Request Form (601) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator updates a Camera System Log (302) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator uses an algorithm to determine the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264). As a rotating lens sleeve (264) rotates clockwise or counterclockwise a lens rear (262) expands and contracts moving away from or moving toward a camera lens front (250). As a lens rear (262) expands and contracts a camera body (200), connected to a camera lens (220), moves away from, or moves towards a camera lens front (250) and focuses on a target object. Determining the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264) allows an operator to remotely focus a camera system (100) on an outlying target object in an image.

(938) A remote operator instructs a device server (224), of camera system (100), to perform a focus operation based on a set of focus specification instructions. Using a communication system (100), a remote operator sends instructions to a device server (244) for a lens focus gear (222) to rotate a number of degrees clockwise or counterclockwise. A remote operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneous moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

(939) A remote operator sends instructions to a device server, (244) located on a camera system (100), to capture an onsite benchmark image using a focus specification. (100). A device server (224) instructs a camera body (200) module to capture an onsite benchmark image. A device server (224) instructs a camera body (200) module to store an onsite benchmark image on an image storage device (226). A device server identifies the image as an onsite benchmark image. A device server identifies an onsite benchmark image with a unique identification number. A remote operator instructs a device server (224) how to uniquely identify an image with an image file identification number. An onsite benchmark image file identification number incorporates a numeric chronological feature, and a multi-level and hierarchical sequence numbering feature.

A remote operator identifies remote docu-vault for storing an onsite benchmark image. A remote operator updates Client Request Form (601) with the docu-vault identification information and the URL.

A remote operator instructs the device server (224) with the identification information and the URL to store an onsite benchmark image.

A remote operator instructs a device server (224) to use a communication system (107) to transmit an onsite benchmark image to a docu-vault.

(943) A remote operator establishes an image as an onsite benchmark image for a camera system (100). An operator instructs a device server (224) how to uniquely identify an image with an image file identification number. An onsite benchmark image file identification number incorporates a numeric chronological feature, and a multi-level and hierarchical sequence numbering feature.

(945) A remote operator updates a Client Request Form (601) with the specifications for a onsite benchmark image for camera system (100). An operator updates a Camera System Log (302) with the specifications for an onsite benchmark image for camera system (100).

(947) A remote operator notes the position of a Servo Motor Benchmark zero-degree marker (245) relative to a Servo Motor 360-degree marker (247). A remote operator updates a Client Request Form (601) with the degree position of a Servo Motor Benchmark zero-degree marker (245) relative to a Servo Motor 360-degree marker (247). A remote operator updates a Camera System Log (302) with the degree position of a Servo Motor Benchmark zero-degree marker (245) relative to a Servo Motor 360-degree marker (247).

### The Fourth Camera System Focus and Instruction Set: Camera System Maintenance and Repair Refocus Process

(957) The fourth process of an EarthCam Camera System Focus Process and instruction set is a Camera System Maintenance and Repair Refocus Process as described in FIG. 24 and beginning at process number 957. A Camera System Maintenance and Repair Refocus Process begins after a camera system (100) experiences but is not limited to experiencing, a mechanical element repair or replacement. A Camera System Maintenance and Repair Refocus Process is not used when a camera system (100) is relocated.

(959) A remote operator instructs a device server (224) located on a camera system (100) to transmit an onsite field benchmark image to a Remote Operator. A device server (224) retrieves a field benchmark image from an image storage device (226). A device server (224) using a communication system (107) transmits a field benchmark image to a remote operator. A remote operator receives a field benchmark image.

(961) A remote operator determines the number of pixels in a target object of an onsite benchmark image and a benchmark image. A remote operator retrieves an onsite benchmark image and a benchmark image from a docu-vault associated with a for a camera system (100). A remote operator reviews the pixel characteristics of an onsite benchmark image and a benchmark image retrieved from a docu-vault. A remote operator reviews the pixel characteristics of a target object in an onsite benchmark image and a target object in a benchmark image. A remote operator uses EarthCam proprietary instructions sets and procedures to compare the pixel characteristics of a target object in an onsite benchmark image and a target object in a benchmark image. A remote operator determines if the pixel characteristics of a target object in an onsite benchmark image and a target object in a benchmark image are adequate.

A remote operator gathers information about determining if the pixel characteristics of a target object in an onsite benchmark image and a target object in a benchmark image are similar and adequate.

A remote operator establishes a Benchmark Image Target Object Rubric, rules, and algorithm for determining if the pixel characteristics of a target object in an onsite benchmark image and a target object in a benchmark image are similar and adequate. A remote operator updates a Camera System Log (302) with a Benchmark Image Target Object Rubric Score.

The rubric may be metric, digital, subjective or any combination. The rubric, rules, algorithm provide the operator with a method for grading the outcome of a process to determine if the pixel characteristics of a target object in an onsite benchmark image and a target object in a benchmark image are similar and adequate and determining if a Benchmark Image Target Object Rubric Score is acceptable.

A remote operator uses a value of 10, but not limited to 10 to indicate a score which is adequate. A remote operator uses a value of 1, but not limited to 1 to indicate a score which is not adequate.

A remote operator updates a Client Request Form (601) with a grade for the outcome of determining if the pixel characteristics of a target object in an onsite benchmark image and a target object in a benchmark image are similar and adequate.

A remote operator updates a Camera System Log (302) with a grade for the outcome of determining if the pixel characteristics of a target object in an onsite benchmark image and a target object in a benchmark image are similar and adequate.

(963) A remote operator determines if the number of pixels are adequate in target object in a benchmark image for a camera system (100). A remote operator retrieves images from a docu-vault associated with a camera system (100). A remote operator reviews the number of pixels in the target object of an image retrieved from a docu-vault. A remote operator uses EarthCam proprietary instructions sets and procedures to examine the number of pixels in the target object of an image retrieved from a docu-vault. A remote operator determines if the number of pixels in the target object of an image retrieved from a docu-vault is adequate.

A remote operator gathers information about the number of pixels in the target object of an image retrieved from a docu-vault.

A remote operator establishes a Target Object Pixels Rubric, rules, and algorithm for determining if the number of pixels in the target object of an image retrieved from a docu-vault is adequate. A remote operator updates a Client Request Form (601) with a Target Object Pixels Rubric Score.

The rubric may be metric, digital, subjective or any combination. The rubric, rules, algorithm provide the operator with a method for grading the outcome of a process to determine if the number of pixels in the target object of an image retrieved from a docu-vault is adequate and determining if a Target Object Pixels Rubric Score is acceptable.

A remote operator uses a value of 10, but not limited to 10 to indicate a score which is adequate. A remote operator uses a value of 1, but not limited to 1 to indicate a score which is not adequate.

A remote operator updates a Client Request Form (601) with a grade for the outcome of a process to determine if the number of pixels in the target object of an image retrieved from a docu-vault is adequate.

(966) An onsite operator determines the position of a Servo Motor Benchmark zero-degree marker (245) relative to a Servo Motor 360-degree marker (247) for a camera system (100). An onsite operator accesses the position of a Lens Sleeve Benchmark zero-degree marker (248) relative to a Camera Body 360-degree marker (249) for a camera system (100).

An onsite operator updates a Client Request Form (601) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator updates a Camera System Log (302) with a number of degrees for a Servo Motor Benchmark zero-degree marker (245) relative to a Servo Motor 360-degree marker (247) and for a number of degrees for a Lens Sleeve Benchmark zero-degree marker (248) relative to a Camera Body 360-degree marker (249) for a camera system (100).

An onsite operator uses an algorithm to determine the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264). As a rotating lens sleeve (264) rotates clockwise or counterclockwise a lens rear (262) expands and contracts moving away from or moving toward a camera lens front (250). As a lens rear (262) expands and contracts a camera body (200), connected to a camera lens (220), moves away from, or moves towards a camera lens front (250) and focuses on a target object. Determining the amount of time to close the relays on the relay board (204) to power the servo motor (216) to rotate the servo motor to achieve the desired number of degrees rotation clockwise or counterclockwise for a lens focus gear (222) to rotate a rotating lens sleeve (264) allows an onsite operator to remotely focus a camera system (100) on an outlying target object in an image.

(967) A remote operator instructs a device server (224), of camera system (100), to perform a focus operation based on a set of focus specification instructions. Using a communication system (100), a remote operator sends instructions to a device server (244) for a lens focus gear (222) to rotate a number of degrees clockwise or counterclockwise. A remote operator uses an algorithm to determine the amount of time to keep a servo motor relay, located on a relay board (204), closed to move the rotating lens sleeve (264) to the required degree location. As a gear ring (222) rotates a lens sleeve (264) causing the lens rear (262) to expand and contract, a camera body (200) is moved forward and away from a wrapper window (110) and simultaneous moves forward and away from a camera lens front (250).

As a camera body (200) is moved forward and away from a wrapper window (100) by a stationary camera lens (220), vibration to the camera body (200), associated with a camera body (200) moving, is absorbed by the vibration absorbing camera body support (150).

An image is focused by a camera body (200) being moved forward and away from a wrapper window (110) and simultaneous being moved forward and away from a stationary camera lens front (250).

(971) A remote operator updates a Client Request Form (601) with a set of focus specification instructions for camera system (100). A remote operator updates a Camera System Log (302) with a set of focus specification instructions for camera system (100).

Certain pixel-based operations as described herein refer to comparing pixel characteristics of a first image or a target object within the first image, with pixel characteristics of a second image or a target object within the second image. In comparing these pixel characteristics, it is sometimes necessary to determine if the pixel characteristics are “similar.” As that term is used herein, an absolute identity between the pixel characteristics is not required, and some differences can be observed while still maintaining a “similar” condition. In fact, the degree of similarity required may be variable and dependent on the circumstances that required the comparison. In the context of evidentiary quality images associated with this invention, the similarity must be such that the first and second images or a target object in first and second images can be determined to encompass the same field of view or the same object, despite some de minimis pixel differences.

What is claimed is:

1. A method for setting up a camera system for recording images, the method comprising:
a. a remote operator retrieving a stored benchmark image from a docu-vault, the stored benchmark image including a stored target object;
b. an onsite operator identifying an onsite target object at the client site and communicating a description of the onsite target object to the remote operator;
c. executing a focus operation based on a predetermined camera system focus specification;
d. capturing an onsite image, including the onsite target object, using the predetermined focus specification;
e. determining pixel characteristics of the onsite target object in the onsite image and stored target object in the stored benchmark image;
f. using a rubric, the remote operator determining if the pixel characteristics of the onsite target object in the onsite image and the stored target object in the stored benchmark image are similar and adequate;
g. capturing an additional onsite image, including the onsite target object, using a different focus specification;
h. using one or more rubrics, the remote operator determining if the pixel characteristics of the onsite target object in the additional onsite image and the stored target object in the stored benchmark image are similar and adequate;
i. repeating steps g. and h. until the pixel characteristics of the onsite target object in a most recent additional onsite image and the stored target object in the stored benchmark image are similar and adequate, and designating a most recent rubric score as a final rubric score and a most recent additional onsite image as an updated benchmark image;
j. updating a record with an identifier for the updated benchmark image; and
k. storing the updated benchmark image.

2. The method of claim 1, wherein a step of retrieving is executed using an address of the stored benchmark image in the docu-vault, the address comprising a numeric chronological feature, and a multi-level and hierarchical sequence numbering feature.

3. The method of claim 1, wherein steps e. and f. are executed by the remote operator.

4. The method of claim 1, wherein steps c. and d. are executed by the onsite operator.

5. The method of claim 1, wherein the rubric is one or more of metric, digital, or subjective.

6. The method of claim 1, further comprising updating a client request form with a grade based on whether the pixel characteristics of the onsite target object in the onsite image and the pixel characteristics or the stored target object in the stored benchmark image are similar and adequate.

7. The method of claim 1, further comprising the onsite operator notifying the remote operator of a date and a time of arrival of the camera system at a client site prior to executing step a.

8. The method of claim 1, further comprising updating one or more of a client request form with an identification of the updated benchmark image, a camera system log with an identification of the updated benchmark image, the client request form with a focus specification for the updated benchmark image, and a camera system log with a focus specification for the updated benchmark image

9. The method of claim 1, wherein the focus specification comprises a position of a servo motor benchmark zero-degree marker relative to a servo motor 360-degree marker for the camera system.

10. The method of claim 1, wherein the focus specification relates to a number of degrees for a lens sleeve benchmark zero-degree marker relative to a camera body 360-degree marker.

11. The method of claim 9, using an algorithm to determine the amount of time to power a servo motor to rotate the servo motor a desired number of rotation degrees clockwise or counterclockwise to achieve a desired position of the servo motor benchmark zero-degree marker relative to the servo motor 360-degree marker.

12. The method of claim 1, wherein a step of storing comprises storing the updated benchmark image in a docu-vault and assigning a unique identifier to the updated benchmark mage.

13. The method of claim 1, wherein the pixel characteristics of a target object are determined based on a bounding box of a target object.

14. The method of claim 1, further comprising if an image includes a distorted or obscured object, a remote operator requesting that an onsite operator capture a ground truth image of the distorted or obscured object for use in correcting or replacing the distorted or obscured object in the image, thereby creating a replacement image and adding the replacement image to the docu-narrative.

15. The method of claim 1, further comprising, prior to step a.:
an operator conducts a laboratory focus setup process,
automatically focusing the camera system based on an initial focus specification;
automatically capturing an automatic image of a resolution and focus device;
selecting a selected target object in the automatic image;
manually focusing the camera;
manually capturing a manual image;
identifying the selected target object in the manual image;
determining whether pixel characteristics of the selected target object in the automatic image and pixel characteristics of the selected target object in the manual image are identical and adequate based on a predetermined rubric, rules or an algorithm;
if the pixel characteristics of the target object in the automatic image and the pixel characteristics of the target object in the manual image are identical and adequate, determining parameters of the focus elements;
identifying the automatic image or the manual image as a camera benchmark image; and
assigning a unique identifier to the camera benchmark image.

16. The method of claim 15, wherein if the pixel characteristics of the selected target object in the automatic image and pixel characteristics of the selected target object in the manual image are not identical and adequate based on the predetermined rubric, rules or an algorithm, repeating steps of manually focusing, manually capturing, and identifying the selected target object, until a result of a step of determining is affirmative.

17. The method of claim 15, wherein the predetermined rubric comprises one or more of metric, digital, and subjective characteristics that permit determining whether pixel characteristics of the selected target object in the automatic image and pixel characteristics of the selected target object in the manual image are identical and adequate.

18. The method of claim 15, wherein a step of automatically focusing comprises the operator sending instructions to the camera system for rotating a focus gear a number of degrees clockwise or counterclockwise.

19. The method of claim 18, wherein an amount of time to rotate the focus gear is based on an algorithm to determine an amount of time to activate a servo motor for rotating the focus gear the number of degrees clockwise or counterclockwise.

20. The method of claim 19, wherein vibrations caused by activation of the servo motor are damped by a vibration damping element proximate the servo motor.

21. The method of claim 15, further comprising storing the camera benchmark image in a docu-vault.

22. The method of claim 15, further comprising updating one or both of a client request form and a camera system log to indicate that the pixel characteristics of the target object in the automatic image and the target object in the manual image are adequate.

23. A method for changing a camera system focus, the camera system for recording images, the method comprising:
a. receiving a client request to change a camera system focus to acquire images at a different distance from the camera system;
b. retrieving a benchmark image from the docu-vault;
c. an onsite operator identifying a target object at the different distance;
d. the onsite operator capturing an onsite image of the target object using focus parameters;
e. using a rubric, a remote operator determining if pixel characteristics of the target object in the onsite image and a target object in the benchmark image are similar and adequate;
f. repeating steps d. and e. using different focus parameters until the pixel characteristics of the target object in a most recent onsite image and the target object in the benchmark image are similar and adequate according to a rubric score, then designating a most recent rubric score as a final rubric score, a most recent onsite image as an updated benchmark image, and a most recent focus parameters as final focus parameters;
g. updating a record with one or more of the final rubric score, the updated benchmark image, and the final focus parameters; and
h. storing the updated benchmark image.

24. The method of claim 23, further comprising assigning a unique identifier to the updated benchmark image.

25. The method of claim 24, wherein the unique identifier incorporates a numeric chronological feature, and a multi-level and hierarchical sequence numbering feature.

26. The method of claim 23, wherein a step of storing comprises storing the updated benchmark image in the docu-vault.

27. The method of claim 23, determining and recording a required time to activate camera system focus components to achieve the final focus parameters.

28. The method of claim 23, wherein vibrations caused by activation of the servo motor are damped by a vibration damping element proximate the servo motor.

29. A method for refocusing a camera system for capturing images, after the camera system has been repaired or an element of the camera system replaced, the method comprising:
a. retrieving a stored benchmark image;
b. retrieving an onsite field image using focus parameters;
c. determining if pixel characteristics of a target object in the onsite field image and a target object in the stored benchmark image are similar and adequate;
d. repeating steps b. and c. using different focus parameters until the pixel characteristics of the target object in a most recent onsite filed image and the target object in the stored benchmark image are similar and adequate according to a rubric score, then designating a most recent rubric score as a final rubric score, a most recent onsite filed image as an updated stored benchmark image, and a most recent focus parameters as final focus parameters;
e. updating a record with one or more of the final rubric score, the updated benchmark image, and the final focus parameters; and
f. storing the updated stored benchmark image.

30. The method of claim 29, wherein the pixel characteristics comprise a number of pixels.
